(19) United States
(12) Patent Application Publication
(10) Pub. No.: US 2006/0172236 A1
(43) Pub. Date: Aug. 3, 2006

(54) Silver salt photothermographic dry imaging material and image forming method

(76) Inventor: Keiko Maeda, Tokyo (JP)

Correspondence Address: CANTOR COLBURN, LLP, 55 GRIFFIN ROAD SOUTH, BLOOMFIELD, CT, 06002, US

(21) Appl. No.: 11/342,198

(22) Filed: Jan. 27, 2006

(30) Foreign Application Priority Data
Jan. 31, 2005 (JP) JP2005-022521

(51) Int. Cl. G03C 1/00

(52) U.S. Cl. 430/619

(57) ABSTRACT

A photothermographic material is disclosed, comprising a light-insensitive aliphatic carboxylic acid silver salt grains, light-sensitive silver halide grains, a reducing agent for silver ions and a binder, wherein the photothermographic material is packaged in a package of a packaging material exhibiting a water-vapor permeability of not more than 5.0 g/m²·24 hr·40° C.·90% RH and the photothermographic material exhibits a moisture content change of 1.6 to 2.2, in which the moisture content change is a ratio of a moisture content after allowed to stand at 23° C. and 80% RH for 6 hr. after opening the package to that immediately after opening the package; the aliphatic carboxylic acid silver salt has a silver behenate content of 65% to 100%.

This application claims priority from Japanese Patent Application No. JP2005-022521, filed on Jan. 31, 2005, which is incorporated hereinto by reference.

### FIELD OF THE INVENTION

The present invention relates to a silver salt photothermographic dry imaging material comprising light-insensitive aliphatic carboxylic acid silver salt grains, light-sensitive silver halide grains, a reducing agent for silver ions and a binder, and an image forming method by use thereof.

### BACKGROUND OF THE INVENTION

In the field of medical treatment and graphic arts, there have been concerns in processing of imaging materials with respect to effluent produced from wet-processing, and recently, reduction of the processing effluent is strongly demanded in terms of environmental protection and space saving. There has been desired a photothermographic dry imaging material for photographic use, capable of forming distinct black images exhibiting high sharpness, enabling efficient exposure by means of a laser imager or a laser image setter.

Known as such technique are silver salt photothermographic dry imaging materials comprising an organic silver salt, light-sensitive silver halide and a reducing agent on a support, as described in U.S. Pat. Nos. 3,152,904 and 3,487,075 by D. Morgan and B. Shely, and D. H. Klosterboer, “Dry Silver Photographic Material” (Handboook of Imaging Materials, Marcel Dekker Inc. page 48, 1991). Such a silver salt photothermographic dry imaging material (hereinafter also denoted as photothermographic dry imaging material or simply as photothermographic material), which does not employ any solution type processing chemical, can provide users a simple and environment-friendly system.

In one aspect, this photothermographic dry imaging material contains light-sensitive silver halide as a photosensor and a light-insensitive aliphatic carboxylic acid silver salt (hereinafter, also denoted as an organic silver salt) as a silver ion source, and is thermally developed usually at 80 to 250° C. by an included reducing agent for silver ions (hereinafter also denoted simply as a reducing agent) to form an image, without performing fixation.

However, the photothermographic dry imaging material, in which an organic silver salt and light-sensitive silver halide are contained together with a reducing agent, readily causes fogging after raw stock. After being exposed, the photothermographic material is thermally developed and not fixed. After being subjected to thermal development, all or a part of the silver halide, organic silver salt and reducing agent remain, so that metallic silver is thermally or photolytically formed after storage over a long period, resulting in problems such as change in image quality, for instance silver image color.

There were disclosed techniques to solve the foregoing problems in JP-A Nos. 2002-23301 and 2003-131337 (hereinafter, the term, JP-A refers to Japanese Patent Application Publication), U.S. Pat. No. 5,714,311 and European Patent No. 1.096,310 and references cited in the foregoing patent documents. However, most of these disclosed techniques resulted in a certain extent of effects but they were insufficient as a technique to satisfy levels required in the market.

In the course of studies by the inventor of this application, it was proved that when the grain size of light-sensitive silver halide was reduced to increase the number of silver halide grains for the purpose of enhancing silver coverage (covering power or CP), there were arisen problems that image color was deteriorated due to change in shape of developed silver (cluster of silver atoms). Moreover, there were produced problems such that change or deterioration of silver image color was further promoted due to influences of light exposing the light-sensitive silver halide when developed silver images were stocked or observed.

There were disclosed techniques of using leuco dyes to make corrections or adjustments of silver image color due to the shape of developed silver to the preferred s in JP-A Nos. 50-36110, 59-2068315-204087, 11-231460, 2002-169249 and 2002-236334. However, it was proved that change of image color after storage was not sufficiently prevented by the foregoing correction techniques.

There were employed halogen compounds capable of oxidizing silver via photo-induction as a technique to prevent change or deterioration of a silver image due to light, as disclosed in JP-A Nos. 7-2781 and 6-208193. However, these compounds, which generally have an inclination of displaying an oxidizing function upon thermolysis, effectively prevent fog formation and its growth, while it was also proved that silver image formation was inhibited, resulting in disadvantages such as reduction in sensitivity, maximum density (Dmax) and silver covering power.

Photothermographic material is set in various employment environments so that in the case of a dry film, the influence of humidity on photographic performance is large relative to conventional photographic film. Accordingly, it is desired to provide a film which is stable even when set under any environment and a technique having no adverse effect such as reduction of sensitivity.

### SUMMARY OF THE INVENTION

The present invention has come into being in light of the foregoing background circumstances. Thus, it is an object of the invention to provide a silver salt photothermographic dry imaging material exhibiting stable photographic performance under a broad range of environment for setting an imager as well as enhanced sensitivity and reduced fogging, and an image forming method by use thereof.

The foregoing object of the invention can be accomplished by the following constitution.

Thus, one aspect of the invention is directed to a silver salt photothermographic dry imaging material (hereinafter, also denoted simply as photothermographic material) comprising a light-insensitive aliphatic carboxylic acid silver salt grains, light-sensitive silver halide grains, a reducing agent for silver ions and a binder, wherein the photothermographic material is stored in a package of a packaging material exhibiting a water-vapor permeability of not more than 5.0 g/m²·24 hr·40° C.·90% RH and the photothermographic material exhibits a moisture content change (initial moisture content change on environmental exposure) of 1.6 to 2.2, in which the moisture content change is a ratio of a moisture content after allowed to stand at 23° C. and 80% RH for 6 hr. after opening the package to that immediately after opening the package; the aliphatic carboxylic acid silver salt has a silver behenate content of 65% to 100%.

Another aspect of the invention is direct to an image forming method using a silver salt photothermographic material described above, the method comprising subjecting the photothermographic material to laser scanning exposure employing a laser scanning exposure apparatus generating a scanning laser beam in a longitudinal multiple mode.

According to the invention, there can be achieved a silver salt photothermographic dry imaging material exhibiting enhanced sensitivity, a low fog density, minimized fogging and little change in sensitivity even after retained in an imager, and superior raw stock stability and image fastness, and an image forming method by use thereof.

### DETAILED DESCRIPTION OF THE INVENTION

Preferred embodiments of this invention will be detailed as below, but this invention is by no means limited to these.

Film Moisture Content

In general, the moisture content can be determined a Karl Fischer method. However, when determining trace amounts of moisture, this method is easily affected by ambient humidity of the surrounding in the course from sampling to the measurement and is susceptible to influences by humidity during the measurement, rendering it difficult to perform reproducible measurement. However, stable measurement can be achieved using a headspace gas chromatography. Specifically, a film sample with an area of 46.0 cm² is finely cut to lengths of approximately 5 mm and placed into a vial, and sealed with a septum and an aluminum cap. Environmental air at the time of sealing the sample is also sampled as a travel blank. The thus sealed sample is placed in a headspace sampler Turbo M-trix HS-406 (produced by Perkin Elmer Co.). As a gas chromatograph (GC) connected to the headspace sampler was used gas chromatograph GC-2010 (produced by Shimadzu Corp.) which is installed with a thermal conductivity detector (TCD). Gas chromatogram was obtained using the following conditions of headspace sampler heating condition: 120° C., 20 min.; GC introducing temperature: 23° C.; column: DB-WAX, product by J & W Co.; temperature increase: 40° C., 2 min to 80° C. (at 5° C./min) and further to 120° C. (at 10° C./min). The target of the measurement was water. Measurement of standard samples was conducted by charging two quantities (preferably three quantities) suitable for the film measurement in an environmental atmosphere, into a vial. The value which was obtained from the calibration curve prepared using peak areas of chromatogram obtained similarly to the foregoing, was considered to be the moisture content of the sampled film.

The moisture content immediately after opening the package refers to the moisture content immediately after initial opening a package such as a moisture-proof bag. Opening was conducted at 23° C. and 20% RH. The film moisture content is the value obtained by placing a film into a vial within 5 min.

The initial moisture content change upon environmental exposure (hereinafter, also denoted simply as initial moisture content change or moisture content change) is the film moisture content after being allowed to stand at 23° C. and 89% RH for 6 hrs. after opening a package, divided by the film moisture content immediately after opening the package, and it is typically from 1.6 to 2.2, and preferably 1.7 to 2.1. Initial moisture content change upon environmental exposure falling outside the foregoing range results in disadvantages such as an increased change in density (density change at a given light-exposure) when outputting in an imager.

In order to achieve an intended initial moisture content change, an uppermost layer having a relatively low water-vapor permeability may be provided, in addition to a binder content or composition of the individual layer. It can also be varied by variation of the kind or amount of all of materials including fatty acid silver salts. The desired initial moisture content change can be achieved by combinations as above.

In one novel aspect of this invention, the packaging material for the photothermographic material of this invention exhibits a water-vapor permeability of not more than 5.0 g/(m²·24 hr·40° C.·90% RH). The water-vapor permeability can be determined by the method described in JIS K 7129/1992. Water-vapor permeability exceeding the above value results in deteriorated storage stability of the packaged photothermographic material.

Silver Halide Grain

There will be hereinafter described light-sensitive silver halide grains (also denoted simply as silver halide grains) used for the thermally developable silver salt photothermographic material of the invention.

Light-sensitive silver halide grains used in this invention are those which are capable of absorbing light as an inherent property of silver halide crystal or capable of absorbing visible or infrared light by artificial physico-chemical methods, and which are treated or prepared so as to cause a physico-chemical change in the interior and/or on the surface of the silver halide crystal upon absorbing light within the region of ultraviolet to infrared.

The silver halide grains used in the invention can be prepared according to the methods described in P. Glafkides, Chimie Physique Photographique (published by Paul Montel Corp., 19679; G. F. Duffin, Photographic Emulsion Chemistry (published by Focal Press, 1966); V. L. Zelikman et al., Making and Coating of Photographic Emulsion (published by Focal Press, 1964). Any one of acidic precipitation, neutral precipitation and ammoniacal precipitation is applicable and the reaction mode of aqueous soluble silver salt and halide salt includes single jet addition, double jet addition and a combination thereof. Specifically, preparation of silver halide grains with controlling the grain formation condition, so-called controlled double-jet-precipitation is preferred. The halide composition of silver halide is not specifically limited and may be any one of silver chloride, silver chlorobromide, silver iodochlorobromide, silver bromide, silver iodobromide and silver iodide. The iodide content of silver iodobromide is preferably 0.02 to 16 mol %, based on Ag. Iodide may be distributed overall within a silver halide grain or may be localized in a specific portion, for example, a core/shell structure in which is high iodide in the central portion of the grain and low or substantially zero iodide in the vicinity of the grain surface.

The grain forming process is usually classified into two stages of formation of silver halide seed crystal grains (nucleation) and grain growth. These stages may continuously be conducted, or the nucleation (seed grain formation) and grain growth may be separately performed. The controlled double-jet precipitation, in which grain formation is undergone with controlling grain forming conditions such as pAg and pH, is preferred to control the grain form or grain size. In cases when nucleation and grain growth are separately conducted, for example, a soluble silver salt and a soluble halide salt are homogeneously and promptly mixed in an aqueous gelatin solution to form nucleus grains (seed grains), thereafter, grain growth is performed by supplying soluble silver and halide salts, while being controlled at a pAg and pH to prepare silver halide grains. After completing the grain formation, the resulting silver halide grain emulsion is subjected to desalting to remove soluble salts by commonly known washing methods such as a noodle washing method, a flocculation method, a ultrafiltration method, or electrodialysis to obtain desired emulsion grains.

In order to minimize cloudiness after image formation and to obtain excellent image quality, the less the average grain size, the more preferred, and the average grain size is preferably not less than 0.030 μm and not more than 0.055 μm, when grains of less than 0.02 μm are neglected. The average grain size as described herein is defined as an average edge length of silver halide grains, in cases where they are so-called regular crystals in the form of cube or octahedron. Furthermore, in cases where grains are tabular grains, the grain size refers to the diameter of a circle having the same area as the projected area of the major faces. Furthermore, silver halide grains are preferably monodisperse grains. The monodisperse grains as described herein refer to grains having a coefficient of variation of grain size obtained by the formula described below of not more than 7%; more preferably not more than 5%, still more preferably not more than 3%, and most preferably not more than 1%.
Coefficient of variation of grain size=standard deviation of grain diameter/average grain diameter×100(%)

The grain form can be of almost any one, including cubic, octahedral or tetradecahedral grains, tabular grains, spherical grains, bar-like grains, and potato-shaped grains. Of these, cubic grains, octahedral grains, tetradecahedral grains and tabular grains are specifically preferred.

The aspect ratio of tabular grains is preferably 1.5 to 100, and more preferably 2 to 50. These grains are described in U.S. Pat. Nos. 5,264,337, 5,314,798 and 5,320,958 and desired tabular grains can be readily obtained. Silver halide grains having rounded corners are also preferably employed.

Crystal habit of the outer surface of the silver halide grains is not specifically limited, but in cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized.

It is preferred to use low molecular gelatin having an average molecular weight of not more than 50,000 in the preparation of silver halide grains used in the invention, specifically, in the stage of nucleation. Thus, the low molecular gelatin has an average molecular eight of not more than 50,000, preferably 2,000 to 40,000, and more preferably 5,000 to 25,000. The average molecular weight can be determined by means of gel permeation chromatography. The low molecular weight gelatin can be obtained by subjecting an aqueous gelatin conventionally used and having an average molecular weight of ca. 100,000 to enzymatic hydrolysis, acid or alkali hydrolysis, thermal degradation at atmospheric pressure or under high pressure, or ultrasonic degradation.

The concentration of dispersion medium used in the nucleation stage is preferably not more than 5% by weight, and more preferably 0.05 to 3.0% by weight.

In the preparation of silver halide grains, it is preferred to use a polyethylene oxide compound represent by the following formula, specifically in the nucleation stage:
YO(CH₂CH₂O)m(C(CH₃)CH₂O)p(CH₂CH₂O)nY
where Y is a hydrogen atom, —SO₃M or —CO—B-COOM, in which M is a hydrogen atom, alkali metal atom, ammonium group or ammonium group substituted by an alkyl group having carbon atoms of not more than 5, and B is a chained or cyclic group forming an organic dibasic acid; m and n each are 0 to 50; and p is 1 to 100. Polyethylene oxide compounds represented by foregoing formula have been employed as a defoaming agent to inhibit marked foaming occurred when stirring or moving emulsion raw materials, specifically in the stage of preparing an aqueous gelatin solution, adding a water-soluble silver and halide salts to the aqueous gelatin solution or coating an emulsion on a support during the process of preparing silver halide photographic light sensitive materials. A technique of using these compounds as a defoaming agent is described in JP-A No. 44-9497. The polyethylene oxide compound represented by the foregoing formula also functions as a defoaming agent during nucleation. The compound represented by the foregoing formula is used preferably in an amount of not more than 1, and more preferably 0.01 to 0.1% by weight, based on silver.

The compound is to be present at the stage of nucleation, and may be added to a dispersing medium prior to or during nucleation. Alternatively, the compound may be added to an aqueous silver salt solution or halide solution used for nucleation. It is preferred to add it to a halide solution or both silver salt and halide solutions in an amount of 0.01 to 2.0% by weight. It is also preferred to make the compound represented by formula [5] present over a period of at least 50% (more preferably, at least 70%) of the nucleation stage.

The temperature during the stage of nucleation is preferably 5 to 60° C., and more preferably 15 to 50° C. Even when nucleation is conducted at a constant temperature, in a temperature-increasing pattern (e.g., in such a manner that nucleation starts at 25° C. and the temperature is gradually increased to reach 40° C. at the time of completion of nucleation) or its reverse pattern, it is preferred to control the temperature within the range described above.

Silver salt and halide salt solutions used for nucleation are preferably in a concentration of not more than 3.5N, and more preferably 0.01 to 2.5N. The flow rate of aqueous silver salt solution is preferably 1.5×10⁻³ to 3.0×10⁻¹ mol/min per lit. of the solution, and more preferably 3.0×10⁻³ to 8.0×10⁻² mol/min. per lit. of the solution. The pH during nucleation is within a range of 1.7 to 10, and since the pH at the alkaline side broadens the grain size distribution, the pH is preferably 2 to 6. The pBr during nucleation is 0.05 to 3.0, preferably 1.0 to 2.5, and more preferably 1.5 to 2.0.

Light-sensitive silver halide grains usable in this invention are preferably those which are capable of being converted from a surface image forming type to an internal image forming type upon thermal development, resulting in reduced surface sensitivity. Thus, the silver halide grains form latent images capable of acting as a catalyst in development (or reduction reaction of silver ions by a reducing agent) upon exposure to light prior to thermal development on the silver halide grain surface, and upon exposure after completion of thermal development, images are formed preferentially in the interior of the grains (i.e., internal latent image formation), thereby suppressing latent image formation on the grain surface. There has been known the use of silver halide grains capable of varying the latent image forming function before and after thermal development in photothermographic materials.

In general, when exposed to light, light-sensitive silver halide grains or spectral sensitizing dyes adsorbed onto the surfaces of the silver halide grains are photo-excited to form free electrons. The thus formed electrons are trapped competitively by electron traps on the grain surface (sensitivity center) and internal electron traps existing in the interior of the grains. In cases when chemical sensitization centers (chemical sensitization nuclei) or dopants useful as a electron trap exist more on the surface than the interior of the grain, latent images are more predominantly on the surface than in the interior of the grain, rendering the grains developable. On the contrary, the chemical sensitization centers or dopants useful as electron traps, which exist more in the interior than the surface of the grains form latent images preferentially in the interior rather than the surface of the grains, rendering the grain undevelopable. Alternatively, it can be said that, in the former case, the grain surface has higher sensitivity than the interior; in the latter case, the surface has lower sensitivity than the interior. The foregoing is detailed, for example, in T. H. James, The Theory of the Photographic Process, 4th Ed. (Macmillan Publishing Co., Ltd., 1977 and Nippon Shashin Gakai Ed., “Shashin Kogaku no Kiso (Ginene Shashin)” (Corona Co., Ltd., 1998).

In one preferred embodiment of this invention, light-sensitive silver halide grains each contain a dopant capable of functioning as an electron-trapping dopant when exposed to light after thermal development inside the grains, resulting in enhanced sensitivity and improved image storage stability. The dopant is more preferably one which is capable of functioning as a hole trap when exposed prior to thermal development and which is also capable of functioning as an electron trap after subjected to thermal development.

The electron trapping dopant is an element or compound, except for silver and halogen forming silver halide, referring to one having a property of trapping free electrons or one whose occlusion within the grain causes a site such as an electron-trapping lattice imperfection. Examples thereof include metal ions except for silver and their salts or complexes; chalcogen (elements of the oxygen group) such as sulfur, selenium and tellurium; chalcogen or nitrogen containing organic or inorganic compounds; and rare earth ions or their complexes.

Examples of the metal ions and their salts or complexes include a lead ion, bismuth ion and gold ion; lead bromide, lead carbonate, lead sulfate, bismuth nitrate, bismuth chloride, bismuth trichloride, bismuth carbonate, sodium bismuthate, chloroauric acid, lead acetate, lead stearate and bismuth and acetate.

Compounds containing chalcogen such as sulfur, selenium or tellurium include various chalcogen-releasing compounds, which are known, in the photographic art, as a chalcogen sensitizer. The chalcogen0 or nitrogen-containing organic compounds are preferably heterocyclic compounds. Examples thereof include imidazole, pyrazole, pyridine, pyrimidine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine, and tetrazaindene; preferred of these are imidazole, pyridine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole, and tetrazaindene. The foregoing heterocyclic compounds may be substituted with substituents. Examples of substituents include an alkyl group, alkenyl group, aryl group, alkoxy group, aryloxy group, acyloxy group, acyl group, alkoxycarbonyl group, aryloxycarbonyl group, acyloxy group, acylamino group, alkoxycarbonylamino group, aryloxycarbonylamino group, sulfonylamino group, sulfamoyl group, carbamoyl group, sulfonyl group, ureido group, phosphoric acid amido group, halogen atoms, cyano group, sulfo group, carboxyl group, nitro group, and heterocyclic group; of these, an alkyl group, aryl group, alkoxy group, aryloxy group, acyl group, acylamino group, alkoxycarbonylamino group, sulfonylamino group, sulfamoyl group, carbamoyl group, sulfonyl group, ureido group, phosphoric acid amido group, halogen atoms, cyano group, nitro group and heterocyclic group are preferred; and an alkyl group, aryl group, alkoxy group, aryloxy group, acyl group, acylamino group, sulfonylamino group, sulfamoyl group, carbamoyl group, halogen atoms, cyano group, nitro group, and heterocyclic group are more preferred.

In one embodiment of this invention, silver halide grains used in this invention occlude transition metal ions selected from groups 6 to 11 inclusive of the periodic table of elements whose oxidation state is chemically prepared in combination with ligands so as to function as an electron-trapping dopant and/or a hole-trapping dopant. Preferred transition metals include W, Fe, Co, Ni, Cu, Ru, Rh, Pd, Re, Os, Ir and Pt. The foregoing transition metal is doped within the interior of the grains, preferably within the interior region of 0% to 99% of the grain volume (more preferably 0% to 50% of the grain volume). The interior region of 0% to 99% of the grain volume refers to the central portion of the grains in an interior region surrounding 99% of the total silver forming the grains.

The foregoing dopants may be used alone or in combination thereof, provided that at least one of the dopants needs to act as an electron-trapping dopant when exposed after being subjected to thermal development. The dopants can be introduced, in any chemical form, into silver halide grains. The dopant content is preferably 1×10⁻⁹ to 1×10 mol, more preferably 1×10⁻⁸ to 1×10⁻¹ mol, and still more preferably 1×10⁻⁶ to 1×10⁻² mol per mol of silver. The optimum content, depending on the kind of the dopant, grain size or form of silver halide grains and other environmental conditions, can be optimized in accordance with the foregoing conditions.

In this invention, transition metal complexes or their ions, represented by the general formula described below are preferred:
(ML₆)^{m}: Formula
wherein M represents a transition metal selected from elements in Groups 6 to 11 of the Periodic Table; L represents a coordinating ligand; and m represents 0, 1-, 2-, 3- or 4-. M is selected preferably from W, Fe, Co, Ni, Cu, Ru, Rh, Pd, Re, Os, Ir and Pt. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When the aquo ligand is present, one or two ligands are preferably coordinated. L may be the same or different.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, these are preferably added at the stage of nuclei formation, growth, and physical ripening; furthermore, are preferably added at the stage of nuclei formation and growth; and are most preferably added at the stage of nuclei formation. These compounds may be added several times by dividing the added amount. Uniform content in the interior of a silver halide grain can be carried out. As disclosed in JP-A No. 63-29603, 2-306236, 3-167545, 4-76534, 6-110146, 5-273683, the metal can be non-uniformly occluded in the interior of the grain.

These metal compounds can be dissolved in water or a suitable organic solvent (e.g., alcohols, ethers, glycols, ketones, esters, amides, etc.) and then added. Furthermore, there are methods in which, for example, an aqueous metal compound powder solution or an aqueous solution in which a metal compound is dissolved along with NaCl and KCl is added to a water-soluble silver salt solution during grain formation or to a water-soluble halide solution; when a silver salt solution and a halide solution are simultaneously added, a metal compound is added as a third solution to form silver halide grains, while simultaneously mixing three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous metal compound powder solution or an aqueous solution in which a metal compound is dissolved along with NaCl and KCl is added to a water-soluble halide solution. When the addition is carried out onto grain surfaces, an aqueous solution comprising the necessary amount of a metal compound can be placed in a reaction vessel immediately after grain formation, or during physical ripening or at the completion thereof or during chemical ripening. Non-metallic dopants can also be introduced in a manner similar to the foregoing metallic dopants.

Whether a dopant has an electron-trapping property in the photothermographic material relating to this invention can be evaluated according to the following manner known in the photographic art. A silver halide emulsion comprising silver halide grains doped with a dopant is subjected to microwave photoconductometry to measure photoconductivity. Thus, the doped emulsion can be evaluated with respect to a decreasing rate of photoconductivity on the basis of a silver halide emulsion containing no dopant. Evaluation can also be made based on comparison of internal sensitivity and surface sensitivity.

A photothermographic dry imaging material relating to this invention can be evaluated with respect to effect of an electron trapping dopant, for example, in the following manner. The photothermographic material, prior to exposure, is heated under the same condition as usual thermal developing conditions and then exposed through an optical wedge to white light or light in the specific spectral sensitization region (for example, in the case when spectrally sensitized for a laser, light falling within such a wavelength region and in the case when infrared-sensitized, an infrared light) for a period of a given time and then thermally developed under the same condition as above. The thus processed photothermographic material is further subjected to densitometry with respect to developed silver image to prepare a characteristic curve comprising an abscissa of exposure and an ordinate of silver density and based thereon, sensitivity is determined. The obtained sensitivity is compared for evaluation with that of a photothermographic material using silver halide emulsion grains not containing an electron trapping dopant. Thus, it is necessary to confirm that the sensitivity of the photothermographic material containing the dopant is lower than that of the photothermographic material not containing the dopant.

A photothermographic material is exposed through an optical wedge to white light or a light within the specific spectral sensitization region (e.g., infrared ray) for a given time (e.g., 30 seconds) and thermally developed under usual practical thermal development conditions (e.g., 123° C., 15 seconds) and the sensitivity obtained based on the characteristic curve is designated as S1. Separately, the photothermographic material, prior to exposure, is heated under the practical thermal development conditions (e.g., 123° C., 15 seconds) and further exposed and thermally developed similarly to the foregoing and the sensitivity obtained based on a characteristic curve is designated as S2. The ratio of S2/S1 of the photothermographic material relating to this invention is preferably not more than 1/10, more preferably not more than 1/20, and still more preferably not more than 1/50.

Specifically, the foregoing characteristics can be evaluated in the following manner. Thus, the photothermographic material is subjected to a heat treatment at a temperature of 123° C. for a period of 15 sec., followed by being exposed to white light (e.g., light at 4874K) or infrared light through an optical wedge for a prescribed period of time (within the range of 0.01 sec. to 30 min., e.g., 30 sec. using a tungsten light source) and being thermally developed at a temperature of 123° C. for a period of 15 sec. The thus processed photothermographic material is further subjected to densitometry with respect to developed silver image to prepare a characteristic curve comprising an abscissa of exposure and an ordinate of silver density and based thereon, sensitivity is determined, which is designated as S₂. Separately, the photothermographic material is exposed and thermally developed in the same manner as above, without being subjected to the heat treatment to determine sensitivity, which is designated S₁. The sensitivity is defined as the reciprocal of an exposure amount giving a density of a minimum density (or a density of the unexposed area) plus 1.0.

Silver halide may be incorporated into an image forming layer by any means, in which silver halide is arranged so as to be as close to reducible silver source (aliphatic carboxylic acid silver salt) as possible. It is general that silver halide, which has been prepared in advance, added to a solution used for preparing an organic silver salt. In this case, preparation of silver halide and that of an organic silver salt are separately performed, making it easier to control the preparation thereof. Alternatively, as described in British Patent 1,447,454, silver halide and an organic silver salt can be simultaneously formed by allowing a halide component to be present together with an organic silver salt-forming component and by introducing silver ions thereto. Silver halide can also be prepared by reacting a halogen containing compound with an organic silver salt through conversion of the organic silver salt. Thus, a silver halide-forming component is allowed to act onto a pre-formed organic silver salt solution or dispersion or a sheet material containing an organic silver salt to convert a part of the organic silver salt to photosensitive silver halide.

The silver halide-forming components include inorganic halide compounds, onium halides, halogenated hydrocarbons, N-halogen compounds and other halogen containing compounds. These compounds are detailed in U.S. Pat. Nos. 4,009,039, 3,457,075 and 4,003,749, British Patent 1,498,956 and JP-A 53-27027 and 53-25420. Silver halide can be formed by converting a part or all of an organic silver salt to silver halide through reaction of the organic silver salt and a halide ion. The silver halide separately prepared may be used in combination with silver halide prepared by conversion of at least apart of an organic silver salt. The silver halide which is separately prepared or prepared through conversion of an organic silver salt is used preferably in an amount of 0.001 to 0.7 mol, and more preferably 0.03 to 0.5 mol per mol of organic silver salt.

Silver halide grain emulsions used in the invention may be desalted after the grain formation, using the methods known in the art, such as the noodle washing method and flocculation process.

Light-Insensitive Silver Aliphatic Carboxylate

Light-sensitive aliphatic carboxylic acid silver salts (hereinafter, also denoted as organic silver salts) usable in the invention which are relatively stable to light, form silver images when heated at a temperature of 80° C. or more in the presence of a light-exposed photocatalyst (for example, latent images of light-sensitive silver halide) and a reducing agent. Such light-insensitive organic silver salts are described in JP-A No. 10-62899, paragraph [0048]-[0049]; European Patent Application Publication (hereinafter, denoted simply as EP-A) No. 803,764A1, page 18, line 24 to page 24, line 37; EP-A No. 962,812A1; JP-A Nos. 11-349591, 2000-7683, 2000-72711, 2002-23301, 2002-23303, 2002-49119, 2002-196446; EP-A Nos. 1246001A1 and 1258775A1; JP-A Nos. 2003-140290, 2003-195445, 2003-295378, 2003-295379, 2003-295380 and 2003-295381.

The foregoing organic silver salts can be used in combination with silver salts of aliphatic carboxylic acids, specifically long chain aliphatic carboxylic acids having 10 to 30 carbon atoms, preferably 15 to 28 carbon atoms. The molecular weight of such an aliphatic carboxylic acid is preferably from 200 to 400, and more preferably 250 to 400. Preferred fatty acid silver salts include, for example, silver behenate, silver arachidate, silver stearate, silver oleate, silver laurate, silver caprate, silver myristate, silver palmitate and their mixtures. of the foregoing fatty acid silver salts, a fatty acid silver salt having a silver behenate content of 65 to 100 mol % (preferably 70 to 99 mol % and more preferably 80 to 95 mol %) is used in this invention. A silver behenate content of less than 65 mol % often results in deteriorated image light fastness.

Other than the foregoing organic silver salts are also usable core/shell organic silver salts described in JP-A No. 2002-23303; silver salts of polyvalent carboxylic acids, as described in EP 1246001 and JP-A No. 2004-061948; and polymeric silver salts, as described in JP-A Nos. 2000-292881 and 2003-295378 to 2003-295381.

The silver behenate content refers to a percentage (%) by weight of silver behenate, based on the total weight of silver salts of long chain aliphatic carboxylic acids having 10 or more carbons, included in the photographic material or a specific layer such as a low-speed emulsion layer or a high-speed emulsion layer.

The content of behenic acid can be determined in the following manner. A sample of organic silver salts in an amount of approximately 10 mg is accurately weighed and placed in a 200 ml eggplant type flask. Subsequently, 15 ml of methanol and 3 ml of 4 mol/L hydrochloric acid are added and the resulting mixture is subjected to ultrasonic dispersion for one minute. Boiling stones made of Teflon (registered trade name) are placed and refluxing is performed for 60 minutes. After cooling, 5 ml of methanol is added from the upper part of the cooling pipe and those adhered to the cooling pipe are washed into the ovoid flask. This procedure is repeated twice. The resulting liquid reaction composition is subjected to extraction employing ethyl acetate. (Separation extraction is performed twice by adding 100 ml of ethyl acetate and 70 ml of water. Vacuum drying is then performed at normal temperature for 30 minutes). In a 10 ml measuring flask is placed 1 ml of a benzanthorone solution as an internal standard. The sample is dissolved in toluene and the total volume is adjusted by the addition of toluene. Gas chromatography (GC) is performed, the mol percentage of the individual organic acid can be determined from its peak area and converted to the percentage by weight to determine the composition of total organic acids.

Subsequently, the content of free organic acids which are not converted to silver salts, is determined in the following manner. A sample of organic silver salts in an amount of approximately 20 mg is accurately weighed, and 10 ml of methanol was added and the resulting mixture is dispersed using an ultrasonic homogenizer. The resulting dispersion is filtered and dried up, and free organic carboxylic acids are separated. Following procedure is conducted similarly to the case of total organic acids, whereby the composition of free organic acids and its proportion in the total organic acids can be determined. The difference of the free acids from the total organic acids is the composition of organic acid existing as organic silver salt.

In cases when extracted from film, the light-sensitive emulsion layer is peeled in a solvent capable of dissolving binders and determination is performed in a similar manner. When the light-sensitive emulsion layer is comprised of two or more layers, the light-sensitive emulsion layer is separated to two or more layers and the foregoing procedure is conducted. The detailed procedure is referred to Y. Okagami, Bunseki Kagaku (Analytical Chemistry), vol. 137, p 41, 1988.

Aliphatic carboxylic acid silver salts according to the present invention may be crystalline grains which have the core/shell structure disclosed in European Patent No. 1168069A1 and Japanese Patent Application Open to Public Inspection No. 2002-023303. Incidentally, when the core/shell structure is formed, organic silver salts, except for aliphatic carboxylic acid silver, such as silver salts of phthalic acid and benzimidazole may be employed wholly or partly in the core portion or the shell portion as a constitution component of the aforesaid crystalline grains.

In the aliphatic carboxylic acid silver salts according to the present invention, it is preferable that the average circle equivalent diameter is from 0.05 to 0.80 μm, and the average thickness is from 0.005 to 0.070 μm. It is still more preferable that the average circle equivalent diameter is from 0.2 to 0.5 mm, and it is more preferable that the average circle equivalent diameter is from 0.2 to 0.5 μm and the average thickness is from 0.01 to 0.05 μm.

When the average circle equivalent diameter is less than or equal to 0.05 μm, excellent transparency is obtained, while image retention properties are degraded. On the other hand, when the average grain diameter is less than or equal to 0.8 μm, transparency is markedly degraded. When the average thickness is less than or equal to 0.005 μm, during development, silver ions are abruptly supplied due to the large surface area and are present in a large amount in the layer, since specifically in the low density section, the silver ions are not used to form silver images. As a result, the image retention properties are markedly degraded. On the other hand, when the average thickness is more than or equal to 0.07 μm, the surface area decreases whereby image stability is enhanced. However, during development, the silver supply rate decreases and in the high density section, silver formed by development results in non-uniform shape, whereby the maximum density tends to decrease.

The average circle equivalent diameter can be determined as follows. Aliphatic carboxylic acid silver salts, which have been subjected to dispersion, are diluted, are dispersed onto a grid covered with a carbon supporting layer, and imaged at a direct magnification of 5,000, employing a transmission type electron microscope (Type 2000FX, manufactured by JEOL, LTD.). The resultant negative image is converted to a digital image employing a scanner. Subsequently, by employing appropriate software, the grain diameter (being an equivalent circle diameter) of at least 300 grains is determined and an average grain diameter is calculated.

It is possible to determine the average thickness, employing a method utilizing a transmission electron microscope (hereinafter, also referred to as a TEM) as described below.

First, a photosensitive layer, which has been applied onto a support, is adhered onto a suitable holder, employing an adhesive, and subsequently, cut in the perpendicular direction with respect to the support plane, employing a diamond knife, whereby ultra-thin slices having a thickness of 0.1 to 0.2 μm are prepared. The ultra-thin slice is supported by a copper mesh and transferred onto a hydrophilic carbon layer, employing a glow discharge. Subsequently, while cooling the resultant slice at less than or equal to −130° C. employing liquid nitrogen, a bright field image is observed at a magnification of 5,000 to 40,000, employing TEM, and images are quickly recorded employing either film, imaging plates, or a CCD camera. During the operation, it is preferable that the portion of the slice in the visual field is suitably selected so that neither tears nor distortions are imaged.

The carbon layer, which is supported by an organic layer such as extremely thin collodion or Formvar, is preferably employed. The more preferred carbon layer is prepared as follows. The carbon layer is formed on a rock salt substrate which is removed through dissolution. Alternately, the organic layer is removed employing organic solvents and ion etching whereby the carbon layer itself is obtained. The acceleration voltage applied to the TEM is preferably from 80 to 400 kV, and is more preferably from 80 to 200 kV.

Other items such as electron microscopic observation techniques, as well as sample preparation techniques, may be obtained while referring to either “Igaku-Seibutsugaku Denshikenbikyo Kansatsu Gihoh (Medical-Biological Electron Microscopic Observation Techniques”, edited by Nippon Denshikembikyo Gakkai Kanto Shibu (Maruzen) or “Denshikembikyo Seibutsu Shiryo Sakuseihoh (Preparation Methods of Electron Microscopic Biological Samples”, edited by Nippon Denshikenbikyo Gakkai Kanto Shibu (Maruzen).

It is preferable that a TEM image, recorded in a suitable medium, is decomposed into preferably at least 1,024×1,024 pixels and subsequently subjected to image processing, utilizing a computer. In order to carry out the image processing, it is preferable that an analogue image, recorded on a film strip, is converted into a digital image, employing any appropriate means such as scanner, and if desired, the resulting digital image is subjected to shading correction as well as contrast-edge enhancement. Thereafter, a histogram is prepared, and portions, which correspond to aliphatic carboxylic acid silver salts, are extracted through a binary-coding process.

At least 300 of the thickness of aliphatic carboxylic acid silver salt particles, extracted as above, are manually determined employing appropriate software, and an average value is then obtained.

Methods to prepare aliphatic carboxylic acid silver salt particles, having the shape as above, are not particularly limited. It is preferable to maintain a mixing state during formation of an organic acid alkali metal salt soap and/or a mixing state during addition of silver nitrate to the soap as desired, and to optimize the proportion of organic acid to the soap, and of silver nitrate which reacts with the soap.

It is preferable that, if desired, the planar aliphatic carboxylic acid silver salt particles (referring to aliphatic carboxylic acid silver salt particles, having an average circle equivalent diameter of 0.05 to 0.80 μm as well as an average thickness of 0.005 to 0.070 μm) are preliminarily dispersed together with binders as well as surface active agents, and thereafter, the resultant mixture is dispersed employing a media homogenizer or a high pressure homogenizer. The preliminary dispersion may be carried out employing a common anchor type or propeller type stirrer, a high-speed rotation centrifugal radial type stirrer (being a dissolver), and a high-speed rotation shearing type stirrer (being a homomixer).

Further, employed as the aforesaid media homogenizers may be rotation mills such as a ball mill, a planet ball mill, and a vibration ball mill, media stirring mills such as a bead mill and an attritor, and still others such as a basket mill. Employed as high pressure homogenizers may be various types such as a type in which collision against walls and plugs occurs, a type in which a liquid is divided into a plurality of portions which are collided with each other at high speed, and a type in which a liquid is passed through narrow orifices.

Preferably employed as ceramics, which are used in ceramic beads employed during media dispersion are, for example, yttrium-stabilized zirconia, and zirconia-reinforced alumina (hereafter ceramics containing zirconia are abbreviated to as zirconia). The reason of the preference is that impurity formation due to friction with beads as well as the homogenizer during dispersion is minimized.

In apparatuses which are employed to disperse the planar aliphatic carboxylic acid silver salt particles of the present invention, preferably employed as materials of the members which come into contact with the aliphatic carboxylic acid silver salt particles are ceramics such as zirconia, alumina, silicon nitride, and boron nitride, or diamond. Of these, zirconia is preferably employed. During the dispersion, the concentration of added binders is preferably from 0.1 to 10.0 percent by weight with respect to the weight of aliphatic carboxylic acid silver salts. Further, temperature of the dispersion during the preliminary and main dispersion is preferably maintained at less than or equal to 45° C. The examples of the preferable operation conditions for the main dispersion are as follows. When a high-pressure homogenizer is employed as a dispersion means, preferable operation conditions are from 29 to 100 MPa, and at least double operation frequency. Further, when the media homogenizer is employed as a dispersion means, the peripheral rate of 6 to 13 m/second is cited as the preferable condition.

In the present invention, light-insensitive aliphatic carboxylic acid silver salt particles are preferably formed in the presence of compounds which function as a crystal growth retarding agent or a dispersing agent. Further, the compounds which function as a crystal growth retarding agent or a dispersing agent are preferably organic compounds having a hydroxyl group or a carboxyl group.

In the present invention, compounds, which are described herein as crystal growth retarding agents or dispersing agents for aliphatic carboxylic acid silver salt particles, refer to compounds which, in the production process of aliphatic carboxylic acid silver salts, exhibit more functions and greater effects to decrease the grain diameter, and to enhance monodispersibility when the aliphatic carboxylic acid silver salts are prepared in the presence of the compounds, compared to the case in which the compounds are not employed. Listed as examples are monohydric alcohols having 10 or fewer carbon atoms, such as preferably secondary alcohol and tertiary alcohol; glycols such as ethylene glycol and propylene glycol; polyethers such as polyethylene glycol; and glycerin. The preferable addition amount is from 10 to 200 percent by weight with respect to aliphatic carboxylic acid silver salts.

On the other hands, preferred are branched aliphatic carboxylic acids, each containing an isomer, such as isoheptanic acid, isodecanoic acid, isotridecanoic acid, isomyristic acid, isopalmitic acid, isostearic acid, isoarachidinic acid, isobehenic acid, or isohexaconic acid. Preferable side chains include an alkyl group and an alkenyl group having 4 or fewer carbon atoms. Further, there are included aliphatic unsaturated carboxylic acids such as palmitoleic acid, oleic acid, linoleic acid, linolenic acid, moroctic acid, eicosenoic acid, arachidonic acid, eicosapentaenoic acid, erucic acid, docosapentaenoic acid, and selacholeic acid. The preferable addition amount is from 0.5 to 10.0 mol percent of aliphatic carboxylic acid silver salts.

Preferable compounds include glycosides such as glucoside, galactoside, and fructoside; trehalose type disaccharides such as trehalose and sucrose; polysaccharides such as glycogen, dextrin, dextran, and alginic acid; cellosolves such as methyl cellosolve and ethyl cellosolve; water-soluble organic solvents such as sorbitan, sorbitol, ethyl acetate, methyl acetate, and dimethylformamide; and water-soluble polymers such as polyvinyl alcohol, polyacrylic acid, acrylic acid copolymers, maleic acid copolymers, carboxymethyl cellulose, hydroxypropyl cellulose, hydroxypropyl methyl cellulose, polyvinylpyrrolidone, and gelatin. The preferable addition amount is from 0.1 to 20.0 percent by weight with respect to aliphatic carboxylic acid silver salts.

Alcohols having 10 or fewer carbon atoms, being preferably secondary alcohols and tertiary alcohols, increase the solubility of sodium aliphatic carboxylates in the emulsion preparation process, whereby the viscosity is lowered so as to enhance the stirring efficiency and to enhance monodispersibility as well as to decrease particle size. Branched aliphatic carboxylic acids, as well as aliphatic unsaturated carboxylic acids, result in higher steric hindrance than straight chain aliphatic carboxylic acid silver salts as a main component during crystallization of aliphatic carboxylic acid silver salts to increase the distortion of crystal lattices whereby the particle size decreases due to non-formation of over-sized crystals.

Aliphatic carboxylic acid silver salts according to the present invention may be crystalline grains which have the core/shell structure disclosed in European Patent No. 1168069A1 and Japanese Patent Application Open to Public Inspection No. 2002-023303. Incidentally, when the core/shell structure is formed, organic silver salts, except for aliphatic carboxylic acid silver, such as silver salts of phthalic acid and benzimidazole may be employed wholly or partly in the core portion or the shell portion as a constitution component of the aforesaid crystalline grains.

Antifoggant and Image Stabilizer

As mentioned above, compared to conventional silver halide photographic materials, the greatest different point in terms of the structure of silver salt photothermographic materials is that in the latter materials, a large amount of photosensitive silver halide, organic silver salts and reducing agents is contained which are capable of becoming causes of generation of fogging and printout silver, irrespective of prior and after photographic processing. Due to that, in order to maintain storage stability before development and even after development, it is important to apply highly effective fog minimizing and image stabilizing techniques to silver salt photothermographic materials. Other than aromatic heterocyclic compounds which retard the growth and development of fog specks, heretofore, mercury compounds, such as mercury acetate, which exhibit functions to oxidize and eliminate fog specks, have been employed as a markedly effective storage stabilizing agents. However, the use of such mercury compounds may cause problems regarding safety as well as environmental protection.

The important points for achieving technologies for antifogging and image stabilizing are:

to prevent formation of metallic silver or silver atoms caused by reduction of silver ion during preserving the material prior to or after development; and

to prevent the formed silver from effecting as a catalyst for oxidation (to oxidize silver into silver ions) or reduction (to reduce silver ions to silver).

Antifoggants as well as image stabilizers which are employed in the silver salt photothermographic material of the present invention will now be described.

In the silver salt photothermographic material of the present invention, one of the features is that bisphenols are mainly employed as a reducing agent, as described below. It is preferable that compounds are incorporated which are capable of deactivating reducing agents upon generating active species capable of extracting hydrogen atoms from the aforesaid reducing agents.

Preferred compounds are those which are capable of: preventing the reducing agent from forming a phenoxy radial; or trapping the formed phenoxy radial so as to stabilize the phenoxy radial in a deactivated form to be effective as a reducing agent for silver ions.

Preferred compounds having the above-mentioned properties are non-reducible compounds having a functional group capable of forming a hydrogen bonding with a hydroxyl group in a bis-phenol compound. Examples are compounds having in the molecule such as, a phosphoryl group, a sulfoxide group, a sulfonyl group, a carbonyl group, an amido group, an ester group, a urethane group, a ureido group, a tertiary amino group, or a nitrogen containing aromatic group.

More preferred are compounds having a sulfonyl group, a sulfoxide group or a phosphoryl group in the molecule.

Specific examples are disclosed in, JP-A Nos. 6-208192, 20001-215648, 3-50235, 2002-6444, 2002-18264. Another examples having a vinyl group are disclosed in, Japanese translated PCT Publication No. 2000-515995, JP-A Nos. 2002-207273, and 2003-140298.

Further, it is possible to simultaneously use compounds capable of oxidizing silver (metallic silver) such as compounds which release a halogen radical having oxidizing capability, or compounds which interact with silver to form a charge transfer complex. Specific examples of compounds which exhibit the aforesaid function are disclosed in JP-A Nos. 50-120328, 59-57234, 4-232939, 6-208193, and 10-197989, as well as U.S. Pat. No. 5,460,938, and JP-A No. 7-2781. Specifically, in the imaging materials according to the present invention, specific examples of preferred compounds include halogen radical releasing compounds which are represented by Formula (OFI) below.
Q₂-Y—C(X₁)(X₃)(X₂) Formula (OFI)

In Formula (OFI), Q₂ represents an aryl group or a heterocyclic group; X₁, X₂, and X₃ each represent a hydrogen atom, a halogen atom, an acyl group, an alkoxycarbonyl group, an aryloxycarbonyl group, a sulfonyl group, or an aryl group, at least one of which is a halogen atom; and Y represents —C(═O)—, —SO— or —SO₂—.

The aryl group represented by Q₂ may be in the form of a single ring or a condensed ring, and is preferably a single ring or double ring aryl group having 6-30 carbon atoms (for example, phenyl and naphthyl) and is more preferably a phenyl group and a naphthyl group, and is still more preferably a phenyl group.

The heterocyclic group represented by Q₂ is a 3- to 10-membered saturated or unsaturated heterocyclic group containing at least one of N, O, or S, which may be a single ring or may form a condensed ring with another ring.

The heterocyclic group is preferably a 5- to 6-membered unsaturated heterocyclic group which may have a condensed ring, is more preferably a 5- to 6-membered aromatic heterocyclic group which may have a condensed ring, and is most preferably a 5- to 6-membered aromatic heterocyclic group which may have a condensed ring containing 1 to 4 nitrogen atoms. Heterocycles in such heterocyclic groups are preferably imidazole, pyrazole, pyridine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine, and tetraazaindene; are more preferably imidazole, pyridine, pyrimidine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole, and tetraazaindene; are still more preferably imidazole, pyridine, pyrimidine, pyrazine, pyridazine; triazole, triazine, thiadiazole, quinoline, phthalazine, naphthyridine, quinoxaline, quinazoline, cinnoline, tetrazole, triazole, benzimidazole, and benzthiazole; and are most preferably pyridine, thiadiazole, quinoline, and benzthiazole.

The aryl group and heterocyclic group represented by Q₂ may have a substituent other than —YU—C(X₁)(X₂)(X₃). Substituents are preferably an alkyl group, an alkenyl group, an aryl group, an alkoxy group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylimino group, a sulfamoyl group, a carbamoyl group, a sulfonyl group, a ureido group, a phosphoric acid amide group, a halogen atom, a cyano group, a sulfo group, a carboxyl group, a nitro group, and a heterocyclic group; are more preferably an alkyl group, an aryl group, an alkoxy group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoric acid amide group, a halogen atom, a cyano group, a nitro group, and a heterocyclic group; are more preferably an alkyl group, an aryl group, an alkoxy group, an aryloxy group, an acyl group, an acylamino group, a sulfonylimino group, a sulfamoyl group, a carbamoyl group, a halogen atom, a cyano group, a nitro group, and a heterocyclic group; and are most preferably an alkyl group, an aryl group, are a halogen atom.

Each of X₁, X₂, and X₃ is preferably a halogen atom, a haloalkyl group, an acyl group, an alkoxycarbonyl group, an aryloxycarbonyl group, a carbamoyl group, a sulfamoyl group, a sulfonyl group, or a heterocyclic group; is more preferably a halogen atom, a haloalkyl group, an acyl group, an alkoxycarbonyl group, an aryloxycarbonyl group, or a sulfonyl group; is still more preferably a halogen atom or a trihalomethyl group; and is most preferably a halogen atom. Of halogen atoms preferred are a chlorine atom, a bromine atom and an iodine atom. Of these, a chlorine atom and a bromine atom are more preferred and a bromine atom is particularly preferred.

Y represents —C(═O)— or —SO₂—, and is preferably —SO₂—.

The added amount of these compounds is commonly 1×10⁻⁴ to 1 mol per mol of silver, and is preferably 1×10⁻³ to 5×10⁻² mol.

Incidentally, in the imaging materials according to the present invention, it is possible to use those disclosed in JP-A No. 2003-5041 in the manner as the compounds represented by aforesaid Formula (OFI).

Specific examples of the compounds represented by Formula (OFI) are listed below, however, the present invention is not limited thereto. 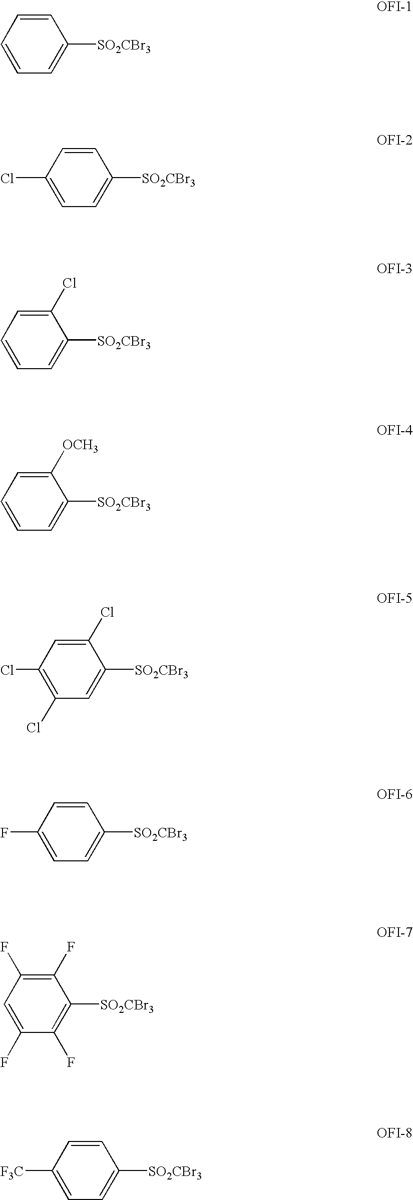 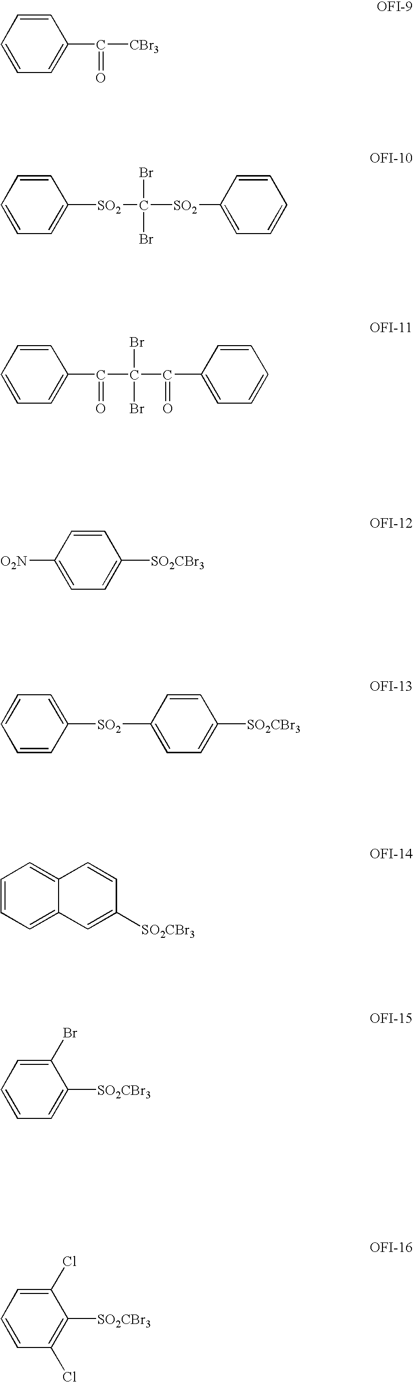 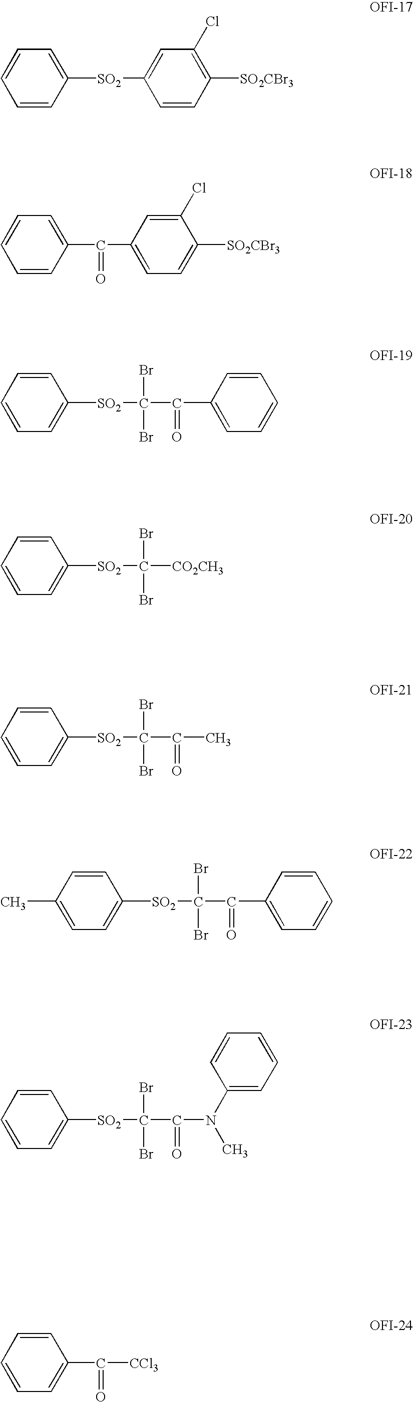 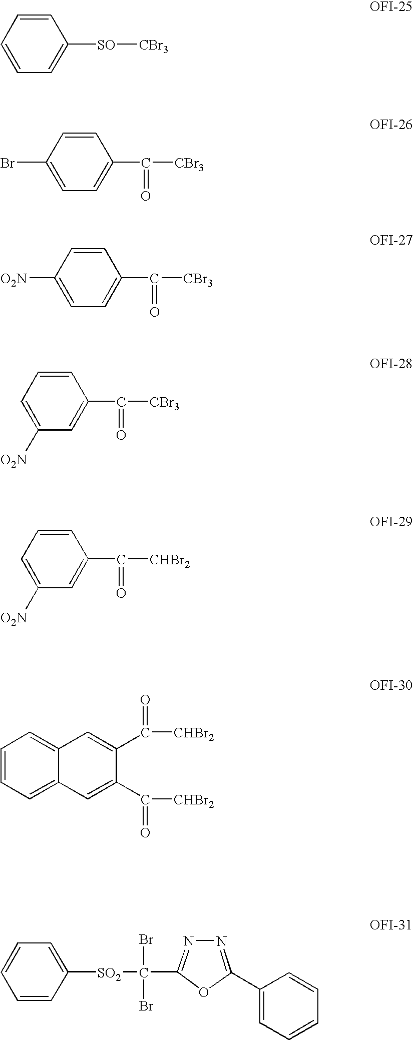 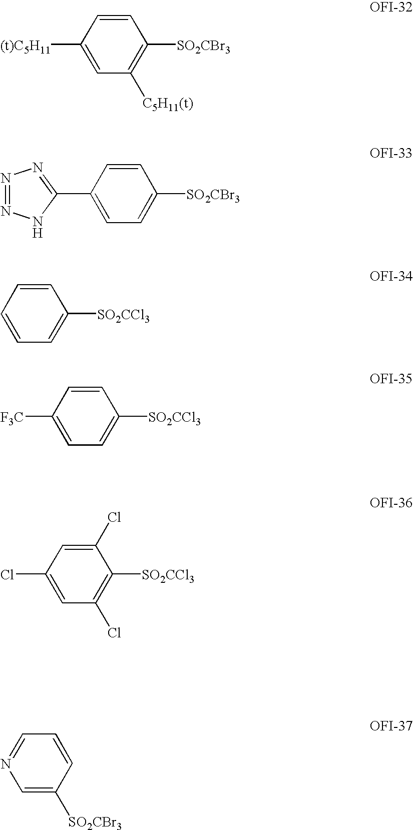 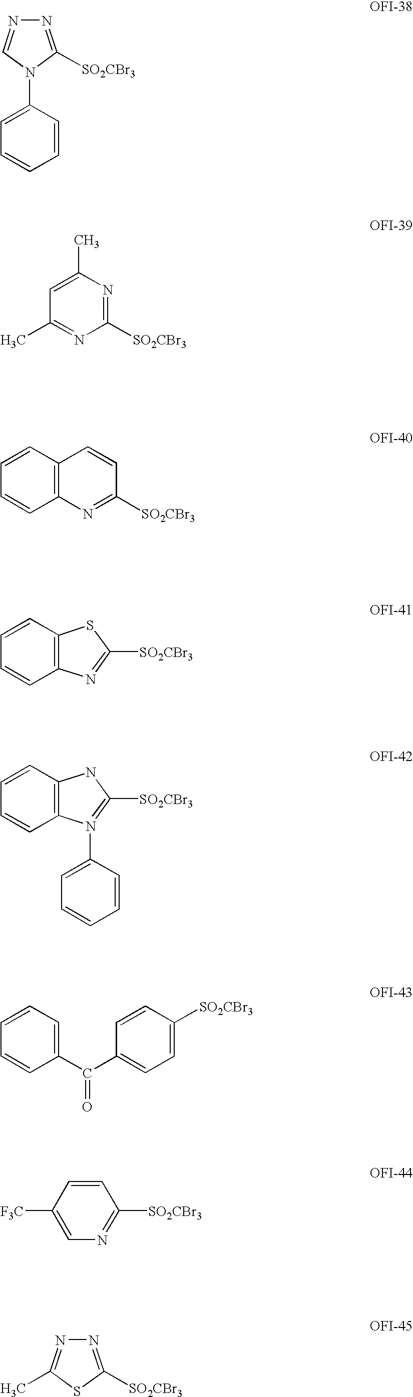 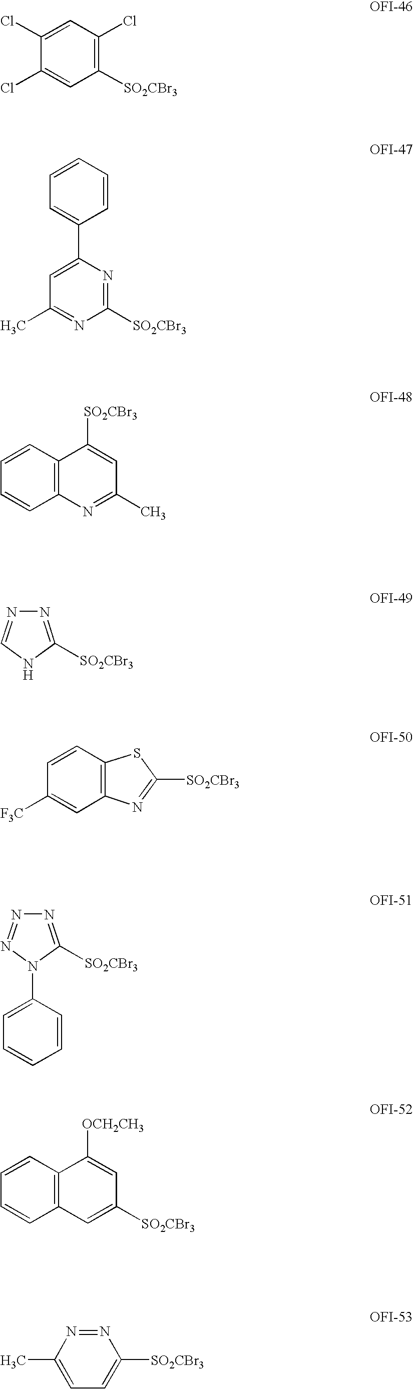 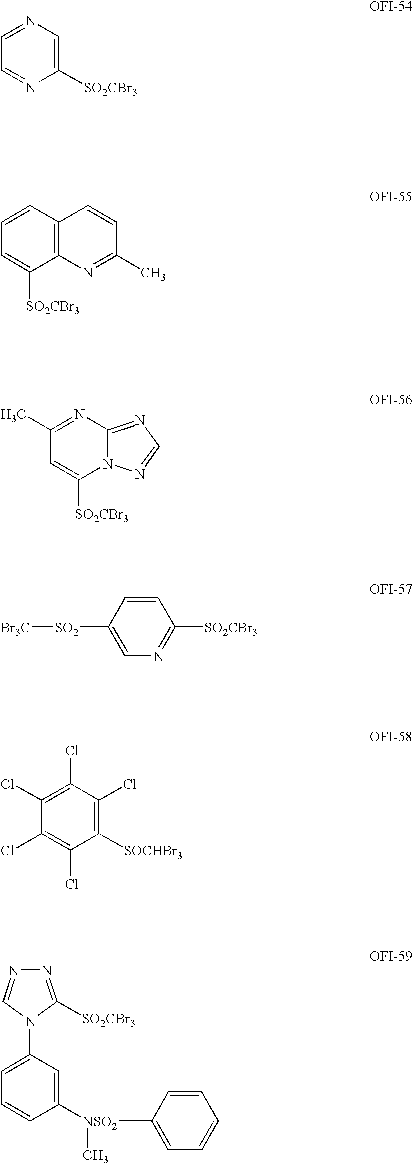 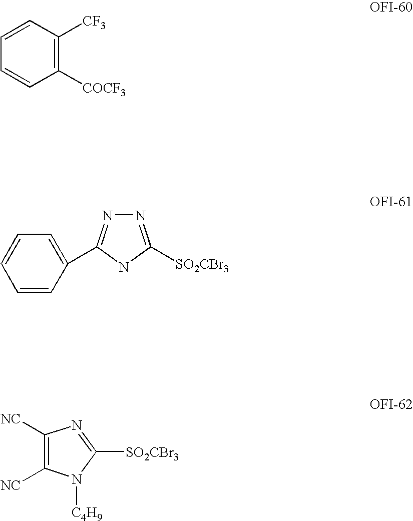
Reducing Agents for Silver Ions

In this present invention, there may be employed, as a reducing agent for silver ions (hereinafter occasionally referred simply to as a reducing agent), polyphenols described in U.S. Pat. Nos. 3,589,903 and 4,021,249, British Patent No. 1,486,148, JP-A Nos. 51-5193350-36110, 50-116023, and 52-84727, and Japanese Patent Publication No. 51-35727; bisnaphthols such as 2,2′-dihydroxy-1,1′-binaphthyl and 6,6′-dibromo-2,2′-dihydroxy-1,1′-binaphthyl described in U.S. Pat. No. 3,672,904; sulfonamidophenols and sulfonamidonaphthols such as 4-benzenesulfonamidophenol, 2-benznesulfonamidophenol, 2,6-dichloro-4-benenesulfonamidophenol, and 4-benznesulfonamidonaphthol described in U.S. Pat. No. 3,801,321.

In the present invention, preferred reducing agents for silver ions are compounds represented by the following formula (RED): 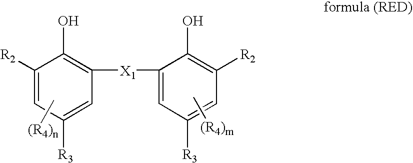
wherein X₁ is a chalcogen atom or CHR₁ in which R₁ is a hydrogen atom, a halogen atom, an alkyl group, alkenyl group, an aryl group or a heterocyclic group; R₂ is an alkyl group; R₃ is a hydrogen atom or a group capable of being substituted on a benzene ring; R₄ is a group capable of being substituted on a benzene ring; m and n are each an integer of 0 to 2.

The foregoing formula (RED) will be detailed below. In the formula (RED), X₁ represents a chalcogen atom or CHR₁. Specific examples of a chalcogen atom include a sulfur atom, a selenium atom, and a tellurium atom. Of these, a sulfur atom is preferred. In the foregoing CHR₁, R₁ represents a hydrogen atom, a halogen atom, an alkyl group, an alkenyl group, an alkynyl group, an aryl group or a heterocyclic group. Halogen atoms include, for example, a fluorine atom, a chlorine atom, and a bromine atom. Examples of an alkyl group include alkyl groups having 1-20 carbon atoms, for example, a methyl group, an ethyl group, a propyl group, a butyl group, a hexyl group, a heptyl group and a cycloalkyl group. Examples of alkenyl groups are, a vinyl group, an allyl group, a butenyl group, a hexenyl group, a hexadienyl group, an ethenyl-2-propenyl group, a 3-butenyl group, a 1-methyl-3-propenyl group, a 3-pentenyl group, a 1-methyl-3-butenyl group and a cyclohexenyl group. Examples of aryl groups are, a phenyl group and a naphthyl group. Examples of heterocylic groups are, a thienyl group, a furyl group, an imidazolyl group, a pyrazolyl group and a pyrrolyl group. Of these, cyclic groups such as cycloalkyl groups and cycloalkenyl groups are preferred.

These groups may have a substituent. Examples of the substituents include a halogen-atom (for example, a fluorine atom, a chlorine atom, or a bromine atom), a cycloalkyl group (for example, a cyclohexyl group or a cyclobutyl group), a cycloalkenyl group (for example, a 1-cycloalkenyl group or a 2-cycloalkenyl group), an alkoxy group (for example, a methoxy group, an ethoxy group, or a propoxy group), an alkylcarbonyloxy group (for example, an acetyloxy group), an alkylthio group (for example, a methylthio group or a trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl-group (for example, a methanesulfonyl group and a trifluoromethanesulfonyl group), a carbamoyl group (for example, a carbamoyl group, an N,N-dimethylcarbamoyl group, or an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamido group (for example, a methanesulfonamido group or a butanesulfonamido group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetamidocarbonyl group or a methoxyacetamidocarbonyl group), and an alkylsulfinylaminocarbonyl group (for example, a methanesulfinylaminocarbonyl group or an ethanesulfinylaminocarbonyl group). Further, when at least two substituents are present, they may be the same or different. Of these, an alkyl group is specifically preferred.

R₂ represents an alkyl group. Preferred as the alkyl groups are those, having 1-20 carbon atoms, which are substituted or unsubstituted. Specific examples include a methyl, ethyl, i-propyl, butyl, i-butyl, t-butyl, t-pentyl, t-octyl, cyclohexyl, 1-methylcyclohexyl, or 1-methylcyclopropyl group.

Substituents of the alkyl group are not particularly limited and include, for example, an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom. In addition, (R₄)ₙ and (R₄)ₘ may form a saturated ring. R₂ is preferably a secondary or tertiary alkyl group and preferably has 2-20 carbon atoms. R₂ is more preferably a tertiary alkyl group, is still more preferably a t-butyl group, a t-pentyl group, or a methylcyclohexyl group, and is most preferably a t-butyl group.

R₃ represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group.

R₃ preferably is methyl, ethyl, i-propyl, t-butyl, cyclohexyl, 1-methylcyclohexyl, or 2-hydroxyethyl. Of these, 2-hydroxyethyl is more preferred.

These groups may further have a substituent. Employed as such substituents may be those listed in aforesaid R₁.

Further, R₃ is more preferably an alkyl group having 1-10 carbon atoms. Specifically listed is the hydroxyl group disclosed in Japanese Patent Application No. 2002-120842, or an alkyl group, such as a 2-hydroxyethyl group, which has as a substituent a group capable of forming a hydroxyl group while being deprotected. In order to achieve high maximum density (Dmax) at a definite silver coverage, namely to result in silver image density of high covering power (CP), sole use or use in combination with other kinds of reducing agents is preferred.

The most preferred combination of R₂ and R₃ is that R₂ is a tertiary alkyl group (t-butyl, or 1-methylcyclohexyl) and R₃ is an alkyl group, such as a 2-hydoxyethyl group, which has, as a substituent, a hydroxyl group or a group capable of forming a hydroxyl group while being deprotected. Incidentally, a plurality of R₂ and R₃ is may be the same or different.

R₄ represents a group capable of being substituted to a benzene ring. Listed as specific examples may be an alkyl group having 1-25 carbon atoms (methyl, ethyl, propyl, i-propyl, t-butyl, pentyl, hexyl, or cyclohexyl), a halogenated alkyl group (trifluoromethyl or perfluorooctyl), a cycloalkyl group (cyclohexyl or cyclopentyl); an alkynyl group (propagyl), a glycidyl group, an acrylate group, a methacrylate group, an aryl group (phenyl), a heterocyclic group (pyridyl, thiazolyl, oxazolyl, imidazolyl, furyl, pyrrolyl, pyradinyl, pyrimidyl, pyridadinyl, selenazolyl, piperidinyl, sliforanyl, piperidinyl, pyrazolyl, or tetrazolyl), a halogen atom (chlorine, bromine, iodine or fluorine), an alkoxy group (methoxy, ethoxy, propyloxy, pentyloxy, cyclopentyloxy, hexyloxy, or cyclohexyloxy), an aryloxy group (phenoxy), an alkoxycarbonyl group (methyloxycarbonyl, ethyloxycarbonyl, or butyloxycarbonyl), an aryloxycarbonyl group (phenyloxycarbonyl), a sulfonamido group (methanesulfonamide, ethanesulfonamide, butanesulfonamide, hexanesulfonamide group, cyclohexabesulfonamide, benzenesulfonamide), sulfamoyl group (aminosulfonyl, methyaminosulfonyl, dimethylaminosulfonyl, butylaminosulfonyl, hexylaminosulfonyl, cyclohexylaminosufonyl, phenylaminosulfonyl, or 2-pyridylaminosulfonyl), a urethane group (methylureido, ethylureido, pentylureido, cyclopentylureido, phenylureido, or 2-pyridylureido), an acyl group (acetyl, propionyl, butanoyl, hexanoyl, cyclohexanoyl, benzoyl, or pyridinoyl), a carbamoyl group (aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (acetamide, propionamide, butaneamide, hexaneamide, or benzamide), a sulfonyl group (methylsulfonyl, ethylsulfonyl, butylsulfonyl, cyclohexylsulfonyl, phenylsulfonyl, or 2-pyridylsulfonyl), an amino group (amino, ethylamino, dimethylamino, butylamino, cyclopentylamino, anilino, or 2-pyridylamino), a cyano group, a nitro group, a sulfo group, a carboxyl group, a hydroxyl group, and an oxamoyl group. Further, these groups may further be substituted with these groups. Each of n and m represents an integer of 0-2. However, the most preferred case is that both n and m are 0. A plurality of R₄s may be the same or different.

Further, R₄ may form a saturated ring together with R₂ and R₃. R₄ is preferably a hydrogen atom, a halogen atom, or an alkyl group, and is more preferably a hydrogen atom.

Specific examples of the compounds represented by formula (RED) are listed below. However, the present invention is not limited thereto.

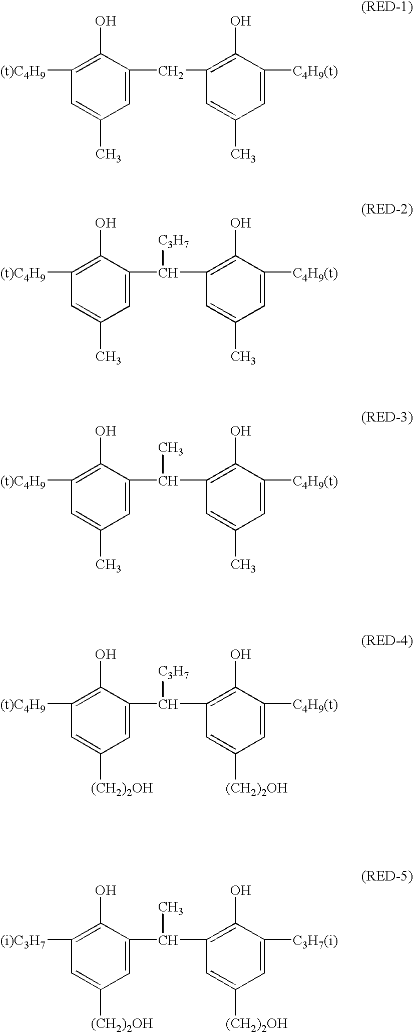

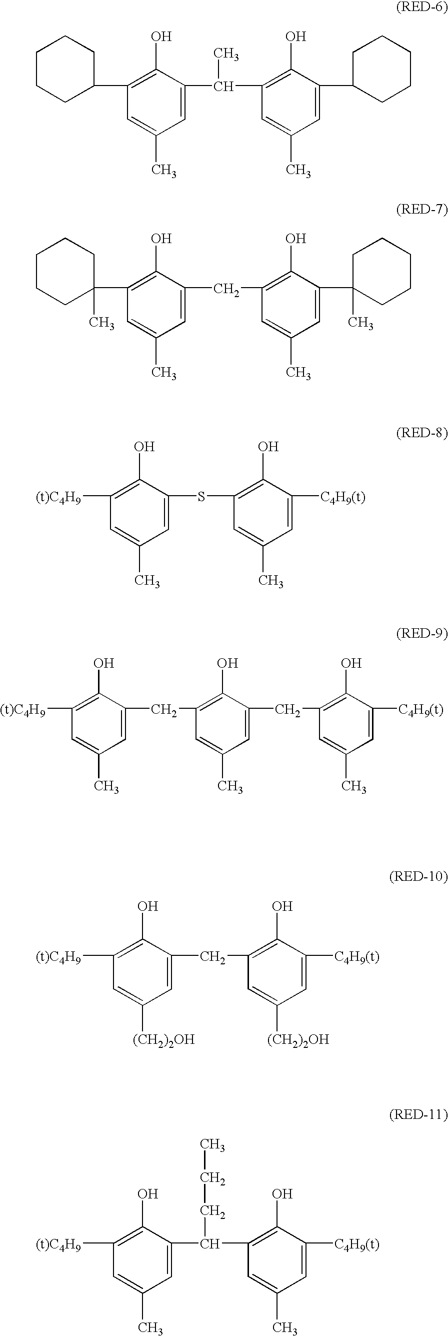

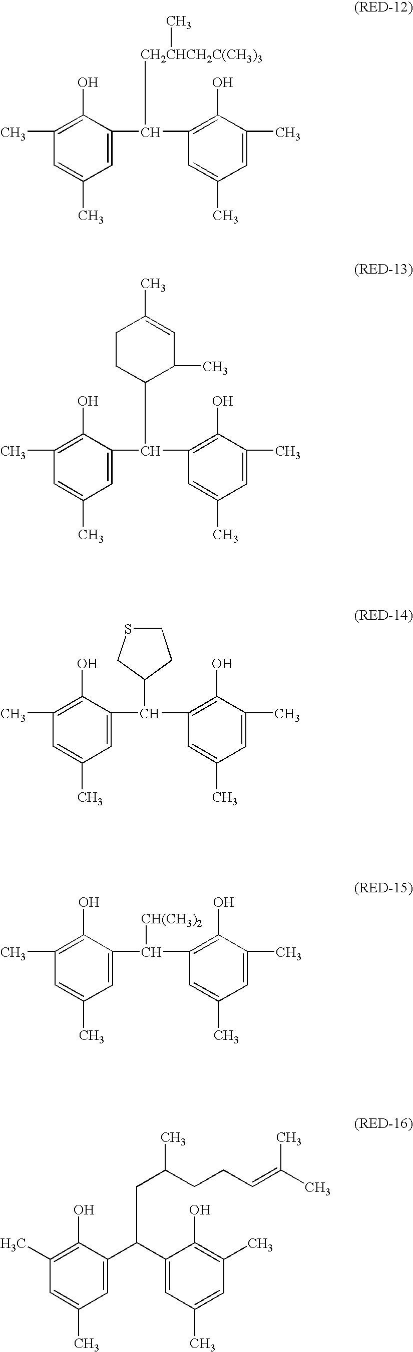

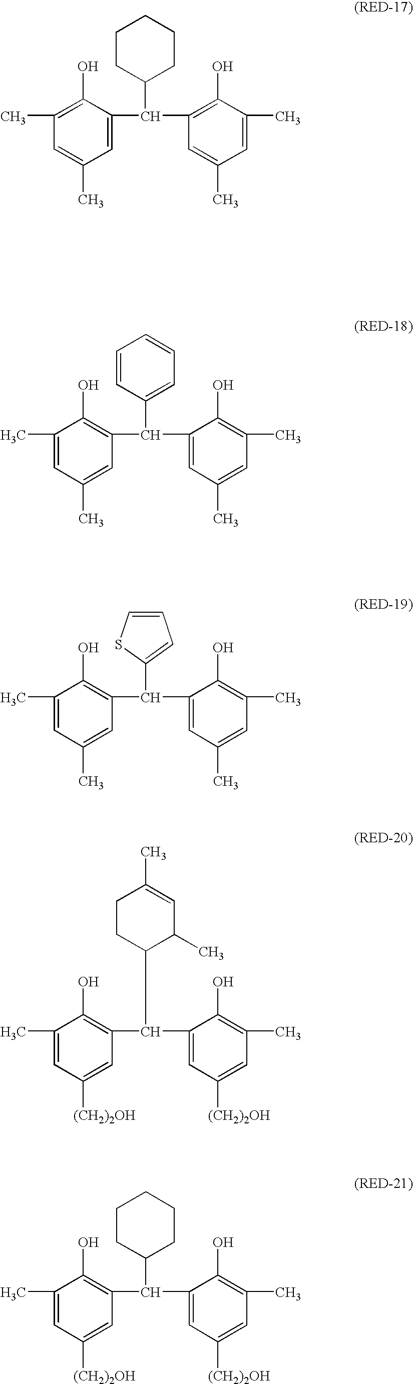

It is possible to synthesize these compounds (bisphenol compounds) represented by Formula (RED) employing conventional methods known in the art (for example, referred to Japanese Patent Application No. 2002-147562).

The specific examples of the synthesis methods will now be described.

Synthesis of Compound (RED-13)

Dissolved in 5.94 ml of water was 1.97 g of sodium hydroxide, and subsequently added were 30.1 g of 2,4-xylenol and 15 ml of toluene. Thereafter, the water and toluene were distilled out at 120° C. The resulting reaction solution was then cooled to room temperature, and 13.65 g of 2,4-dimethyl-3-cyclohexanecarboxyaldehyde was added and the resulting mixture was stirred at 120° C. for 8 hours. While distilling out the resulting water, stirring was carried out for 12 hours under heating. Thereafter, heating was terminated. When the reaction solution was cooled to 80° C., 64 ml of heptane was gradually added, whereby the resulting reaction solution was dispersed. After cooling to room temperature by being allowed to stand, a solution prepared by mixing 5.28 g of concentrated hydrochloric acid and 14.4 ml of water were added, and the resulting mixture was stirred for 4 hours. After cooling the resulting mixture employing iced water for an additional 4 hours while stirring, filtration was carried out. Thereafter, washing was carried out employing 54 ml of heptane, whereby crude crystals were obtained. The resulting crude crystals were dissolved in 133 ml of acetonitrile while heated. After filtration, 88 ml of water was added and stirring was carried out for 4 hours at room temperature. Further, stirring was carried out while being cooled employing iced water for an additional 4 hours, and deposited crystals were collected by filtration, whereby 28.8 g (at a yield of 80 percent) of the targeted compound was obtained.

The aforesaid crystals were mixed crystals consisting of 25 percent (being a mol percentage) of cis form and 75 percent of trans form, resulting in a melting point of 198.5-199.5° C.

Employing the same method as above, 100 g of a cis form/trans form mixture was obtained. After dissolving the resulting mixture in 800 ml of acetone while heating, the resulting solution was cooled to room temperature while allowed to stand, and stirring continued throughout the night without any modification. Deposited crystals were collected via filtration and dried under vacuum for 15 hours, whereby crystals comprised of a trans form as a main component were obtained. On the other hand, the mother liquor was concentrated to approximately ⅓ of the original volume, whereby 10.9 g of crystals comprised of cis-form as a main component was obtained. The aforesaid mother liquor was further concentrated to ⅔ of the original volume, into which cis-form seed crystals were placed while stirring, whereby 3.2 g of cis-form crystals as a main component was obtained. Subsequently, dissolved in 100 ml of tetrahydrofuran were the aforesaid two types of crystals comprised of cis-form as a main component. Subsequently, while performing partial concentration employing an evaporator, 300 ml of hexane was added and the total volume was concentrated to approximately 100 ml. Thereafter, deposited crystals were collected via filtration and dried at 40° C. for 4 hours under vacuum, whereby 11.1 g of cis-form Crystals (1) comprised as a main component was obtained.

The mother liquors were collected and concentrated, whereby 24.4 g residue was obtained. All the resulting residue was separated into a fraction containing trans form in a greater amount and a fraction containing the cis-form, employing gas chromatography (500 g of silica gel and isopropyl ether/hexane=1/4). The residue which was obtained by concentrating the fraction containing cis form in a greater amount was dissolved in tetrahydrofuran, and while performing partial concentration, hexane was added. Deposited crystals were collected via filtration, whereby 12.5 g of cis form crystals as a main component was obtained. The resulting crystals were again dissolved in 100 ml of tetrahydrofuran while added by 300 ml of hexane, and the resulting solution was concentrated to approximately 100 ml. Thereafter, deposited crystals were collected via filtration and dried at 60° C. for 4 hours under vacuum, whereby 7.8 g of cis form Crystals (2) as a main component was obtained.

Subsequently, 11.1 g of aforesaid cis form crystals (1) as a main component and 7.8 g of Crystals (2) were mixed and dissolved in 300 ml of tetrahydrofuran. After an active carbon treatment, while performing partial concentration, 1,000 ml of hexane was added, and the resulting mixture was concentrated to approximately 300 ml. Thereafter, deposited crystals were collected via filtration and dried at 60° C. for 4 hours under vacuum. The resulting crystals were suspended in 200 ml of hexane, stirred for 30 minutes, and collected via filtration, dried for 15 hours under vacuum, whereby 15.3 g of cis form crystals (at a purity of 99.9 percent) was obtained at a melting point of 190° C.

Synthesis of Compound RED-10

First Step:

In a 100 ml 4-necked flask fitted with a refluxing device and a stirrer were added 10.0 g (7.24×10⁻² mol) of 4-hydroxyphenetyl alcohol, 13.7 g (1.19×10⁻¹ mol) of 85 percent phosphoric acid, and 50.0 ml of toluene. After heating the resulting mixture to 95-100° C. while stirring, a solution consisting of 90 g (7.96×10⁻² mol) and 6.00 ml of toluene was dripped over a period of 30 minutes while maintaining the temperature of the solution in the range of from 90 to 100° C.

After completion of the dripping, the resulting mixture was stirred for one hour at the same temperature. Thereafter, the interior temperature was lowered to 50° C., and 25.0 ml of ethyl acetate and 50.0 ml of water were added. Subsequently, the content was transferred to a separating funnel. After performing washing three times employing 50.0 ml of water each time, the pH was adjusted to 6-7 by the addition of an aqueous Na₂CO₃ solution. Further, after performing washing employing a saturated sodium chloride solution, the water in the organic layer was removed by MgSO₄.

After dehydration, MgSO₄ was removed via filtration, and solvents were distilled out under vacuum. After completion of the distilling-out, a product in the form of glutinous starch syrup was obtained, resulting in a yield of 14.0 g. The resulting product was dissolved in 28 ml of toluene, and employed in the subsequent step without any modification.

Second Step

Into a 100 ml flask fitted with a refluxing device and a stirrer were added the entire first step product (being a toluene solution), 1.4 g (7.24×10⁻³ mol) of p-tolunesulfonic acid monohydrate, and 1.2 g (3.98×10⁻² mol) of paraformaldehyde. The resulting mixture underwent reaction at 70 to 75° C. for 3 hours.

After completion of the reaction, 30.0 ml of ethyl acetate and 20.0 ml of water were added to the reaction product, and the resulting mixture was then transferred to a separating flask.

Washing was performed employing 20.0 ml of water and the pH was adjusted to 6-7. Further, after washing employing a saturated sodium chloride solution, water in the organic layer was removed employing MgSO₄. After dehydration, MgSO₄ was removed via filtration, and solvents were distilled out under vacuum. After completion of the distilling-out, a product in the form of a glutinous starch syrup was obtained. The resulting product was subjected to column purification*1. The separated targeted product was dissolved in 11.5 ml of dichloromethane, cooled by iced water and crystallized, whereby crude crystals were obtained, resulting in a crude yield of 9.5 g (65 percent).

Crude crystals were dissolved in 9.5 ml of ethyl acetate and the resulting solution was chilled by iced water to result in crystallization, whereby a targeted product was obtained, resulting in a crude yield of 9.5 g (65 percent). *1: Due to a minute amount of impurities which were formed in the first step, it was difficult to achieve crystallization without any modification, and as a result, column purification was reluctantly performed.

Incidentally, the second step proceeds at a high reaction rate. Therefore, if it is possible to sufficiently remove impurities formed in the first step, the aforesaid column purification becomes unnecessary.

The amount of silver ion reducing agents employed in the photothermographic materials of the present invention varies depending on the types of organic silver salts, reducing agents and other additives. However, the aforesaid amount is customarily 0.05-10 mol per mol of organic silver salts, and is preferably 0.1-3 mol. Furthers in the aforesaid range, silver ion reducing agents of the present invention may be employed in combinations of at least two types. Namely, in view of achieving images exhibiting excellent storage stability, high image quality and high CP, it is preferable to simultaneously use reducing agents which differ in reactivity, due to a different chemical structure.

In the present invention, preferred cases occasionally occur in which the aforesaid reducing agents are added, just prior to coating, to a photosensitive emulsion comprised of photosensitive silver halide, organic silver salt particles, and solvents and the resulting mixture is coated to minimize variations of photographic performance due to the standing time.

Further, hydrazine derivatives and phenol derivatives represented by Formulas (1) to (4) in JP-A No. 2003-43614, and Formulas (1) to (3) in JP-A No. 2003-66559 are preferably employed as a development accelerator which are simultaneously employed with the aforesaid reducing agents.

The oxidation potential of development accelerators employed in the silver salt photothermographic materials of the present invention, which is determined by polarographic measurement, is preferably lower 0.01 to 0.4 V, and is more preferably lower 0.01 to 0.3 V than that of the compounds represented by general formula (RED). Incidentally, the oxidation potential of the aforesaid development accelerators is preferably 0.2 to 0.6 V, which is polarographically determined in a solvent mixture of tetrahydrofuran:Britton Robinson buffer solution=3:2 the pH of which is adjusted to 6 employing an SCE counter electrode, and is more preferably 0.3 to 0.55 V. Further, the pKa value in a solvent mixture of tetrahydrofuran:water=3:1 is preferably 3 to 12, and is more preferably 5 to 10. It is particularly preferable that the oxidation potential which is polarographically determined in the solvent mixture of tetrahydrofuran:Britton Robinson buffer solution=3:2, the pH of which is adjusted to 6, employing an SCE counter electrode is 0.3 to 0.55, and the pKa value in the solvent mixture of tetrahydrofuran:water=3:2 is 5 to 10.

Further, as silver ion reducing agents according to the present invention, there may be employed various types of reducing agents disclosed in European Patent No. 1,278,101 and JP-A No. 2003-15252.

The amount of silver ion reducing agents employed in the photothermographic imaging materials of the present invention varies depending on the types of organic silver salts, reducing agents, and other additives. However, the aforesaid amount is customarily 0.05 to 10 mol per mol of organic silver salts and is preferably 0.1 to 3 mol. Further, in this amount range, silver ion reducing agents of the present invention may be employed in combinations of at least two types. Namely, in view of achieving images exhibiting excellent storage stability, high image quality, and high CP, it is preferable to simultaneously employ reducing agents which differ in reactivity due to different chemical structure. Preferred cases occasionally occur in which when the aforesaid reducing agents are added to and mixed with a photosensitive emulsion comprised of photosensitive silver halide, organic silver salt particles, and solvents just prior to coating, and then coated, variation of photographic performance during standing time is minimized.

Chemical Sensitization

Silver halide grains used in the invention can be subjected to chemical sensitization. In accordance with methods described in JP-A Nos. 2001-249428 and 2001-249426, for example, a chemical sensitization center (chemical sensitization speck) can be formed using compounds capable of releasing chalcogen such as sulfur or noble metal compounds capable of releasing a noble metal ion such as a gold ion. In this invention, it is preferred to conduct chemical sensitization with an organic sensitizer-containing a chalcogen atom, as described below. Such a chalcogen atom-containing organic sensitizer is preferably a compound containing a group capable of being adsorbed onto silver halide and a labile chalcogen atom site. These organic sensitizers include, for example, those having various structures, as described in JP-A Nos. 60-150046, 4-109240 and 11-218874. Specifically preferred of these is at least a compound having a structure in which a chalcogen atom is attacked to a carbon or phosphorus atom through a double bond. Specifically, heterocycle-containing thiourea derivatives and triphenylphosphine sulfide derivatives are preferred. A variety of techniques for chemical sensitization employed in silver halide photographic material for use in wet processing are applicable to conduct chemical sensitization, as described, for example, in T. H. James, The Theory of the Photographic Process, 4th Ed. (Macmillan Publishing Co., Ltd., 1977 and Nippon Shashin Gakai Ed., “Shashin Kogaku no Kiso (Gin-ene Shashin)” (Corona Co., Ltd., 1998). The amount of a chalcogen compound added as an organic sensitizer is variable, depending on the chalcogen compound to be used, silver halide grains and a reaction environment when subjected to chemical sensitization and is preferably 10⁻⁸ to 10⁻² mol, and more preferably 10⁻⁷ to 10⁻³ mol per mol of silver halide. In the invention, the chemical sensitization environment is not specifically limited but it is preferred to conduct chemical sensitization in the presence of a compound capable of eliminating a silver chalcogenide or silver specks formed on the silver halide grain or reducing the size thereof, or specifically in the presence of an oxidizing agent capable of oxidizing the silver specks, using a chalcogen atom-containing organic sensitizer. To conduct chemical sensitization under preferred conditions, the pAg is preferably 6 to 11, and more preferably 7 to 10, the pH is preferably 4 to 10 and more preferably 5 to 8, and the temperature is preferably not more than 30° C.

Chemical sensitization using the foregoing organic sensitizer is also preferably conducted in the presence of a spectral sensitizing dye or a heteroatom-containing compound capable of being adsorbed onto silver halide grains. Thus, chemical sensitization in the present of such a silver halide-adsorptive compound results in prevention of dispersion of chemical sensitization center specks, thereby achieving enhanced sensitivity and minimized fogging. Although there will be described spectral sensitizing dyes used in the invention, preferred examples of the silver halide-adsorptive, heteroatom-containing compound include nitrogen containing heterocyclic compounds described in JP-A No. 3-24537. In the heteroatom-containing compound, examples of the heterocyclic ring include a pyrazolo ring, pyrimidine ring, 1,2,4-triazole ring, 1,2,3-triazole ring, 1,3,4-thiazole ring, 1,2,3-thiadiazole ring, 1, 2, 4-thiadiazole ring, 1,2,5-thiadiazole ring, 1,2,3,4-tetrazole ring, pyridazine ring, 1,2,3-triazine ring, and a condensed ring of two or three of these rings, such as triazolotriazole ring, diazaindene ring, triazaindene ring and pentazaindene ring. Condensed heterocyclic ring comprised of a monocycic hetero-ring and an aromatic ring include, for example, a phthalazine ring, benzimidazole ring indazole ring, and benzthiazole ring. Of these, an azaindene ring is preferred and hydroxy-substituted azaindene compounds, such as hydroxytriazaindene, tetrahydroxyazaindene and hydroxypentazaundene compound are more preferred. The heterocyclic ring may be substituted by substituent groups other than hydroxy group. Examples of the substituent group include an alkyl group, substituted alkyl group, alkylthio group, amino group, hydroxyamino group, alkylamino group, dialkylamino group, arylamino group, carboxy group, alkoxycarbonyl group, halogen atom and cyano group. The amount of the heterocyclic ring containing compound to be added, which is broadly variable with the size or composition of silver halide grains, is within the range of 10⁻⁶ to 1 mol, and preferably 10⁻⁴ to 10⁻¹ mol per mol silver halide.

As described earlier, silver halide grains can be subjected to noble metal sensitization using compounds capable of releasing noble metal ions such as a gold ion. Examples of usable gold sensitizers include chloroaurates and organic gold compounds. In addition to the foregoing sensitization, reduction sensitization can also be employed and exemplary compounds for reduction sensitization include ascorbic acid, thiourea dioxide, stannous chloride, hydrazine derivatives, borane compounds, silane compounds and polyamine compounds. Reduction sensitization can also conducted by ripening the emulsion while maintaining the pH at not less than 7 or the pAg at not more than 8.3. Silver halide to be subjected to chemical sensitization may be one which has been prepared in the presence of an organic silver salt, one which has been formed under the condition in the absence of the organic silver salt, or a mixture thereof.

When the surface of silver halide grains is subjected to chemical sensitization, it is preferred that an effect of the chemical sensitization substantially disappears after subjected to thermal development. An effect of chemical sensitization substantially disappearing means that the sensitivity of the photothermographic material, obtained by the foregoing chemical sensitization is reduced, after thermal development, to not more than 1.1 times that of the case not having been subjected to chemical sensitization. To allow the effect of chemical sensitization to disappear, it is preferred to allow an oxidizing agent such as a halogen radical-releasing compound which is capable of decomposing a chemical sensitization center (or chemical sensitization nucleus) through an oxidation reaction to be contained in an optimum amount in the light-sensitive layer and/or the light-insensitive layer. The content of an oxidizing agent is adjusted in light of oxidizing strength of an oxidizing agent and chemical sensitization effects.

There may be further used sensitizing dyes other than those described above as long as they do not result in adversely effects. Examples of the spectral sensitizing dye include cyanine, merocyanine, complex cyanine, complex merocyanine, holo-polar cyanine, styryl, hemicyanine, oxonol and hemioxonol dyes, as described in JP-A Nos. 63-159841, 60-140335, 63-231437, 63-259651, 63-304242, 63-15245; U.S. Pat. Nos. 4,639,414, 4,740,455, 4,741,966, 4,751,175 and 4,835,096. Usable sensitizing dyes are also described in Research Disclosure (hereinafter, also denoted as RD) 17643, page 23, sect. IV-A (December, 1978), and ibid 18431, page 437, sect. X (August, 1978). It is preferred to use sensitizing dyes exhibiting spectral sensitivity suitable for spectral characteristics of light sources of various laser imagers or scanners. Examples thereof include compounds described in JP-A Nos. 9-34078, 9-54409 and 9-80679.

Useful cyanine dyes include, for example, cyanine dyes containing a basic nucleus, such as thiazoline, oxazoline, pyrroline, pyridine, oxazole, thiazole, selenazole and imidazole nuclei. Useful merocyanine dyes preferably contain, in addition to the foregoing nucleus, an acidic nucleus such as thiohydatoin, rhodanine, oxazolidine-dione, thiazoline-dione, barbituric acid, thiazolinone, malononitrile and pyrazolone nuclei. In the invention, there are also preferably used sensitizing dyes having spectral sensitivity within the infrared region. Examples of the preferred infrared sensitizing dye include those described in U.S. Pat. Nos. 4,536,478, 4,515,888 and 4,959,294.

The photothermographic material preferably contains at least one of sensitizing dyes described in Japanese Patent Application No. 2003-102726, represented by the following formulas (SD-1) and (SD-2): 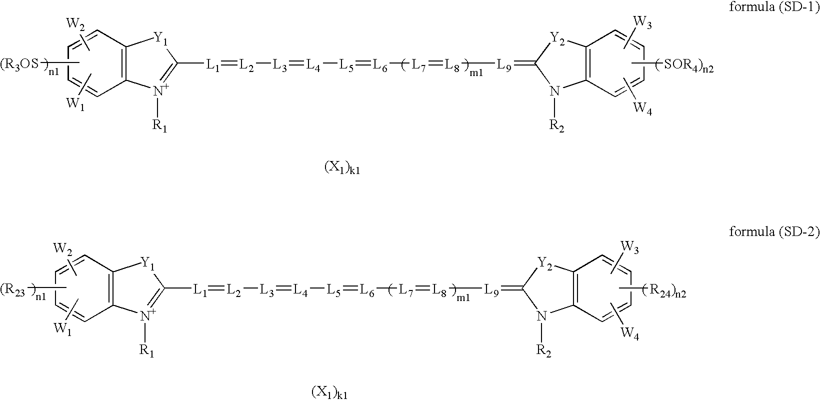
wherein Y₁ and Y₂ are each an oxygen atom, a sulfur atom, a selenium atom or —CH═CH—; L₁ to L₉ are each a methine group; R₁ and R₂ are an aliphatic group; R₃, R₄, R₂₃ and R₂₄ are each a lower alkyl group, a cycloalkyl group, an alkenyl group, an aralkyl group, an aryl group or a heterocyclic group; W₁, W₂, W₃ and W₄ are each a hydrogen atom, a substituent or an atom group necessary to form a ring by W₁ and W₂ or W₃ and W₄, or an atom group necessary to form a 5- or 6-membered ring by R₃ and W₁, R₃ and W₂, R₂₃ and W₁, R₂₃ and W₂, R₄ and W₃, R₄ and W₄, R₂₄ and W₃, or R₂₄ and W₄; X₁ is an ion necessary to compensating for a charge within the molecule; k1 is the number of ions necessary to compensate for a charge within the molecule; m1 is 0 or 1; n1 and n2 are each 0, 1 or 2, provided that n1 and n2 are not 0 at the same time.

The infrared sensitizing dyes and spectral sensitizing dyes described above can be readily synthesized according to the methods described in F. M. Hammer, The Chemistry of Heterocyclic Compounds vol. 18, “The cyanine. Dyes and Related Compounds” (A. Weissberger ed. Interscience Corp., New York, 1964).

The infrared sensitizing dyes can be added at any time after preparation of silver halide. For example, the dye can be added to a light sensitive emulsion containing silver halide grains/organic silver salt grains in the form of by dissolution in a solvent or in the form of a fine particle dispersion, so-called solid particle dispersion. Similarly to the heteroatom containing compound having adsorptivity to silver halide, after adding the dye prior to chemical sensitization and allowing it to be adsorbed onto silver halide grains, chemical sensitization is conducted, thereby preventing dispersion of chemical sensitization center specks and achieving enhanced sensitivity and minimized fogging.

These sensitizing dyes may be used alone or in combination thereof. The combined use of sensitizing dyes is often employed for the purpose of supersensitization, expansion or adjustment of the light-sensitive wavelength region. A super-sensitizing compound, such as a dye which does not exhibit spectral sensitization or substance which does not substantially absorb visible light may be incorporated, in combination with a sensitizing dye, into the emulsion containing silver halide and organic silver salt used in photothermographic imaging materials of the invention.

Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A 59-19032, 59-192242 and 5-341432. In the invention, an aromatic heterocyclic mercapto compound represented by the following formula is preferred as a supersensitizer:
Ar-SM
wherein M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver-halide grain emulsion is also included in the invention. In particular, a preferred example thereof is a disulfide compound represented by the following formula:
Ar—S—S—Ar
wherein Ar is the same as defined in the mercapto compound represented by the formula described earlier.

The aromatic heterocyclic rings described above may be substituted with a halogen atom (e.g., Cl, Br, I), a hydroxy group, an amino group, a carboxy group, an alkyl group (having one or more carbon atoms, and preferably1 1 to 4 carbon atoms) or an alkoxy group (having one or more carbon atoms, and preferably1 1 to 4 carbon atoms). In addition to the foregoing supersensitizers, there are usable heteroatom-containing macrocyclic compounds described in JP-A No. 2001-330918, as a supersensitizer. The supersensitizer is incorporated into a light-sensitive layer containing organic silver salt and silver halide grains, preferably in an amount of 0.001 to 1.0 mol, and more preferably 0.01 to 0.5 mol per mol of silver.

It is preferred that a sensitizing dye is allowed to adsorb onto the surface of light-sensitive silver halide grains to achieve spectral sensitization and the spectral sensitization effect substantially disappears after being subjected to thermal development. The effect of spectral sensitization substantially disappearing means that the sensitivity of the photothermographic material, obtained by a sensitizing dye or a supersensitizer is reduced, after thermal development, to not more than 1.1 times that of the case not having been subjected to spectral sensitization. To allow the effect of spectral sensitization to disappear, it is preferred to use a spectral sensitizing dye easily releasable from silver halide grains and/or to allow an oxidizing agent such as a halogen radical-releasing compound which is capable of decomposing a spectral sensitizing dye through an oxidation reaction to be contained in an optimum amount in the light-sensitive layer and/or the light-insensitive layer. The content of an oxidizing agent is adjusted in light of oxidizing strength of the oxidizing agent and its spectral sensitization effects.

Binder

Suitable binders for the silver salt photothermographic material are to be transparent or translucent and commonly colorless, and include natural polymers, synthetic resin polymers and copolymers, as well as media to form film. The binders include, for example, gelatin, gum Arabic, casein, starch, poly(acrylic acid), poly(methacrylic acid), poly(vinyl chloride), poly(methacrylic acid), copoly(styrene-maleic anhydride), coply(styrene-acrylonitrile), coply(styrene-butadiene), poly(vinyl acetals) (for example, poly(vinyl formal) and poly(vinyl butyral), poly(esters), poly(urethanes), phenoxy resins, poly(vinylidene chloride), poly(epoxides), poly(carbonates), poly(vinyl acetate), cellulose esters, poly(amides). The binders may be hydrophilic ones or hydrophobic ones.

Preferable binders for the photosensitive layer of the photothermographic material of this invention are poly(vinyl acetals), and a particularly preferable binder is poly(vinyl butyral), which will be detailed hereunder. Polymers such as cellulose esters, especially polymers such as triacetyl cellulose, cellulose acetate butyrate, which exhibit higher softening temperature, are preferable for an over-coating layer as well as an undercoating layer, specifically for a light-insensitive layer such as a protective layer and a backing layer. Incidentally, if desired, the binders may be employed in combination of at least two types.

Such binders are employed in the range of a proportion in which the binders function effectively. Skilled persons in the art can easily determine the effective range. For example, preferred as the index for maintaining aliphatic carboxylic acid silver salts in a photosensitive layer is the proportion range of binders to aliphatic carboxylic acid silver salts of 15:1 to 1:2 and most preferably of 8:1 to 1:1. Namely, the binder amount in the photosensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In this invention, it is preferable that thermal transition point temperature, after development is at higher or equal to 100° C., is from 46 to 200° C. and is more preferably from 70 to 105° C. Thermal transition point temperature, as described in this invention, refers to the VICAT softening point or the value shown by the ring and ball method, and also refers to the endothermic peak which is obtained by measuring the individually peeled photosensitive layer which has been thermally developed, employing a differential scanning calorimeter (DSC), such as EXSTAR 6000 (manufactured by Seiko Denshi Co.), DSC220C (manufactured by Seiko Denshi Kogyo Co.), and DSC-7 (manufactured by Perkin-Elmer Co.). Commonly, polymers exhibit a glass transition point, Tg. In silver salt photothermographic dry imaging materials, a large endothermic peak appears at a temperature lower than the Tg value of the binder resin employed in the photosensitive layer. The inventors of this invention conducted diligent investigations while paying special attention to the thermal transition point temperature. As a result, it was discovered that by regulating the thermal transition point temperature to the range of 46 to 200° C., durability of the resultant coating layer increased and in addition, photographic characteristics such as speed, maximum density and image retention properties were markedly improved. Based on the discovery, this invention was achieved.

The glass transition temperature (Tg) is determined employing the method, described in Brandlap, et al., “Polymer Handbook”, pages from III-139 through III-179, 1966 (published by Wiley and Son Co.). The Tg of the binder composed of copolymer resins is obtained based on the following formula.
Tg of the copolymer (in ° C.)=v₁Tg₁+v₂Tg₂+ . . . +vₙTgₙ
wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer. The accuracy of Tg, calculated based on the formula calculation, is ±5° C.

In the photothermographic material of this invention, employed as binders, which are incorporated into the photosensitive layer, on the support, comprising aliphatic carboxylic acid silver salts, photosensitive silver halide grains and reducing agents, may be conventional polymers known in the art. The polymers have a Tg of 70 to 105° C., a number average molecular weight of 1,000 to 1,000,000, preferably from 10,000 to 500,000, and a degree of polymerization of about 50 to about 1,000. Examples of such polymers include polymers or copolymers comprised of constituent units of ethylenic unsaturated monomers such as vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, and vinyl acetal, as well as vinyl ether, and polyurethane resins and various types of rubber based resins.

Further listed are phenol resins, epoxy resins, polyurethane hardening type resins, urea resins, melamine resins, alkyd resins, formaldehyde resins, silicone resins, epoxy-polyamide resins, and polyester resins. Such resins are detailed in “Plastics Handbook”, published by Asakura Shoten. These polymers are not particularly limited, and may be either homopolymers or copolymers as long as the resultant glass transition temperature, Tg is in the range of 70 to 105° C.

Ethylenically unsaturated monomers as constitution units forming homopolymers or copolymers include alkyl acrylates, aryl acrylates, alkyl methacrylates, aryl methacrylates, alkyl cyano acrylate, and aryl cyano acrylates, in which the alkyl group or aryl group may not be substituted. Specific alkyl groups and aryl groups include a methyl group, an ethyl group, an n-propyl group, an isopropyl group, an n-butyl group, an isobutyl group, a sec-butyl group, a tert-butyl group, an amyl group, a hexyl group, a cyclohexyl group, a benzyl group, a chlorophenyl group, an octyl group, a stearyl group, a sulfopropyl group, an N-ethyl-phenylaminoethyl group, a 2-(3-phenylpropyloxy)ethyl group, a dimethylaminophenoxyethyl group, a furfuryl group, a tetrahydrofurfuryl group, a phenyl group, a cresyl group, a naphthyl group, a 2-hydroxyethyl group, a 4-hydroxybutyl group, a triethylene glycol group, a dipropylene glycol group, a 2-methoxyethyl group, a 3-methoxybutyl group, a 2-actoxyethyl group, a 2-acetacttoxyethyl group, a 2-methoxyethyl group, a 2-iso-proxyethyl group, a 2-butoxyethyl group, a 2-(2-methoxyethoxy)ethyl group, a 2-(2-ethoxyetjoxy)ethyl group, a 2-(2-bitoxyethoxy)ethyl group, a 2-diphenylphsophorylethyl group, an ω-methoxypolyethylene glycol (the number of addition mol n=6), an ally group, and dimethylaminoethylmethyl chloride.

In addition, there may be employed the monomers described below. Vinyl esters: specific examples include vinyl acetate, vinyl propionate, vinyl butyrate, vinyl isobutyrate, vinyl corporate, vinyl chloroacetate, vinyl methoxyacetate, vinyl phenyl acetate, vinyl benzoate, and vinyl salicylate; N-substituted acrylamides, N-substituted methacrylamides and acrylamide and methacrylamide: N-substituents include a methyl group, an ethyl group, a propyl group, a butyl group, a tert-butyl group, a cyclohexyl group, a benzyl group, a hydroxymethyl group, a methoxyethyl group, a dimethylaminoethyl group, a phenyl group, a dimethyl group, a diethyl group, a β-cyanoethyl group, an N-(2-acetacetoxyethyl) group, a diacetone group; olefins: for example, dicyclopentadiene, ethylene, propylene, 1-butene, 1-pentane, vinyl chloride, vinylidene chloride, isoprene, chloroprene, butadiene, and 2,3-dimethylbutadiene; styrenes; for example, methylstyrene, dimethylstyrene, trimethylstyrene, ethylstyrene, isopropylstyrene, tert-butylstyrene, chloromethylstryene, methoxystyrene, acetoxystyrene, chlorostyrene, dichlorostyrene, bromostyrene, and vinyl methyl benzoate; vinyl ethers: for example, methyl vinyl ether, butyl vinyl ether, hexyl vinyl ether, methoxyethyl vinyl ether, and dimethylaminoethyl vinyl ether; N-substituted maleimides: N-substituents include a methyl group, an ethyl group, a propyl group, a butyl group, a tert-butyl group, a cyclohexyl group, a benzyl group, an n-dodecyl group, a phenyl group, a 2-methylphenyl group, a 2,6-diethylphenyl group, and a 2-chlorophenyl group; others include butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, glycidyl acrylate, glycidyl methacrylate, N-vinyl oxazolidone, N-vinyl pyrrolidone, acrylonitrile, metaacrylonitrile, methylene malonnitrile, vinylidene chloride.

Of these, preferable examples include alkyl methacrylates, aryl methacrylates, and styrenes. Of such polymers, those having an acetal group are preferably employed because they exhibit excellent compatibility with the resultant aliphatic carboxylic acid, whereby an increase in flexibility of the resultant layer is effectively minimized.

Particularly preferred as polymers having an acetal group are the compounds represented by formula (V) described below: 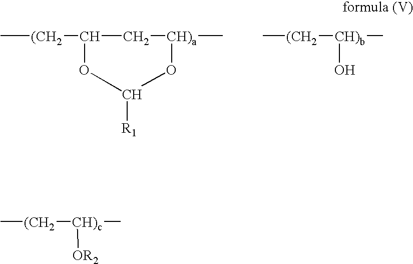
wherein R₁ represents a substituted or unsubstituted alkyl group, and a substituted or unsubstituted aryl group, however, groups other than the aryl group are preferred; R₂ represents a substituted or unsubstituted alkyl group, a substituted or unsubstituted aryl group, —COR₃ or —CONHR₃, wherein R₃ represents the same as defined above for R₁.

Unsubstituted alkyl groups represented by R₁, R₂, and R₃ preferably have 1 to 20 carbon atoms and more preferably have 1 to 6 carbon atoms. The alkyl groups may have a straight or branched chain, but preferably have a straight chain. Listed as such unsubstituted alkyl groups are, for example, a methyl group, an ethyl group, an n-propyl group, an isopropyl group, an n-butyl group, an isobutyl group, a t-butyl group, an n-amyl group, a t-amyl group, an n-hexyl group, a cyclohexyl group, an n-heptyl group, an n-octyl group, a t-octyl group, a 2-ethylhexyl group, an n-nonyl group, an n-decyl group, an n-dodecyl group, and an n-octadecyl group. Of these, particularly preferred is a methyl group or a propyl group.

Unsubstituted aryl groups preferably have from 6 to 20 carbon atoms and include, for example, a phenyl group and a naphthyl group. Listed as groups which can be substituted for the alkyl groups as well as the aryl groups are an alkyl group (for example, a methyl group, an n-propyl group, a t-amyl group, a t-octyl group, an n-nonyl group, and a dodecyl group), an aryl group (for example, a phenyl group), a nitro group, a hydroxyl group, a cyano group, a sulfo group, an alkoxy group (for example, a methoxy group), an aryloxy group (for example, a phenoxy group), an acyloxy group (for example, an acetoxy group), an acylamino group (for example, an acetylamino group), a sulfonamido group (for example, methanesulfonamido group), a sulfamoyl group (for example, a methylsulfamoyl group), a halogen atom (for example, a fluorine atom, a chlorine atom, and a bromine atom), a carboxyl group, a carbamoyl group (for example, a methylcarbamoyl group), an alkoxycarbonyl group (for example, a methoxycarbonyl group), and a sulfonyl group (for example, a methylsulfonyl group). When at least two of the substituents are employed, they may be the same or different. The number of total carbons of the substituted alkyl group is preferably from 1 to 20, while the number of total carbons of the substituted aryl group is preferably from 6 to 20.

R₂ is preferably —COR₃ (wherein R₃ represents an alkyl group or an aryl group) and —CONHR₅₃ (wherein R₃ represents an aryl group). “a”, “b”, and “c” each represents the value in which the weight of repeated units is shown utilizing mol percent; “a” is in the range of 40 to 86 mol percent; “b” is in the range of from 0 to 30 mol percent; “c” is in the range of 0 to 60 mol percent, so that a+b+c=100 is satisfied. Most preferably, “a” is in the range of 50 to 86 mol percent, “b” is in the range of 5 to 25 mol percent, and “c” is in the range of 0 to 40 mol percent. The repeated units having each composition ratio of “a”, “b”, and “c” may be the same or different.

Employed as polyurethane resins usable in this invention may be those, known in the art, having a structure of polyester polyurethane, polyether polyurethane, polyether polyester polyurethane, polycarbonate polyurethane, polyester polycarbonate polyurethane, or polycaprolactone polyurethane. It is preferable that, if desired, all polyurethanes described herein are substituted, through copolymerization or addition reaction, with at least one polar group selected from the group consisting of —COOM, —SO₃M, —OSO₃M, —P═O(OM)₂, —O—P═O(OM)₂ (wherein M represents a hydrogen atom or an alkali metal salt group), —N(R₄)₂, —N⁺(R₄)₃ (wherein R₅₄ represents a hydrocarbon group, and a plurality of R₅₄ may be the same or different), an epoxy group, —SH, and —CN. The amount of such polar groups is commonly from 10⁻¹ to 10⁻⁸ mol/g, and is preferably from 10⁻² to 10⁻⁶ mol/g. Other than the polar groups, it is preferable that the molecular terminal of the polyurethane molecule has at least one OH group and at least two OH groups in total. The OH group cross-links with polyisocyanate as a hardening agent so as to form a 3-dimensinal net structure. Therefore, the more OH groups which are incorporated in the molecule, the more preferred. It is particularly preferable that the OH group is positioned at the terminal of the molecule since thereby the reactivity with the hardening agent is enhanced. The polyurethane preferably has at least three OH groups at the terminal of the molecules, and more preferably has at least four OH groups. When polyurethane is employed, the polyurethane preferably has a glass transition temperature of 70 to 105° C., a breakage elongation of 100 to 2,000 percent, and a breakage stress of 0.5 to 100 M/mm².

Polymers represented by aforesaid Formula (V) of this invention can be synthesized employing common synthetic methods described in “Sakusan Binihru Jushi (Vinyl Acetate Resins)”, edited by Ichiro Sakurada (Kohbunshi Kagaku Kankoh Kai, 1962).

Examples of representative synthetic methods will now be described. However, the present invention is not limited to these representative synthetic examples.

### SYNTHESIS EXAMPLE 1

### Synthesis of P-1

Charged into a reaction vessel were 20 g of polyvinyl alcohol (Gosenol GH18) manufactured by Nihon Gosei Co., Ltd. and 180 g of pure water, and the resulting mixture was dispersed in pure water so that 10 percent by weight polyvinyl alcohol dispersion was obtained. Subsequently, the resultant dispersion was heated to 95° C. and polyvinyl alcohol was dissolved. Thereafter, the resultant solution was cooled to 75° C., whereby an aqueous polyvinyl alcohol solution was prepared. Subsequently, 1.6 g of 10 percent by weight hydrochloric acid, as an acid catalyst, was added to the solution. The resultant solution was designated as Dripping Solution A. Subsequently, 11.5 g of a mixture consisting of butylaldehyde and acetaldehyde in a mol ratio of 4:5 was prepared and was designated as Dripping Solution B. Added to a 1,000 ml four-necked flask fitted with a cooling pipe and a stirring device was 100 ml of pure water which was heated to 85° C. and stirred well. Subsequently, while stirring, Dripping Solution A and Dripping Solution B were simultaneously added dropwise into the pure water over 2 hours, employing a dripping funnel. During the addition, the reaction was conducted while minimizing coalescence of deposit particles by controlling the stirring rate. After the dropwise addition, 7 g of 10 weight percent hydrochloric acid, as an acid catalyst, was further added, and the resultant mixture was stirred for 2 hours at 85° C., whereby the reaction had sufficiently progressed. Thereafter, the reaction mixture was cooled to 40° C. and was neutralized employing sodium bicarbonate. The resultant product was washed with water 5 times, and the resultant polymer was collected through filtration and dried, whereby P-1 was prepared. The Tg of obtained P-1 was determined employing a DSC, resulting in 83° C.

Other polymers described in Table 1 were synthesized in the same manner as above.

These polymers may be employed individually or in combinations of at least two types as a binder. The polymers are employed as a main binder in the photosensitive silver salt containing layer (preferably in a photosensitive layer) of the present invention. The main binder, as described herein, refers to the binder in “the state in which the proportion of the aforesaid binder is at least 50 percent by weight of the total binders of the photosensitive silver salt containing layer”. Accordingly, other binders may be employed in the range of less than 50 weight percent of the total binders. The other polymers are not particularly limited as long as they are soluble in the solvents capable of dissolving the polymers of the present invention. More preferably listed as the polymers are poly(vinyl acetate), acrylic resins, and urethane resins.

Compositions of polymers, which are preferably employed in the present invention, are shown in Table 1. Incidentally, Tg in Table 1 is a value determined employing a differential scanning calorimeter (DSC), manufactured by Seiko Denshi Kogyo Co., Ltd.

TABLE 1

| | | | | | Hydroxyl | Tg |
|---|---|---|---|---|---|---|
| | Acetoacetal | Butyral | Acetal | Acetyl | Group | Value |
| Polymer | (mol %) | (mol %) | (mol %) | (mol %) | (mol %) | (° C.) |
| P-1 | 6 | 4 | 73.7 | 1.7 | 24.6 | 85 |
| P-2 | 3 | 7 | 75.0 | 1.6 | 23.4 | 75 |
| P-3 | 10 | 0 | 73.6 | 1.9 | 24.5 | 110 |
| P-4 | 7 | 3 | 71.1 | 1.6 | 27.3 | 88 |
| P-5 | 10 | 0 | 73.3 | 1.9 | 24.8 | 104 |
| P-6 | 10 | 0 | 73.5 | 1.9 | 24.6 | 104 |
| P-7 | 3 | 7 | 74.4 | 1.6 | 24.0 | 75 |
| P-8 | 3 | 7 | 75.4 | 1.6 | 23.0 | 74 |
| P-9 | — | — | — | — | — | 60 |

Incidentally, in Table 1, P-9 is a polyvinyl butyral resin B-79, manufactured by Solutia Co.

In the present invention, it is known that by employing cross-linking agents in the aforesaid binders, uneven development is minimized due to the improved adhesion of the layer to the support. In addition, it results in such effects that fogging during storage is minimized and the creation of printout silver after development is also minimized.

Employed as cross-linking agents used in the present invention may be various conventional cross-linking agents, which have been employed for silver halide photosensitive photographic materials, such as aldehyde based, epoxy based, ethyleneimine based, vinylsulfone based sulfonic acid ester based, acryloyl based, carbodiimide based, and silane compound based cross-linking agents, which are described in Japanese Patent Application Open to Public Inspection No. 50-96216. Of these, preferred are isocyanate based compounds, silane compounds, epoxy compounds or acid anhydrides, as shown below.

As one of preferred cross-linking agents, isocyanate based and thioisocyanate based cross-linking agents represented by formula (IC), shown below, will now be described:
X═C═N-L-(N═C═X)ᵥ formula (IC)
wherein v represents 1 or 2; L represents an alkyl group, an aryl group, or an alkylaryl group which is a linking group having a valence of v+1; and X represents an oxygen atom or a sulfur atom.

Incidentally, in the compounds represented by aforesaid Formula (IC), the aryl ring of the aryl group may have a substituent. Preferred substituents are selected from the group consisting of a halogen atom (for example, a bromine atom or a chlorine atom), a hydroxyl group, an amino group, a carboxyl group, an alkyl group and an alkoxy group.

The aforesaid isocyanate based cross-linking agents are isocyanates having at least two isocyanate groups and adducts thereof. Specific examples thereof include aliphatic isocyanates, aliphatic isocyanates having a ring group, benzene diisocyanates, naphthalene diisocyanates, biphenyl isocyanates, diphenylmethane diisocyanates, triphenylmethane diisocyanates, triisocyanates, tetraisocyanates, and adducts of these isocyanates and adducts of these isocyanates with dihydric or trihydric polyalcohols. Employed as specific examples may be isocyanate compounds described on pages 10 through 12 of JP-A No. 56-5535.

Incidentally, adducts of isocyanates with polyalcohols are capable of markedly improving the adhesion between layers and further of markedly minimizing layer peeling, image dislocation, and air bubble formation. Such isocyanates may be incorporated in any portion of the silver salt photothermographic material. They may be incorporated in for example, a support (particularly, when the support is paper, they may be incorporated in a sizing composition), and optional layers such as a photosensitive layer, a surface protective layer, an interlayer, an antihalation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have “v” of 0, namely compounds having only one functional group.

Listed as examples of silane compounds which can be employed as a cross-linking agent in the present invention are compounds represented by General Formal (1) or Formula (2), described in JP-A No. 2002-22203.

In these Formulas, R₁, R₂, R₃, R₄, R₅, R₆, R₇, and R₈ each represents a straight or branched chain or cyclic alkyl group having from 1 to 30 carbon atoms, which may be substituted, (such as a methyl group, an ethyl group, a butyl group, an octyl group, a dodecyl group, and a cycloalkyl group), an alkenyl group (such as a propenyl group, a butenyl group, and a nonenyl group), an alkynyl group (such as an acetylene group, a bisacetylene group, and a phenylacetylene group), an aryl group, or a heterocyclic group, (such as a phenyl group, a naphthyl group, a tetrahydropyrane group, a pyridyl group, a furyl group, a thiophenyl group, an imidazole group, a thiazole group, a thiadiazole group, and an oxadiazole group, which may have either an electron attractive group or an electron donating group as a substituent.

At least one of substituents selected from R₁, R₂, R₃, R₄, R₅, R₆, R₇, and R₈ is preferably either a non-diffusive group or an adsorptive group. Specifically, R² is preferably either a non-diffusive group or an adsorptive group.

Incidentally, the non-diffusive group, which is called a ballast group, is preferably an aliphatic group having at least 6 carbon atoms or an aryl group substituted with an alkyl group having at least 3 carbon atoms. Non-diffusive properties vary depending on binders as well as the used amount of cross-linking agents. By introducing the non-diffusive groups, migration distance in the molecule at room temperature is retarded, whereby it is possible to retard reactions during storage.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Preferred as epoxy compounds are those represented by the following formula (EP).

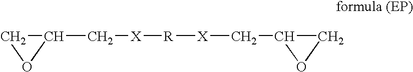

In the formula (EP), the substituent of the alkylene group represented by R is preferably a group selected from a halogen atom, a hydroxyl group, a hydroxyalkyl group, or an amino group. Further, the linking group represented by R preferably has an amide linking portion, an ether linking portion, or a thioether linking portion. The divalent linking group, represented by X, is preferably —SO₂—, —SO₂NH—, —S—, —O—, or —NR₁—, wherein R₁ represents a univalent group, which is preferably an electron attractive group.

These epoxy compounds may be employed individually or in combinations of at least two types. The added amount is not particularly limited but is preferably in the range of 1×10⁻⁶ to 1×10⁻² mol/m², and is more preferably in the range of 1×10⁻⁵ to 1×10⁻³ mol/m².

The epoxy compounds may be incorporated in optional layers on the photosensitive layer side of a support, such as a photosensitive layer, a surface protective layer, an interlayer, an antihalation layer, and a subbing layer, and may be incorporated in at least two layers. In addition, the epoxy compounds may be incorporated in optional layers on the side opposite the photosensitive layer on the support. Incidentally, when a photosensitive material has a photosensitive layer on both sides, the epoxy compounds may be incorporated in any layer.

Acid anhydrides are compounds which have at least one acid anhydride group having the structural formula described below.
—CO—O—CO—

The acid anhydrites are to have at least one such acid anhydride group. The number of acid anhydride groups, and the molecular weight are not limited, but the compounds represented by the following formula (SA) are preferred:

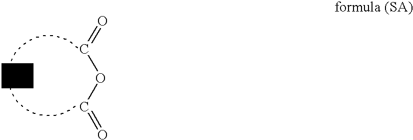

In the foregoing formula (SA), Z represents a group of atoms necessary for forming a single ring or a polycyclic system. These cyclic systems may be unsubstituted or substituted. Example of substituents include an alkyl group (for example, a methyl group, an ethyl group, or a hexyl group), an alkoxy group (for example, a methoxy group, an ethoxy group, or an octyloxy group), an aryl group (for example, a phenyl group, a naphthyl group, or a tolyl group), a hydroxyl group, an aryloxy group (for example, a phenoxy group), an alkylthio group (for example, a methylthio group or a butylthio group), an arylthio group (for example, a phenylthio group), an acyl group (for example, an acetyl group, a propionyl group, or a butyryl group), a sulfonyl group (for example, a methylsulfonyl group, or a phenylsulfonyl group), an acylamino group, a sulfonylamino group, an acyloxy group (for example, an acetoxy group or a benzoxy group), a carboxyl group, a cyano group, a sulfo group, and an amino group. Substituents are preferably those which do not contain a halogen atom.

These acid anhydrides may be employed individually or in combinations of at least two types. The added amount is not particularly limited, but is preferably in the range of 1×10⁶ to 1×10⁻² mol/m² and is more preferably in the range of 1×10⁻⁶ to 1×10⁻³ mol/m².

In the present invention, the acid anhydrides may be incorporated in optional layers on the photosensitive layer side on a support, such as a photosensitive layer, a surface protective layer, an interlayer, an antihalation layer, or a subbing layer, and may be incorporated in at least two layers. Further, the acid anhydrides may be incorporated in the layer(s) in which the epoxy compounds are incorporated.

Image Tone Adjustment

The image tone (or image color) obtained by thermal development of the imaging material is described. It has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown. The tone is more described below based on an expression defined by a method recommended by the Commission Internationale de l'Eclairage (CIE) in order to define more quantitatively.

“Colder tone” as well as “warmer tone”, which is terminology of image tone, is expressed, employing minimum density Dₘᵢₙ and hue angle h_{ab} at an optical density D of 1.0. The hue angle h_{ab} is obtained by the following formula, utilizing color specifications a* and b* of L*a*b*. Color Space which is a color space perceptively having approximately a uniform rate, recommended by Commission Internationale de l'Eclairage (CIE) in 1976.
h_{ab}=tan⁻¹(b*/a*)

In this invention, h_{ab} is preferably in the range of 180 degrees<h_{ab}<270 degrees, is more preferably in the range of 200 degrees<h_{ab}<270 degrees, and is most preferably in the range of 220 degrees<h_{ab}<260 degrees.

This finding is also disclosed in JP-A 2002-6463.

Incidentally, as described, for example, in JP-A No. 2000-29164, it is conventionally known that diagnostic images with visually preferred color tone are obtained by adjusting, to the specified values, u* and v* or a* and b* in CIE 1976 (L*u*v*) color space or (L*a*b*) color space near an optical density of 1.0.

Extensive investigation was performed for the silver salt photothermographic material according to the present invention. As a result, it was discovered that when a linear regression line was formed on a graph in which in the CIE 1976 (L*u*v*) color space or the (L*a*b*) color space, u* or a* was used as the abscissa and v* or b* was used as the ordinate, the aforesaid materiel exhibited diagnostic properties which were equal to or better than conventional wet type silver salt photosensitive materials by regulating the resulting linear regression line to the specified range. The condition ranges of the present invention will now be described.

(1) It is preferable that the coefficient of determination value R² of the linear regression line, which is made by arranging u* and v* in terms of each of the optical densities of 0.5, 1.0, and 1.5 and the minimum optical density, is also from 0.998 to 1.000.

The value b* of the intersection point of the aforesaid linear regression line with the ordinate is −5-+5; and gradient (b*/a*) is 0.7 to 2.5.

The coefficient of determination value R² of the linear regression line is preferably 0.998 to 1.000, which is formed by arrangement of a* and b* in terms of each of the above optical densities; value v* of the intersection point of the aforesaid linear regression line with the ordinate is +preferably from −5 to +5, while gradient (v*/u*) is preferably from 0.7 to 2.5.

A method for making the above-mentioned linear regression line, namely one example of a method for determining u* and v* as well as a* and b* in the CIE 1976 color space, will now be described.

By employing a thermal development apparatus, a 4-step wedge sample including an unexposed portion and optical densities of 0.5, 1.0, and 1.5 is prepared. Each of the wedge density portions prepared as above is determined employing a spectral chronometer (for example, CM-3600d, manufactured by Minolta Co., Ltd.) and either u* and v* or a* and b* are calculated. Measurement conditions are such that an F7 light source is used as a light source, the visual field angle is 10 degrees, and the transmission measurement mode is used. Subsequently, either measured u* and v* or measured a* and b* are plotted on the graph in which u* or a* is used as the abscissa, while v* or b* is used as the ordinate, and a linear regression line is formed, whereby the coefficient of determination value R² as well as intersection points and gradients are determined.

The specific method enabling to obtain a linear regression line having the above-described characteristics will be described below. In this invention, by regulating the added amount of the aforesaid toning agents, developing agents, silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver.

Usually, image toning agents such as phthalazinones or a combinations of phthalazine with phthalic acids, or phthalic anhydride are employed. Examples of suitable image toning agents are disclosed in Research Disclosure, Item 17029, and U.S. Pat. Nos. 4,123,282, 3,994,732, 3,846,136, and 4,021,249.

Other than such image toning agents, it is preferable to control color tone employing couplers disclosed in JP-A No. 11-288057 and EP 1134611A2 as well as leuco dyes detailed below. Further, it is possible to unexpectedly minimize variation of tone during storage of silver images by simultaneously employing silver halide grains which are converted into an internal latent image-forming type after the thermal development according to the present invention.

Leuco Dye

Leuco dyes are employed in the silver salt photothermographic materials relating to this invention. There may be employed, as leuco dyes, any of the colorless or slightly tinted compounds which are oxidized to form a colored state when heated at temperatures of about 80 to about 200° C. for about 0.5 to about 30 seconds. It is possible to use any of the leuco dyes which are oxidized by silver ions to form dyes. Compounds are useful which are sensitive to pH and oxidizable to a colored state.

Representative leuco dyes suitable for the use in the present invention are not particularly limited. Examples include bisphenol leuco dyes, phenol leuco dyes, indoaniline leuco dyes, acrylated azine leuco dyes, phenoxazine leuco dyes, phenodiazine leuco dyes, and phenothiazine leuco dyes. Further, other useful leuco dyes are those disclosed in U.S. Pat. Nos. 3,445,234, 3,846,136, 3,994,732, 4,021,249, 4,021,250, 4,022,617, 4,123,282, 4,368,247, and 4,461,681, as well as JP-A Nos. 50-36110, 59-206831, 5-204087, 11-231460, 2002-169249, and 2002-236334.

In order to control images to specified color tones, it is preferable that various color leuco dyes are employed individually or in combinations of a plurality of types. In the present invention, for minimizing excessive yellowish color tone due to the use of highly active reducing agents, as well as excessive reddish images especially at a density of at least 2.0 due to the use of minute silver halide grains, it is preferable to employ leuco dyes which change to cyan. Further, in order to achieve precise adjustment of color tone, it is further preferable to simultaneously use yellow leuco dyes and other leuco dyes which change to cyan.

It is preferable to appropriately control the density of the resulting color while taking into account the relationship with the color tone of developed silver itself. In the present invention, color formation is performed so that the sum of maximum densities at the maximum adsorption wavelengths of dye images formed by leuco dyes is customarily 0.01 to 0.30, is preferably 0.02 to 0.20, and is most preferably 0.02 to 0.10. Further, it is preferable that images be controlled within the preferred color tone range described below.

Yellow Dye-Forming Leuco Dye

In this invention, particularly preferably employed as yellow forming leuco dyes are color image forming agents represented by the following formula (YL) which increase absorbance between 360 and 450 nm via oxidation:

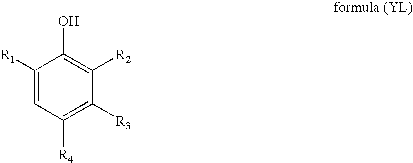

The compounds represented by Formula (YL) will now be detailed. In the foregoing formula (YL), the alkyl groups represented by R₁ are preferably those having 1-30 carbon atoms, which may have a substituent. Specifically preferred is methyl, ethyl, butyl, octyl, i-propyl, t-butyl, t-octyl, t-pentyl, sec-butyl, cyclohexyl, or 1-methyl-cyclohexyl. Groups (i-propyl, i-nonyl, t-butyl, t-amyl, t-octyl, cyclohexyl, 1-methyl-cyclohexyl or adamantyl) which are three-dimensionally larger than i-propyl are preferred. Of these, preferred are secondary or tertiary alkyl groups and t-butyl, t-octyl, and t-pentyl, which are tertiary alkyl groups, are particularly preferred. Examples of substituents which R₁ may have include a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group.

R₂ represents a hydrogen atom, a substituted or unsubstituted alkyl group, or an acylamino group. The alkyl group represented by R₂ is preferably one having 1 to 30 carbon atoms, while the acylamino group is preferably one having 1 to 30 carbon atoms. Of these, description for the alkyl group is the same as for aforesaid R₁.

The acylamino group represented by R₂ may be unsubstituted or have a substituent. Specific examples thereof include an acetylamino group, an alkoxyacetylamino group, and an aryloxyacetylamino group. R₂ is preferably a hydrogen atom or an unsubstituted group having 1 to 24 carbon atoms, and specifically listed are methyl, i-propyl, and t-butyl. Further, neither R₁ nor R₂ is a 2-hydroxyphenylmethyl group.

R₃ represents a hydrogen atom, and a substituted or unsubstituted alkyl group. Preferred as alkyl groups are those having 1 to 30 carbon atoms. Description for the above alkyl groups is the same as for R₁. Preferred as R₃ are a hydrogen atom and an unsubstituted alkyl group having 1 to 24 carbon atoms, and specifically listed are methyl, i-propyl and t-butyl. It is preferable that either R₁₂ or R₁₃ represents a hydrogen atom.

R₄ represents a group capable of being substituted to a benzene ring, and represents the same group which is described for substituent R₄, for example, in aforesaid Formula (RED). R₄ is preferably a substituted or unsubstituted alkyl group having 1 to 30 carbon atoms, as well as an oxycarbonyl group having 2 to 30 carbon atoms. The alkyl group having 1 to 24 carbon atoms is more preferred. Listed as substituents of the alkyl group are an aryl group, an amino group, an alkoxy group, an oxycarbonyl group, an acylamino group, an acyloxy group, an imido group, and a ureido group. Of these, more preferred are an aryl group, an amino group, an oxycarbonyl group, and an alkoxy group. The substituent of the alkyl group may be substituted with any of the above alkyl groups.

Among the compounds represented by the foregoing formula (YL), preferred compounds are bis-phenol compounds represented by the following formula: 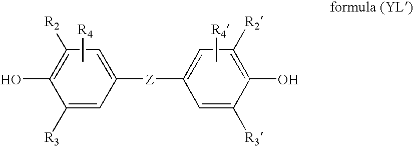
wherein, Z represents a —S— or —C(R₁) (R_{1′})— group. R₁ and R_{1′} each represent a hydrogen atom or a substituent. The substituents represented by R₁ and R_{1′} are the same substituents listed for R₁ in the aforementioned Formula (RED). R₁ and R_{1′} are preferably a hydrogen atom or an alkyl group.

R₂, R₃, R₂′ and R₃′ each represent a substituent. The substituents represented by R₂, R₃, R₂′ and R₃′ are the same substituents listed for R₂ and R₃ in the aforementioned Formula (RED). R₂, R₃, R₂′ and R₃′ are preferably, an alkyl group, an alkenyl group, an alkynyl group, an aryl group, a heterocyclic group, and more preferably, an alkyl group. Substituents on the alkyl group are the same substituents listed for the substituents in the aforementioned Formula (RED). R₂, R₃, R₂′ and R₃′ are more preferably tertiary alkyl groups such as t-butyl, t-amino, t-octyl and 1-methylcyclohexyl.

R₄ and R_{4′} each represent a hydrogen atom or a substituent, and the substituents are the same substituents listed for R₄ in the aforementioned formula (RED).

Examples of the bis-phenol compounds represented by the formula (YL′) are, the compounds disclosed in JP-A No. 2002-169249, Compounds (II-1) to (II-40), paragraph Nos. [0032]-[0038]; and EP 1211093, Compounds (ITS-1) to (ITS-12), paragraph No. [0026].

Specific examples of bisphenol compounds represented by Formula (YL′) are shown below.

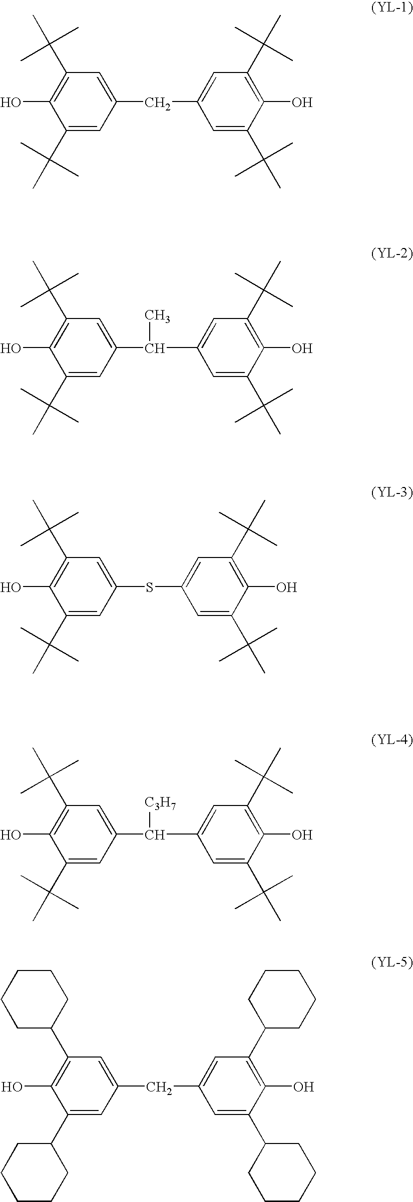

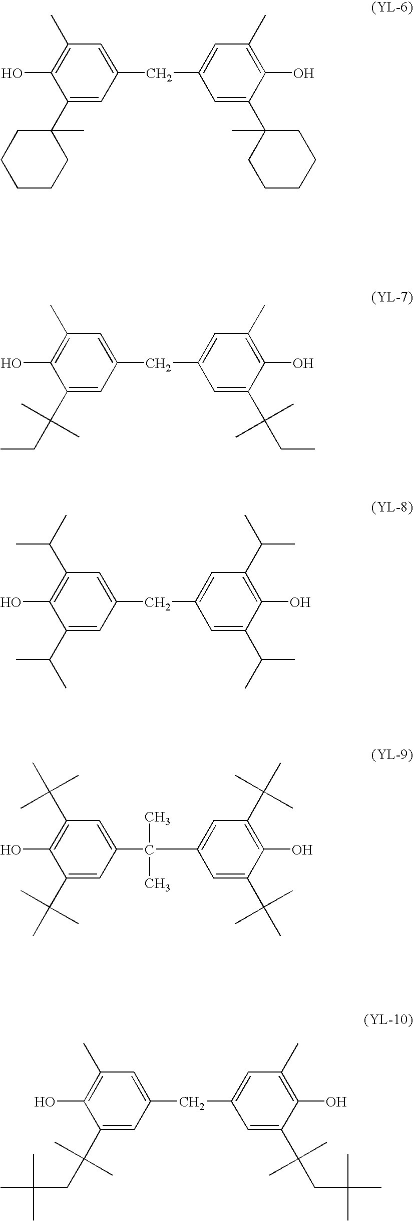

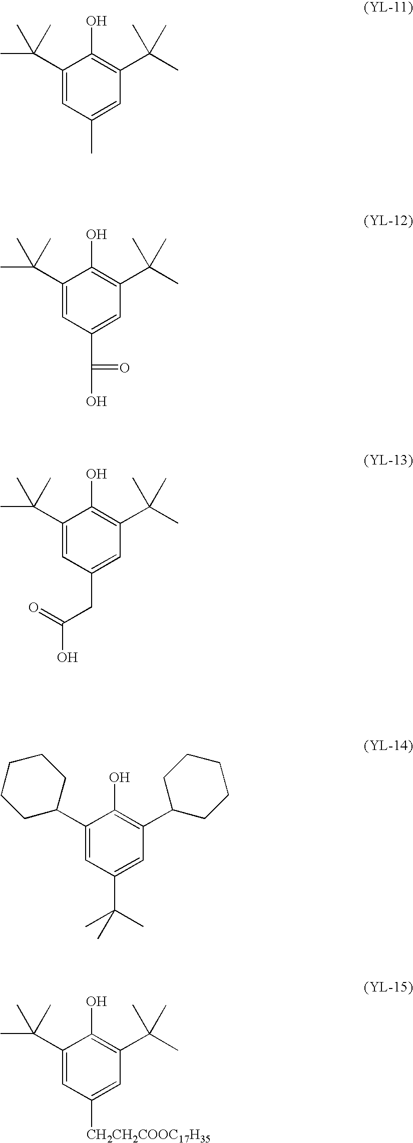

An amount of an incorporated compound represented by formula (YL) is; usually, 0.00001 to 0.01 mol, and preferably, 0.0005 to 0.01 mol, and more preferably, 0.001 to 0.008 mol per mol of Ag.

Cyan forming leuco dyes will now be described. In the present invention, particularly preferably employed as cyan forming leuco dyes are color image forming agents which increase absorbance between 600 and 700 nm via oxidation, and include the compounds described in JP-A No. 59-206831 (particularly, compounds of λmax in the range of 600-700 nm), compounds represented by formulas (I) through (IV) of JP-A No. 5-204087 (specifically, compounds (1) through (18) described in paragraphs [0032] through [0037]), and compounds represented by formulas 4-7 (specifically, compound Nos. 1 through 79 described in paragraph [0105]) of JP-A No. 11-231460.

Cyan forming leuco dyes which are particularly preferably employed in the present invention are represented by the following formula (CL): 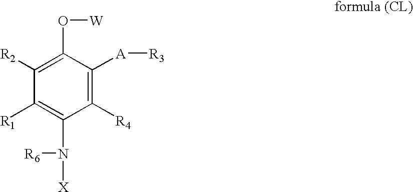
wherein R₁ and R₂ each represent a hydrogen atom, a substituted or unsubstituted alkyl group, an NHCO—R₁₀ group wherein R₁₀ is an alkyl group, an aryl group, or a heterocyclic group, while R₁ and R₂ may bond to each other to form an aliphatic hydrocarbon ring, an aromatic hydrocarbon ring, or a heterocyclic ring; A represents-NHCO—, —CONH—, or —NHCONH—; R₃ represents a substituted or unsubstituted alkyl group, an aryl group, or a heterocyclic group, or -A-R₃ is a hydrogen atom; W represents a hydrogen atom or a —CONHR₅— group, —COR₅ or a —CO—O—R₅ group wherein R₅ represents a substituted or unsubstituted alkyl group, an aryl group, or a heterocyclic group; R₄ represents a hydrogen atom, a halogen atom, a substituted or unsubstituted alkyl group, an alkoxy group, a carbamoyl group, or a nitrile group; R₆ represents a —CONH—R₇ group, a —CO—R₇ group, or a —CO—O—R₇ group wherein R₇ is a substituted or unsubstituted alkyl group, an aryl group, or a heterocyclic group; and X represents a substituted or unsubstituted aryl group or a heterocyclic group.

In the foregoing formula (CL), halogen atoms include fluorine, bromine, and chlorine; alkyl groups include those having at most 20 carbon atoms (methyl, ethyl, butyl, or dodecyl); alkenyl groups include those having at most 20 carbon atoms (vinyl, allyl, butenyl, hexenyl, hexadienyl, ethenyl-2-propenyl, 3-butenyl, 1-methyl-3-propenyl, 3-pentenyl, or 1-methyl-3-butenyl); alkoxy groups include those having at most 20 carbon atoms (methoxy or ethoxy); aryl groups include those having 6-20 carbon atoms such as a phenyl group, a naphthyl group, or a thienyl group; heterocyclic groups include each of thiophene, furan, imidazole, pyrazole, and pyrrole groups. A represents —NHCO—, —CONH—, or —NHCONH—; R₃ represents a substituted or unsubstituted alkyl group (preferably having at most 20 carbon atoms such as methyl, ethyl, butyl, or dodecyl), an aryl group (preferably having 6-20 carbon atoms, such as phenyl, naphthyl, or thienyl), or a heterocyclic group (thiophene, furan, imidazole, pyrazole, or pyrrole); -A-R₃ is a hydrogen atom; W represents a hydrogen atom or a —CONHR₅ group, a —CO—R₅ group or a —CO—OR₅ group wherein R₅ represents a substituted or unsubstituted alkyl group (preferably having at most 20 carbon atoms, such as methyl, ethyl, butyl, or dodecyl), an aryl group (preferably having 6-20 carbon atoms, such as phenyl, naphthyl, or thienyl), or a heterocyclic group (such as thiophene, furan, imidazole, pyrazole, or pyrrole); R₄ is preferably a hydrogen atom, a halogen atom (e.g., fluorine, chlorine, bromine, iodine), a chain or cyclic alkyl group (e.g., a methyl group, a butyl group, a dodecyl group, or a cyclohexyl group), an alkoxy group (e.g., a methoxy group, a butoxy group, or a tetradecyloxy group), a carbamoyl group (e.g., a diethylcarbamoyl group or a phenylcarbamoyl group), and a nitrile group and of these, a hydrogen atom and an alkyl group are more preferred. Aforesaid R₁ and R₂, and R₃ and R₄ bond to each other to form a ring structure. The aforesaid groups may have a single substituent or a plurality of substituents. For example, typical substituents which may be introduced into aryl groups include a halogen atom (e.g., fluorine, chlorine, or bromine), an alkyl group (e.g., methyl, ethyl, propyl, butyl, or dodecyl), a hydroxyl group, a cyan group, a nitro group, an alkoxy group (methoxy or ethoxy), an alkylsulfonamide group (e.g., methylsulfonamido or octylsulfonamido), an arylsulfonamide group (e.g., phenylsulfonamido or naphthylsulfonamido), an alkylsulfamoyl group (e.g., butylsulfamoyl), an arylsulfamoyl group (e.g., phenylsulfamoyl), an alkyloxycarbonyl group (e.g., methoxycarbonyl), an aryloxycarbonyl group (e.g., phenyloxycarbonyl), an aminosulfonamide group, an acylamino group, a carbamoyl group, a sulfonyl group, a sulfinyl group, a sulfoxy group, a sulfo group, an aryloxy group, an alkoxy group, an alkylcarbonyl group, an arylcarbonyl group, or an aminocarbonyl group. It is possible to introduce two different groups of these groups into an aryl group. Either R₁₀ or R₈₅ is preferably a phenyl group, and is more preferably a phenyl group having a plurality of substituents containing a halogen atom or a cyano group.

R₆ is a —CONH—R₇ group, a —CO—R₇ group, or —CO—O—R₇ group, wherein R₇ is a substituted or unsubstituted alkyl group (preferably having at most 20 carbon atoms, such as methyl, ethyl, butyl, or dodecyl), an aryl group (preferably having 6 to 20 carbon atoms, such as phenyl, naphthol, or thienyl), or a heterocyclic group (thiophene, furan, imidazole, pyrazole, or pyrrole). The substituents of the alkyl group represented by R₇ are the same ones as substituents in R₁ to R₄. X₈ represents a substituted or unsubstituted aryl group or a heterocyclic group. These aryl groups include groups having 6 to 20 carbon atoms such as phenyl, naphthyl, or thienyl, while the heterocyclic groups include any of the groups such as thiophene, furan, imidazole, pyrazole, or pyrrole. The substituents which may be substituted to the group represented by X are the same ones as the substituents in R₁ to R₄. The groups represented by X preferably is an aryl group, which is substituted with an alkylamino group (a diethylamino group) at the paraposition, or a heterocyclic group. These may contain other photographically useful groups.

Specific examples of cyan forming leuco dyes (CL) are listed below, however are not limited thereto.

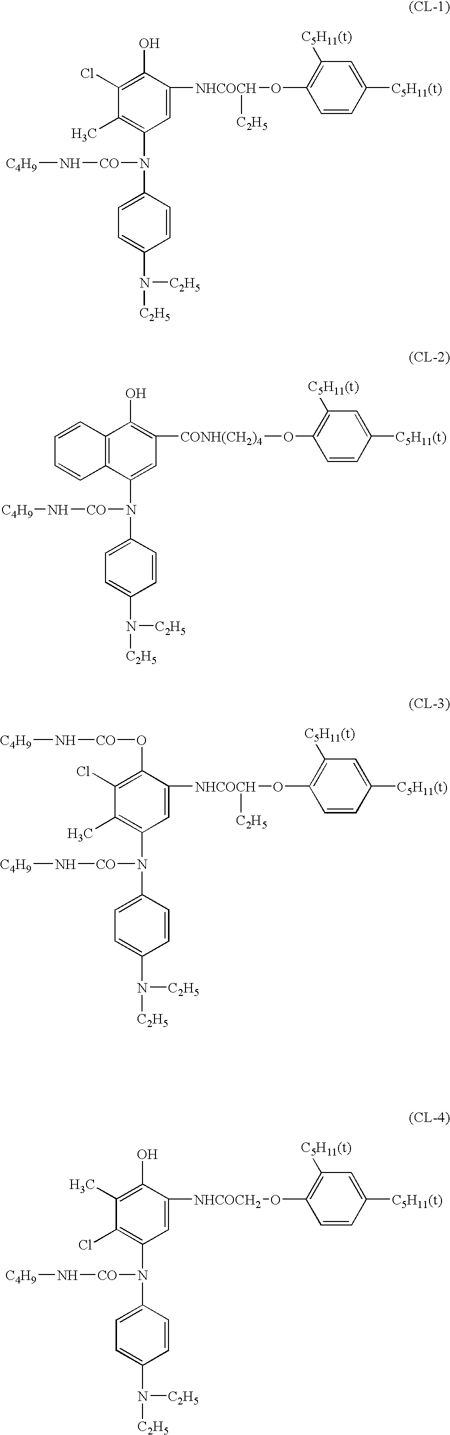

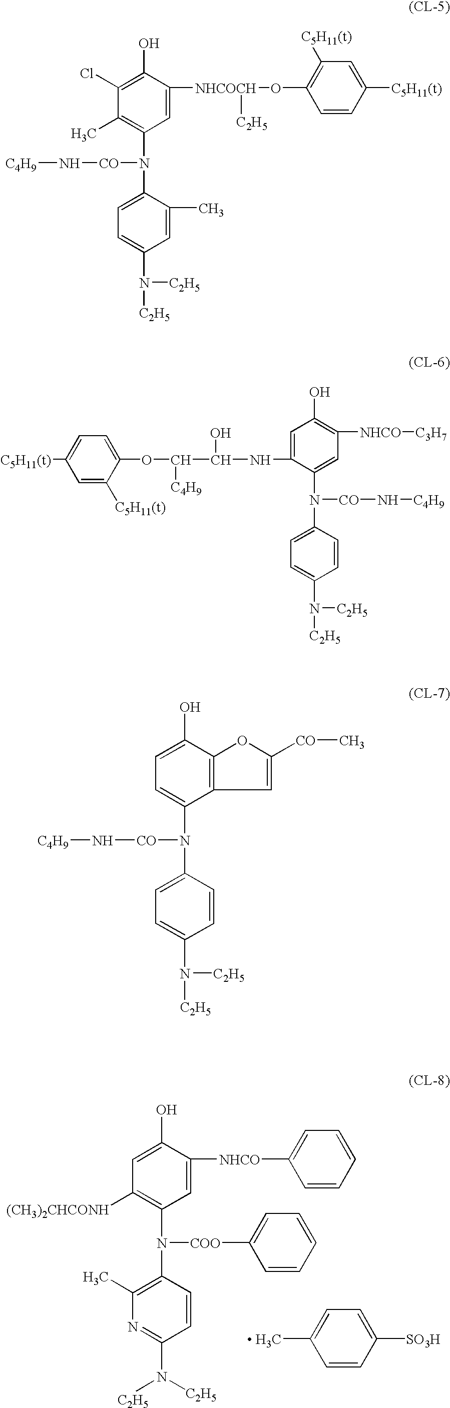

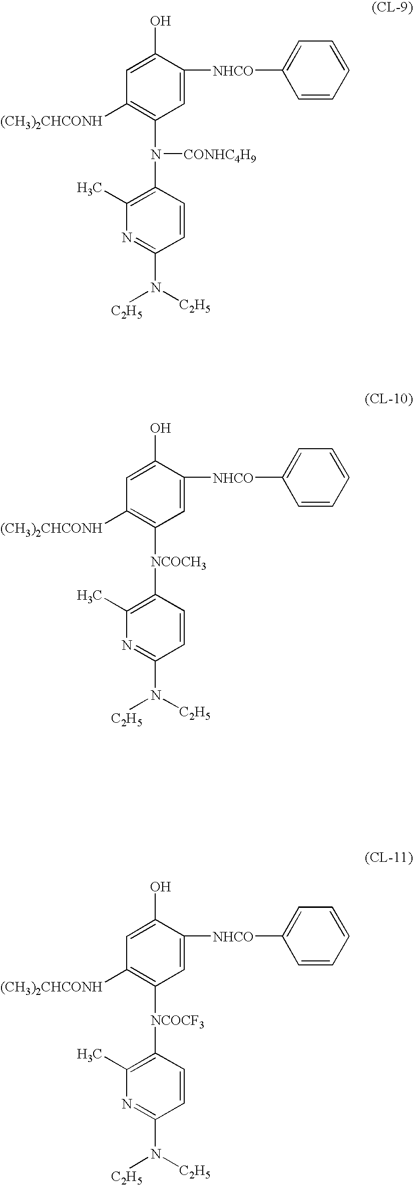

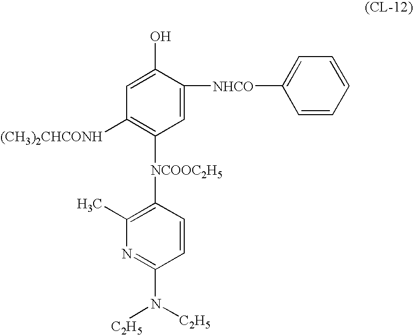

The addition amount of cyan forming leuco dyes is usually 0.00001 to 0.05 mol/mol of Ag, preferably 0.0005 to 0.02 mol/mol, and more preferably 0.001 to 0.01 mol.

The compounds represented by the foregoing formula (YL) and cyan forming leuco dyes may be added employing the same method as for the reducing agents represented by the foregoing formula (RED). They may be incorporated in liquid coating compositions employing an optional method to result in a solution form, an emulsified dispersion form, or a minute solid particle dispersion form, and then incorporated in a photosensitive material.

It is preferable to incorporate the compounds represented by Formula (YL) and cyan forming leuco dyes into an image forming layer containing organic silver salts. On the other hand, the former may be incorporated in the image forming layer, while the latter may be incorporated in a non-image forming layer adjacent to the aforesaid image forming layer. Alternatively, both may be incorporated in the non-image forming layer. Further, when the image forming layer is comprised of a plurality of layers, incorporation may be performed for each of the layers.

Fluorinated Surfactant

Fluorinated surfactants represented by the following formulas (SA-1) to (SA-3) are preferably employed in the photothermographic materials:
(Rf-L)ₚ-Y-(A)_{q} formula (SA-1)
LiO₃S—(CF₂)ₙ—SO₃Li formula (SA-2)
MO₃S—(CF₂)ₙ—SO₃M formula (SA-3)
wherein M represents a hydrogen atom, a sodium atom, a potassium atom, and an ammonium group; n represents a positive integer, while in the case in which M represents H, n represents an integer of 1 to 6 and 8, and in the case in which M represents an ammonium group, n represents an integer of 1 to 8.

In the foregoing formula (SA-1), Rf represents a substituent containing a fluorine atom. Fluorine atom-containing substituents include, for example, an alkyl group having 1 to 25 carbon atoms (such as a methyl group, an ethyl group, a butyl group, an octyl group, a dodecyl group, or an octadecyl group), and an alkenyl group (such as a propenyl group, a butenyl group, a nonenyl group or a dodecenyl group).

L represents a divalent linking group having no fluorine atom. Listed as divalent linking groups having no fluorine atom are, for example, an alkylene group (e.g., a methylene group, an ethylene group, and a butylene group), an alkyleneoxy group (such as a methyleneoxy group, an ethyleneoxy group, or a butyleneoxy group), an oxyalkylene group (e.g., an oxymethylene group, an oxyethylene group, and an oxybutylene group), an oxyalkyleneoxy group (e.g., an oxymethyleneoxy group, an oxyethyleneoxy group, and an oxyethyleneoxyethyleneoxy group), a phenylene group, and an oxyphenylene group, a phenyloxy group, and an oxyphenyloxy group, or a group formed by combining these groups.

A represents an anion group or a salt group thereof. Examples include a carboxylic acid group or salt groups thereof (sodium salts, potassium salts and lithium salts), a sulfonic acid group or salt groups thereof (sodium salts, potassium salts and lithium salts), and a phosphoric acid group and salt groups thereof (sodium salts, potassium salts and lithium salts).

Y represents a trivalent or tetravalent linking group having no fluorine atom. Examples include trivalent or tetravalent linking groups having no fluorine atom, which are groups of atoms comprised of a nitrogen atom as the center. P represents an integer from 1 to 3, while q represents an integer of 2 or 3.

The fluorinated surfactants represented by the foregoing formula (SA-1) are prepared as follows. Alkyl compounds having 1 to 25 carbon atoms into which fluorine atoms are introduced (e.g., compounds having a trifluoromethyl group, a pentafluoroethyl group, a perfluorobutyl group, a perfluorooctyl group, or a perfluorooctadecyl group) and alkenyl compounds (e.g., a perfluorohexenyl group or a perfluorononenyl group) undergo addition reaction or condensation reaction with each of the tri- to hexa-valent alknaol compounds into which fluorine atom(s) are not introduced, aromatic compounds having 3 or 4 hydroxyl groups or hetero compounds. Anion group (A) is further introduced into the resulting compounds (including alknaol compounds which have been partially subjected to introduction of Rf) employing, for example, sulfuric acid esterification.

Examples of the aforesaid tri- to hexa-valent alkanol compounds include glycerin, pentaerythritol, 2-methyl-2-hydroxymethyl-1,3-propanediol, 2,4-dihydroxy-3hydroxymethylpentane, 1,2,6-hexanrtriol. 1,1,1-tris(hydroxymethyl)propane, 2,2-bis(butanol), aliphatic triol, tetramethylolmethane, D-sorbitol, xylitol, and D-mannitol. The aforesaid aromatic compounds, having 3-4 hydroxyl groups and hetero compounds, include, for example, 1,3,5-trihydroxybenzene and 2,4,6-trihydroxypyridine.

In formula (SA-2), “n” is an integer of 1 to 4.

In the foregoing formula (SA-3), M represents a hydrogen atom, a potassium atom, or an ammonium group and n represents a positive integer. In the case in which M represents H, n represents an integer from 1 to 6 or 8; in the case in which M represents Na, n represents 4; in the case in which M represents K, n represents an integer from 1 to 6; and in the case in which M represents an ammonium group, n represents an integer from 1 to 8.

The fluorinated surfactants represented by the formulas (SA-1) to (SA-3) can be added to liquid coating compositions, employing any conventional addition methods known in the art. Thus, they are dissolved in solvents such as alcohols including methanol or ethanol, ketones such as methyl ethyl ketone or acetone, and polar solvents such as dimethylformamide, and then added. Further, they may be dispersed into water or organic solvents in the form of minute particles at a maximum size of 1 μm, employing a sand mill, a jet mill, or an ultrasonic homogenizer and then added. Many techniques are disclosed for minute particle dispersion, and it is possible to perform dispersion based on any of these. It is preferable that the aforesaid fluorinated surfactants are added to the protective layer which is the outermost layer.

The added amount of the aforesaid fluorinated surfactants is preferably 1×10⁻⁸ to 1×10⁻¹ mol per m². When the added amount is less than the lower limit, it is not possible to achieve desired charging characteristics, while it exceeds the upper limit, storage stability degrades due to an increase in humidity dependence.

Surfactants represented by the foregoing formulas (SA-1), (SA-2), and (SA-3) are disclosed in JP-A No. 2003-57786, and Japanese Patent Application Nos. 2002-178386 and 2003-237982.

Materials for the support employed in the photothermographic material are various kinds of polymers, glass, wool fabric, cotton fabric, paper, and metal (for example, aluminum). From the viewpoint of handling as information recording materials, flexible materials, which can be employed as a sheet or can be wound in a roll, are suitable. Accordingly, preferred as supports in the silver salt photothermographic dry imaging material of the present invention are plastic films (for example, cellulose acetate film, polyester film, polyethylene terephthalate film, polyethylene naphthalate film, polyamide film, polyimide film, cellulose triacetate film or polycarbonate film). Of these, in the present invention, biaxially stretched polyethylene terephthalate film is particularly preferred. The thickness of the supports is commonly from about 50 to about 300 μm, and is preferably from 70 to 180 μm.

To minimize static charge buildup, electrically conductive compounds such as metal oxides and/or electrically conductive polymers may be incorporated in composition layers. The compounds may be incorporated in any layer, but are preferably incorporated in a subbing layer, a backing layer, and an interlayer between the photosensitive layer and the subbing layer. In the present invention, preferably employed are electrically conductive compounds described in columns 14 through 20 of U.S. Pat. No. 5,244,773.

The silver salt photothermographic material relating to this invention comprises a support having thereon at least one photosensitive layer. The photosensitive layer may only be formed on the support. However, it is preferable that at least one light-insensitive layer is formed on the photosensitive layer. For example, it is preferable that for the purpose of protecting a photosensitive layer, a protective layer is formed on the photosensitive layer, and in order to minimize adhesion between photosensitive materials as well as adhesion in a wound roll, a backing layer is provided on the opposite side of the support. As binders employed in the protective layer as well as the backing layer, polymers such as cellulose acetate, cellulose acetate butyrate, which has a higher glass transition point from the thermal development layer and exhibit abrasion resistance as well as distortion resistance are selected from the aforesaid binders. Incidentally, for the purpose of increasing latitude, one of the preferred embodiments of the present invention is that at least two photosensitive layers are provided on the one side of the support or at least one photosensitive layer is provided on both sides of the support.

In the silver salt photothermographic dry imaging material of the present invention, in order to control the light amount as well as the wavelength distribution of light which transmits the photosensitive layer, it is preferable that a filter layer is formed on the photosensitive layer side or on the opposite side, or dyes or pigments are incorporated in the photosensitive layer.

For example, when the silver salt photothermographic dry imaging material of the present invention is used as an image recording material utilizing infrared radiation, it is preferable to employ squalilium dyes having a thiopyrylium nucleus (hereinafter referred to as thiopyriliumsqualilium dyes) and squalilium dyes having a pyrylium nucleus (hereinafter referred to as pyryliumsqualilium dyes), as described in Japanese Patent Application No. 11-255557, and thiopyryliumcroconium dyes or pyryliumcroconium dyes which are analogous to the squalilium dyes.

Incidentally, the compounds having a squalilium nucleus, as described herein, refers to ones having 1-cyclobutene-2-hydroxy-4-one in their molecular structure. Herein, the hydroxyl group may be dissociated. Hereinafter, all of these dyes are referred to as squalilium dyes. There are also preferably employed as a dye compounds described in JP-A No. 8-201959.

Layer Arrangement and Coating Codition

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method. Of these, more preferred is the pre-weighing type coating system called an extrusion coating method. The extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above.

In the present invention, silver coverage is preferably from 0.1 to 2.5 g/m², and is more preferably from 0.5 to 1.5 g/m². Further, in the present invention, it is preferable that in the silver halide grain emulsion, the content ratio of silver halide grains, having a grain diameter of 0.030 to 0.055 μm in term of the silver weight, is from 3 to 15 percent in the range of a silver coverage of 0.5 to 1.5 g/m². The ratio of the silver coverage which is resulted from silver halide is preferably from 2 to 18 percent with respect to the total silver, and is more preferably from 3 to 15 percent. Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷. Further, the coated weight of aliphatic carboxylic acid silver salts of the present invention is from 10⁻¹⁷ to 10⁻¹⁵ g per silver halide grain having a diameter (being a sphere equivalent grain diameter) of at least 0.01 μm, and is more preferably from 10⁻¹⁶ to 10⁻¹⁴ g. When coating is carried out under conditions within the aforesaid range, from the viewpoint of maximum optical silver image density per definite silver coverage, namely covering power as well as silver image tone, desired results are obtained.

Packaging Material

A package material relating to this invention is comprised of a surface layer as a design-printed surface, an interlayer having moisture-proofing or light-shielding function and a lower layer having a heat-melting function. The interlayer may optionally be comprised of plural layers. For instance, Two layers are comprised of one layer having moisture-proofing function and the other layer having light-shielding function. The lower layer may have light-shielding function. Material used for the surface layer is not specifically limited and may be the same one as used in the interlayer.

Conventionally used packaging materials are usable as material for use in the respective layers of a packaging material and examples thereof include low density polyethylene (LDPE), high density polyethylene (HDPE), linear low density polyethylene)LLDPE), intermediate density polyethylene, non-oriented polypropylene (CPP), oriented polypropylene (OPP), oriented nylon, (ONy), polyethylene terephthalate (PET), cellophane, polyvinyl alcohol, (PVA), oriented vinylon (OV), ethylene-vinyl acetate copolymer, (EVOH), and polyvinylidene chloride (PVDC). These material are usable as a multilayer material made by co-extrusion of different polymer films or as multilayer material made by lamination at different orientation angles. Further, to obtain physical properties of a desired packaging material, densities or molecular weight distributions of polymeric film materials may be combined.

Polymeric film materials for use in the lower layer of multilayer material usable in this invention include, for example, LDPE and LLDPE manufactured using a metallocene catalyst. In these polymeric film materials may be incorporated LDPE or LLDPE manufactured by conventional methods. There are usable commercially available LDPE and LLDPE manufactured using a metallocene catalyst.

To enhance slippage for imaging materials or protective materials to be packaged, slipping agents are preferably incorporated to the lower layer. Examples of a slipping agent include a metal soap (e.g., zinc stearate, calcium stearate), fatty acid amide and higher fatty acids.

Light-shielding ability as a function required in multilayer material usable in this invention can be achieved by incorporation of light-shielding materials described in JP-A Nos. 63-85539, 64-82935, 1-209134, 1-94341, 2-165140, and 2-221956. The light-shielding layer may be provided in any layer of the multilayer material, but an interlayer or a heat-fusible layer is preferred. A layer mainly comprised of polyethylene is preferable but is not specifically limited to this. Incorporation of carbon black is preferred as a light-shielding material to be incorporated to the light-shielding layer, in terms of light-shielding ability and cost.

The packaging material usable in this invention exhibits a water-vapor permeability of not more than 5.0 g/m²·24 hr·40° C.·90 RH (JIS K 7192/1992), and preferably not more than 1.0 g/m²·24 hr·40° C.·90% RH. A water-vapor permeability of more than 5.0 g/m²·24 hr·40° C.·90% RH results in fogging. The interlayer of a package material can employ moisture-proofing materials described in JP-A Nos. 8-254793, 8-171177, 8-122980, 6-259343, 6-122469, 6-95302, 60-151045, 60-189438, 61-54934, 63-30842, 63-247033, 63-272668, 63-283936, 63-193144, 63-183839, 64-16641, 1-93348, 64-77532, 1-251031, 2-186338, 1-267031, 2-235048, 2-278256, 1-152336, 2-21645, and 2-44738. Of these, the use of an aluminum foil or material having a deposited aluminum layer, or deposited alumina (Al₂O₃) or silica (SiO₂) layer is preferable. The water-vapor permeability can be determined in a method described in accordance with ZIS Z-028.

Exposure

When the photothermographic dry imaging material of the present invention is exposed, it is preferable to employ an optimal light source for the spectral sensitivity provided to the aforesaid photosensitive material. For example, when the aforesaid photosensitive material is sensitive to infrared radiation, it is possible to use any radiation source which emits radiation in the infrared region. However, infrared semiconductor lasers (at 780 nm and 820 nm) are preferably employed due to their high power, as well as ability to make photosensitive materials transparent.

In the present invention, it is preferable that exposure is carried out utilizing laser scanning. Employed as the exposure methods are various ones. For example, listed as a preferable method is the method utilizing a laser scanning exposure apparatus in which the angle between the scanning surface of a photosensitive material and the scanning laser beam does not substantially become vertical. “Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans photosensitive materials, the beam spot diameter on the exposed surface of the photosensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode. The longitudinal multiple mode is achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

In the recording methods of the aforesaid first and second embodiments, it is possible to suitably select any of the following lasers employed for scanning exposure, which are generally well known, while matching the use. The foregoing lasers include solid lasers such as a ruby laser, a YAG laser, and a glass laser; gas lasers such as a HeNe laser, an Ar ion laser, a Kr ion laser, a CO₂ laser a CO laser, a HeCd laser, an N₂ laser, and an excimer laser; semiconductor lasers such as an InGaP laser, an AlGaAs laser, a GaASP laser, an InGaAs laser, an InAsP laser, a CdSnP₂ laser, and a GaSb laser; chemical lasers; and dye lasers. Of these, from the viewpoint of maintenance as well as the size of light sources, it is preferable to employ any of the semiconductor lasers having a wavelength of 600 to 1,200 nm. The beam spot diameter of lasers employed in laser imagers, as well as laser image setters, is commonly in the range of 5 to 75 μm in terms of a short axis diameter and in the range of 5 to 100 μm in terms of a long axis diameter. Further, it is possible to set a laser beam scanning rate at the optimal value for each photosensitive material depending on the inherent speed of the silver salt photothermographic dry imaging material at laser transmitting wavelength and the laser power.

In the present invention, development conditions vary depending on employed devices and apparatuses, or means. Typically, an imagewise exposed silver salt photothermographic dry imaging material is heated at optimal high temperature. It is possible to develop a latent image formed by exposure by heating the material at relatively high temperature (for example, from about 100 to about 200° C.) for a sufficient period (commonly from about 1 second to about 2 minutes). When the heating temperature is less than or equal to 100° C., it is difficult to obtain sufficient image density within a relatively short period. On the other hand, at more than or equal to 200° C., binders melt so as to be transferred to rollers, and adverse effects result not only for images but also for transportability as well as processing devices. Upon heating the material, silver images are formed through an oxidation-reduction reaction between aliphatic carboxylic acid silver salts (which function as an oxidizing agent) and reducing agents. This reaction proceeds without any supply of processing solutions such as water from the exterior.

Heating may be carried out employing typical heating means such as hot plates, irons, hot rollers and heat generators employing carbon and white titanium. When the protective layer-provided silver salt photothermographic dry imaging material of the present invention is heated, from the viewpoint of uniform heating, heating efficiency, and workability, it is preferable that heating is carried out while the surface of the side provided with the protective layer comes into contact with a heating means, and thermal development is carried out during the transport of the material while the surface comes into contact with the heating rollers.

### EXAMPLES

The present invention will be further described based on examples but is by no means limited to these.

### Example 1

### Preparation of Photothermographic Material

A photographic support comprised of a 175 μm thick biaxially oriented polyethylene terephthalate film with blue tinted at an optical density of 0.170 (determined by Densitometer PDA-65, manufactured by Konica Minolta MG Inc.), which had been subjected to corona discharge treatment of 8 W·minute/m² on both sides, was subjected to subbing. Namely, subbing liquid coating composition a-1 was applied onto one side of the above photographic support at 22° C. and 100 m/minute to result in a dried layer thickness of 0.2 μm and dried at 140° C., whereby a subbing layer on the image forming layer side (designated as Subbing Layer A-1) was formed. Further, subbing liquid coating composition b-1 described below was applied, as a backing layer subbing layer, onto the opposite side at 22° C. and 100 m/minute to result in a dried layer thickness of 0.12 μm and dried at 140° C. An electrically conductive subbing layer (designated as subbing lower layer B-1), which exhibited an antistatic function, was applied onto the backing layer side. The surface of subbing Lower Layer A-1 and subbing lower layer B-1 was subjected to corona discharge treatment of 8 W·minute/m². Subsequently, subbing liquid coating composition a-2 was applied onto subbing lower layer A-1 was applied at 33° C. and 100 m/minute to result in a dried layer thickness of 0.03 μm and dried at 140° C. The resulting layer was designated as subbing upper layer A-2. Subbing liquid coating composition b-2 described below was applied onto subbing lower Layer B-1 at 33° C. and 100 m/minute to results in a dried layer thickness of 0.2 μm and dried at 140° C. The resulting layer was designated as subbing upper layer B-2. Thereafter, the resulting support was subjected to heat treatment at 123° C. for two minutes and wound up under the conditions of 25° C. and 50 percent relative humidity, whereby a subbed sample was prepared.

Preparation of Water-Based Polyester A-1

A mixture of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 part by weight of calcium acetate monohydrate, and 0.022 part by weight of manganese acetate tetrahydrate was subjected to transesterification at 170 to 220° C. under a flow of nitrogen while distilling out methanol. Thereafter, 0.04 part by weight of trimethyl phosphate, 0.04 part by weight of antimony trioxide, and 6.8 parts by weight of 4-cyclohexanedicarboxylic acid were added. The resulting mixture underwent esterification at a reaction temperature of 220 to 235° C. while a nearly theoretical amount of water being distilled away.

Thereafter, the reaction system was subjected to pressure reduction and heating over a period of one hour and was subjected to polycondensation at a final temperature of 280° C. and a maximum pressure of 133 Pa for one hour, whereby Water-soluble Polyester A-1 was synthesized. The intrinsic viscosity of the resulting Water-soluble Polyester A-1 was 0.33, the average particle-size was 40 nm, and Mw was 80,000 to 100,000.

Subsequently, 850 ml of pure water was placed in a 2-liter three-necked flask fitted with stirring blades, a refluxing cooling pipe, and a thermometer, and while rotating the stirring blades, 150 g of water-soluble polyester A-1 was gradually added. The resulting mixture was stirred at room temperature for 30 minutes without any modification. Thereafter, the interior temperature was raised to 98° C. over a period of 1.5 hours and at that resulting temperature, dissolution was performed. Thereafter, the temperature was lowered to room temperature over a period of one hour and the resulting product was allowed to stand overnight, whereby water-based polyester A-1 solution was prepared.

Modified Water-Based Polyester Solution B-1 and B-2

Into a 3-liter four-necked flask fitted with stirring blades, a reflux cooling pipe, a thermometer, and a dripping funnel was put 1,900 ml of the aforesaid 15 percent by weight water-based polyester A-1 solution, and the interior temperature was raised to 80° C., while rotating the stirring blades. Into this was added 6.52 ml of a 24 percent aqueous ammonium peroxide solution, and a monomer mixed liquid composition (consisting of 28.5 g of glycidyl methacrylate, 21.4 g of ethyl acrylate, and 21.4 g of methyl methacrylate) was dripped over a period of 30 minutes, and reaction was allowed for an additional 3 hours. Thereafter, the resulting product was cooled to at most 30° C., and filtrated, whereby modified water-based polyesters solution B-1 (vinyl based component modification ratio of 20 percent by weight) of 18 wt % solid was obtained.

Subsequently, modified water-based polyester B-2 at a solid concentration of 18 percent by weight (a vinyl based component modification ratio of 20 percent by weight) was prepared in the same manner as above except that the vinyl modification ratio was changed to 36 percent by weight and the modified component was changed to styrene:glycidyl methacrylate:acetacetoxyethyl methacrylate:n-butyl acrylate=39.5:40:20:0.5.

Preparation of Acryl Based Polymer Latexes C-1 to C-3

Acryl based polymer latexes C-1 to C-3 having the monomer compositions shown in Table 1 were synthesized employing emulsion polymerization. All the solid concentrations were adjusted to 30 percent by weight.

TABLE 2

| Latex No. | Monomer Composition (weight ratio) | Tg (° C.) |
|---|---|---|
| C-1 | styrene:glycidyl methacrylate:n- | 20 |
| | butyl acrylate = 20:40:40 | |
| C-2 | styrene:n-butyl acrylate:t-butyl | 55 |
| | acrylate:hydroxyethyl methacrylate = 27:10:35:28 | |
| C-3 | styrene:glycidyl methacrylate:acetacetoxyethyl | 50 |
| | methacrylate = 40:40:20 | |

Coating Composition a-1: Subbing Lower Layer A-1 on Image Forming Layer Side

| | | |
|---|---|---|
| Acryl Based Polymer Latex C-3 (30% solids) | 70.0 | g |
| Aqueous dispersion of ethoxylated alcohol and | 5.0 | g |
| ethylene homopolymer (10% solids) | | |
| Surfactant (A) | 0.1 | g |
| Distilled water to make | 1000 | ml |

Coating Composition a-2: Image Forming Layer Side Subbing Upper Layer A-2

| | | |
|---|---|---|
| Modified Water-based Polyester B-2 (18 wt %) | 30.0 | g |
| Surfactant (A) | 0.1 | g |
| Spherical silica matting agent (Sea Hoster | 0.04 | g |
| KE-P50, manufactured by Nippon Shokubai | | |
| Co., Ltd.) | | |
| Distilled water to make | 1000 | ml |

Coating Composition b-1: Backing Layer Side Subbing Lower Layer B-1

| Acryl Based Polymer Latex C-1 (30% solids) | 30.0 | g |
|---|---|---|
| Acryl Based Polymer Latex C-2 (30% solids) | 7.6 | g |
| SnO₂ sol*¹ | 180 | g |
| Surfactant (A) | 0.5 | g |
| Aqueous 5 wt % PVA-613 (PVA, manufactured | 0.4 | g |
| by Kuraray Co., Ltd.) | | |
| Distilled water to make | 1000 | ml |
| *¹The solid concentration of SnO₂ sol synthesized employing the method described in Example 1 of Japanese Patent Publication JP-B No. 35-6616 (the term, JP-B refers to Japanese Patent Publication) was heated and concentrated to | | |
| # reach a solid concentration of 10 percent by weight, and subsequently, the pH was adjusted to 10 by the addition of ammonia water. | | |

Coatings Composition b-2: Backing Layer Side Subbing Upper Layer B-2

| | | |
|---|---|---|
| Modified Water-based Polyester B-1 (18 percent | 145.0 | g |
| by weight) | | |
| Spherical silica matting agent (Sea Hoster | 0.2 | g |
| KE-P50, manufactured by Nippon Shokubai | | |
| Co., Ltd.) | | |
| Surface Active Agent (A) | 0.1 | g |
| Distilled water to make | 1000 | ml |

An antihalation layer having the composition described below was applied onto subbing layer A-2 on the subbed support.

Antihalation Layer Coating Composition

| | | |
|---|---|---|
| PVB-1 (binder resin) | 0.8 | g/m² |
| Infrared dye 1 | 1.2 × 10⁻⁵ | mol/m² |

Coating compositions of a backing layer and its protective layer which were prepared to achieve a coated amount (per m²) described below was successively applied onto the subbing upper layer B-2 and subsequently dried, whereby a a backing layer and a protective layer were formed.

Backing Layer Coating Composition

| | | |
|---|---|---|
| PVB-1 (binder resin) | 1.8 | g |
| Infrared dye | 1.2 × 10⁻⁵ | mol |

Bucking Protective Layer Coating Composition

| | | |
|---|---|---|
| Cellulose acetate butyrate | 1.1 | g |
| Matting agent (polymethyl methacrylate of an | 0.12 | g |
| average particle size of 5 μm) | | |
| Antistatic agent F-EO | 250 | mg |
| Antistatic agent F-DS1 | 30 | mg |

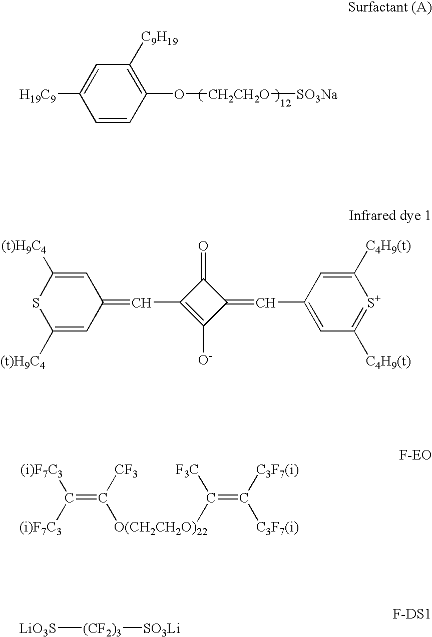

Preparation of Silver Halide Emulsion 1

Solution A1

| | | |
|---|---|---|
| Phenylcarbamoyl-modified gelatin | 88.3 | g |
| Compound*³ (10% aqueous methanol solution) | 10 | ml |
| Potassium bromide | 0.32 | g |
| Water to make | 5429 | ml |

Solution B1

| | | |
|---|---|---|
| 0.67 mol/L aqueous silver nitrate | 2635 | ml |
| solution | | |

Solution C1

| | | |
|---|---|---|
| Potassium bromide | 51.55 | g |
| Potassium iodide | 1.47 | g |
| Water to make | 660 | ml |

Solution D1

| | | |
|---|---|---|
| Potassium bromide | 154.9 | g |
| Potassium iodide | 4.41 | g |
| K₃IrCl₆ (equivalent to 4 × 10⁻⁵ mol/Ag) | 50.0 | ml |
| Water to make | 1982 | ml |

Solution E1

0.4 mol/L aqueous potassium bromide solution
in an amount to control silver potential

Solution F1

| | | |
|---|---|---|
| Potassium hydroxide | 0.71 | g |
| Water to make | 20 | ml |

Solution G1

| | | |
|---|---|---|
| 56% aqueous acetic acid solution | 18.0 | ml |

Solution H1

| | | |
|---|---|---|
| Sodium carbonate anhydride | 1.72 | g |
| Water to make | 151 | ml |

*³Compound A: HO(CH₂CH₂O)ₙ(CH(CH₃)CH₂O)₁₇(CH₂CH₂O)ₘH (m + N = 5 through 7)

Using a mixing stirrer shown in JP-B Nos. 58-58288 and 58-58289, ¼ portion of solution B1 and whole solution C1 were added to solution A1 over 4 minutes 45 seconds, employing a double-jet precipitation method while adjusting the temperature to 30° C. and the pAg to 8.09, whereby nuclei were formed. After one minute, whole solution F1 was added. During the addition, the pAg was appropriately adjusted employing Solution E1. After 6 minutes, ¾ portions of solution B1 and whole solution D1 were added over 14 minutes 15 seconds, employing a double-jet precipitation method while adjusting the temperature to 30° C. and the pAg to 8.09. After stirring for 5 minutes, the mixture was cooled to 40° C., and whole solution G1 was added, whereby a silver halide emulsion was flocculated. Subsequently, while leaving 2000 ml of the flocculated portion, the supernatant was removed, and 10 L of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, solution H1 was added and the resultant mixture was heated to 60° C., and then stirred for an additional 120 minutes. Finally, the pH was adjusted to 5.8 and water was added so that the weight was adjusted to 1,161 g per mol of silver, whereby an emulsion was prepared.

The prepared emulsion was comprised of monodisperse cubic silver iodobromide grains having an average grain size of 0.040 μm, a grain size variation coefficient of 12 percent and a (100) crystal face ratio of 92 percent.

Preparation of Aliphatic Carboxylic Acid Silver Salt A

In 4,720 ml of pure water were dissolved 117.7 g of behenic acid, 60.9 g of arachidic acid, 39.2 g of stearic acid, and 2.1 g of palmitic acid at 80° C. Subsequently, 486.2 ml of a 1.5 M aqueous sodium hydroxide solution was added, and further, 6.2 ml of concentrated nitric acid was added. Thereafter, the resultant mixture was cooled to 55° C., whereby an aliphatic acid sodium salt solution was prepared. After 347 ml of t-butyl alcohol was added and stirred for 20 min, the above-described photosensitive silver halide emulsion 1 as well as 450 ml of pure water was added and stirred for 5 minutes.

Subsequently, 702.6 ml of one mol silver nitrate solution was added over two minutes and stirred for 10 minutes, whereby an aliphatic carboxylic acid silver salt dispersion was prepared. Thereafter, the resultant aliphatic carboxylic acid silver salt dispersion was transferred to a water washing machine, and deionized water was added. After stirring, the resultant dispersion was allowed to stand, whereby a flocculated aliphatic carboxylic acid silver salt was allowed to float and was separated, and the lower portion, containing water-soluble salts, were removed. Thereafter, washing was repeated employing deionized water until electric conductivity of the resultant effluent reached 50 μS/cm. After centrifugal dehydration, the resultant cake-shaped aliphatic carboxylic acid silver salt was dried employing an gas flow type dryer Flush Jet Dryer (manufactured by Seishin Kigyo Co., Ltd.), while setting the drying conditions such as nitrogen gas as well as heating flow temperature at the inlet of the dryer, until its water content ratio reached 0.1 percent, whereby powdery aliphatic carboxylic acid silver salt A was prepared. The thus prepared powdery aliphatic carboxylic acid silver salt A had a silver behenate content of 60%.

Preparation of Aliphatic Carboxylic Acid Silver Salt B

Powdery aliphatic carboxylic acid silver salt B was prepared similarly to the foregoing aliphatic carboxylic acid silver salt A, provided that 217.0 g of behenic acid, 20.0 g of arachidic acid and 17.3 g of stearic acid were used and dissolved at a temperature of 90° C. The silver behenate content of aliphatic carboxylic acid silver salt B was 85%.

Preparation of Aliphatic Carboxylic Acid Silver Salt C

Powdery aliphatic carboxylic acid silver salt C was prepared similarly to the foregoing aliphatic carboxylic acid silver salt A, provided that purification was conducted once through recrystallization using toluene to enhance purity up to 92% and fatty acids were dissolved at a temperature of 90° C. The silver behenate content of aliphatic carboxylic acid silver salt B was 93%.

Preparation of Aliphatic Carboxylic Acid Silver Salt D

Powdery aliphatic carboxylic acid silver salt D was prepared similarly to the foregoing aliphatic carboxylic acid silver salt A, provided that purification was conducted three times through recrystallization using toluene to enhance a purity up to 98% and fatty acids were dissolved at a temperature of 90° C. The silver behenate content of aliphatic carboxylic acid silver salt D was 98%.

Preparation of Preliminary Dispersions A-D

In 1457 g of methyl ethyl ketone (hereinafter referred to as MEK) was dissolved 14.57 g of poly(vinyl butyral) resin P-9. While stirring, employing dissolver DISPERMAT Type CA-40M, manufactured by VMA-Getzmann Co., 500 g of aforesaid Powder Aliphatic Carboxylic Acid Silver Salt A was gradually added and sufficiently mixed, and Preliminary Dispersion A was thus prepared. Similarly, preliminary dispersions B-D were prepared using powdery aliphatic carboxylic acid silver salts B-D.

Preparation of Photosensitive Emulsions A-D

Preliminary dispersion A, prepared as above, was charged into a media type homogenizer DISPERMAT Type SL-C12EX (manufactured by VMA-Getzmann Co.), filled with 0.5 mm diameter zirconia beads (Toreselam, produced by Toray Co.) so as to occupy 80 percent of the interior volume so that the retention time in the mill reached 1.5 minutes and was dispersed at a peripheral rate of the mill of 8 m/second, whereby photosensitive emulsion A was prepared. Similarly, photosensitive emulsions B-D were prepared using preliminary dispersions B-D, respectively.

Preparation of Stabilizer Solution

Stabilizer solution was prepared by dissolving 1.0 g of stabilizer 1 and 0.31 g of potassium acetate in 4.97 g of methanol.

Preparation of Infrared Sensitizing Dye A Solution

Infrared sensitizing dye A solution was prepared by dissolving 19.2 mg of infrared sensitizing dye 1, 10 mg of infrared sensitizing dye 2, 1.48 g of 2-chloro-benzoic acid, 2.78 g of stabilizer 2, and 365 mg of 5-methyl-2-mercaptobenzimidazole in 31.3 ml of MEK in a dark room.

Preparation of Additive Solution “a”

Additive solution “a” was prepared by dissolving 27.98 g of 1,1-bis(2-hydroxy-3,5-dimethylphenyl)-3,5,5-trimethylhexane (RED-12 or developer A) and 1.54 g of 4-methylphthalic acid, and 0.20 g of aforesaid infrared dye 1 in 110 g of MEK.

Preparation of Additive Solution “b”

Additive Solution “b” was prepared by dissolving 3.56 g of Antifoggant 2 and 3.43 g of phthalazine in 40.9 g of MEK.

Preparation of Light-sensitive Layer Coating Composition

While stirring, 50 g of aforesaid light-sensitive emulsion A and 15.11 g of MEK were mixed and the resultant mixture was maintained at 21° C. Subsequently, 390 μl of antifoggant 1 (being a 10 percent methanol solution) was added and stirred for one hour. Further, 494 μl of calcium bromide (being a 10 percent methanol solution) was added and stirred for 20 minutes. Subsequently, 167 ml of aforesaid stabilizer solution was added and stirred for 10 minutes. Thereafter, 1.32 g of the foregoing infrared sensitizing dye A was added and the resulting mixture was stirred for one hour. Subsequently, the resulting mixture was cooled to 13° C. and stirred for an additional 30 minutes. While maintaining at 13° C., 20.40 g of poly(vinyl acetal) resin P-3 as a binder was added and stirred for 30 minutes. Thereafter, 1.084 g of tetrachlorophthalic acid (being a 9.4 weight percent MEK solution) was added and stirred for 15 minutes. Further, while stirring, 12.43 g of additive solution “a”, 1.6 ml of Desmodur N300/aliphatic isocyanate, manufactured by Mobay Chemical Co. (being a 10 percent MEK solution), and 4.27 g of additive Solution “b” were successively added, whereby light-sensitive layer coating composition T1 was prepared. Subsequently, light-sensitive layer coating compositions T2 to T8 were prepared similarly, provided that the light-sensitive layer composition, and the binder resin and its content were changed, as shown in Table 3. The foregoing polyvinyl acetal resin as a binder resin was used selecting a binder resin shown in Table 3.

Coating Solution of Protective Layer A

To 865 g of methyl ethyl ketone were added 96 g of cellulose acetate butyrate (CAB 171-15, product by Eastman Chemical Co.), polymethyl methacrylate (Paraloid A-21, Rohm & Haas Co.), 1.5 g of vinylsulfone compound, 1.0 g of benzotriazole and 1.0 g of a fluorinated surfactant (Surflon KH40, product by Asahi Glass Co., Ltd.) with stirring. Then, 30 g of 1 matting agent MEK dispersion was added thereto with stirring to prepare a coating solution of a surface protective layer A.

1st Layer Coating Solution of Protective Layer B

In water was dissolved 64 g of inert gelatin, and 80 g of 27% methylmetacrylate/styrene/butyl acrylate, hydroxyethyl methacrylate.acrylic acid copolymer (64/9/20/5/2 in weight ratio) latex solution, 23 ml of 10% phthalic acid methanol solution, 23 ml of aqueous 10% 4-methylphthalic acid solution, 28 ml of 0.5 mol/L sulfuric acid, 5 ml of an aqueous 5% airosol OT solution, 0.5 g of phenoxyethanol and 0.1 g of benzoisothiazoline were added thereto. Water was further added to make a coating solution in a total amount of 750 g. Then, 26 ml of aqueous chromium alum solution was added with stirring by a static mixer immediately before coating and the thus prepared coating solution was supplied to a coating die so as to form a coverage of 18.6 ml/m². The viscosity of the coating solution was 20 mPa·s, measured by B-type viscometer (No. 1 rotor, 60 rpm) at 40° C.

2nd Layer Coating Solution of Protective Layer B

In water was dissolved 64 g of inert gelatin, and 102 g of 27% methylmetacrylate/styrene/butyl acrylate, hydroxyethyl methacrylate.acrylic acid copolymer (64/9/20/5/2 in weight ratio) latex solution, 15 ml of an aqueous 5% solution of fluorinated surfactant (F-11) of formula (F), 15 ml of an aqueous 5% solution of fluorinated surfactant (FF-1), 23 ml of an aqueous 5% airosol OT solution, 1.6 g of 4-methylphalic acid, 4.8 g of phthalic acid, 44 ml of 0.5 mol/L sulfuric acid and 10 mg of benzoisothiazoline were added thereto. Water was further added to make a coating solution in a total amount of 650 g and stirred by a dissolver. Thereafter, 132.0 g of monodisperse silica having a monodisperse degree of 15% (average particle size of 3 μm, surface-treated with aluminum at 1% of the total weight of silica), which was dispersed in water at a concentration of 5%, was added and dispersed with stirring. Then, 445 ml of an aqueous solution containing 4% chromium alum and 0.67% phthalic acid was added with stirring by a static mixer immediately before coating and the thus prepared coating solution was supplied as a 2nd coating solution of surface protective layer B to a coating die so as to form a coverage of 8.3 ml/m². The viscosity of the coating solution was 18 mPa·s, measured by B-type viscometer (No. 1 rotor, 60 rpm) at 40° C.

Preparation of Photothermographic Material Sample

Light-sensitive layer coating solution T1 and surface protective layer coating soution B, prepared as above, were simultaneously coated onto the subbing layer on the support prepared as above, employing a prior art extrusion type coater, and sample 101 was prepared. Coating was performed so that the coated silver amount of the light-sensitive layer was 1.5 g/m² and the thickness of the surface protective layer reached 2.5 μm after drying. Thereafter, drying was performed employing a drying air flow at a drying temperature of 75° C. and a dew point of 10° C. for 10 minutes, and photothermographic material sample 101 was thus obtained.

Samples 102 through 111 were prepared similarly to sample 101, provided that the kind of a light-sensitive emulsion contained in the light-sensitive layer coating solution T1, the content of a binder and its kind were varied as shown in Table 3.

Packaging of Sample

Thus prepared samples were each packaged in packaging materials No. 1 to 4, exhibiting a water-vapor permeability shown in Table 3 under a degassing pressure of 2.0 kPa. The thus packaged samples were maintained under conditions of 23° C. and 80% RH for 7 days and subjected to characteristic evaluation, as described below.

Packaging Material 1
(outer side) nylon 10 μm/Al 0.05 μm (moisture-proofing layer)/polyethylene 20 μm/carbon black+polyethylene 20 μm (light-shielding layer) (inner side or light-sensitive layer side)

Packaging Material 2
(outer side) nylon 15 μm/Al 0.05 μm (moisture-proofing layer)/polyethylene 20 μm/carbon black+polyethylene 30 μm (light-shielding layer) (inner side or light-sensitive layer side)

Packaging Material 3
(outer side) nylon 15 μm/Al 0.07 μm (moisture-proofing layer)/polyethylene 20 μm/carbon black+polyethylene 40 μm (light-shielding layer) (inner side or light-sensitive layer side)

Packaging Material 4
(outer side) nylon 15 μm/Al 7 μm (moisture-proofing layer)/polyethylene 20 μm/carbon black+polyethylene 30 μm (light-shielding layer) (inner side or light-sensitive layer side)

### Evaluation

Initial Moisture Content Change

Using packaging materials No. 1 to 4 described above, photothermographic material samples were packaged under a deaeration pressure of 2.0 kPa and stored at 23° C. and 80% RH for 7 days. The thus stored samples were opened under conditions of 23° C. and 80% RH and further allowed to stand for 6 hr. as such. The moisture content immediately after being opened and the moisture content after being allowed to stand at 23° C. and 80% Rh for 6 hr. after being opened were measure for each sample. The ratio of the moisture content after being allowed to stand for 6 hr to that immediately after being opened was defined as the initial moisture content change upon environment exposure (also denoted simply as moisture content change) and shown in Table 3.

Exposure and Processing

Scanning exposure was applied onto the emulsion side surface of each sample prepared as above, employing an exposure apparatus in which a semiconductor laser, which was subjected to a longitudinal multi-mode at a wavelength of 800 to 820 nm, employing high frequency superposition, was employed as a laser beam source. Exposure was carried out while adjusting the angle between the exposed surface of the sample and the exposure laser beam to 75 degrees. Such exposure resulted in formed images exhibiting minimized unevenness and surprisingly superior sharpness, compared to the case in which the angle was adjusted to 90 degrees.

Thereafter, while employing an automatic processor having a heating drum, the protective layer of each sample was brought into contact with the surface of the drum and thermal development was carried out at 123° C. over 15 sec. Exposure and thermal development were carried out in an atmosphere maintained at 23° C. and 50% RH.

Fogging

The density in an unexposed area of each of the thus processed samples was measured using a densitometer and defined as the fog density.

Sensitivity

The visual transmission density of the resulting silver images formed as above was measured employing a densitometer and characteristic curves were prepared in which the abscise shows the exposure amount and the ordinate shows the density. Utilizing the resulting characteristic curve, sensitivity (also denoted simply as “S”) was defined as the reciprocal of the exposure amount to give a density higher 1.0 than an unexposed area. Sensitivity was represented by a relative value, based on the sensitivity of sample 101 being 100.

Fogging After Retained in Imager

After outputting samples to determine the fog density and the sensitivity of each, the imager was maintained for 24 hr. without turning off the power source. The density of unexposed areas of outputted film samples was determined using a densitometer and indicated as the fog density after being retained in the imager.

Density Change After Retained in Imager

Densities obtained at a given exposure under exposure conditions similar to the foregoing sensitometry, were determined with respect to before and after retained in the imager. From the obtained densities, the density change between before and after retained in an imager was determined based on the following equation:
Density change after retain in imager=[(density after retained in imager)/(density before retained in imager)]×100
Water-Vapor Permeability

The water-vapor permeability of each of the foregoing package materials 1 to 4 was determined in accordance with the method described in JIS K 7192/1992. Results thereof are shown in Table 3.

TABLE 3

| | | | Binder/ | | | Moisture | | | | Density |
|---|---|---|---|---|---|---|---|---|---|---|
| Sample | | Silver | Content | Protective | Packaging | Content | | | | Change*⁴ |
| No. | *1 | Carboxylate | (g) | Layer | Material (*2) | Change | Fog | Fogging*³ | S | (%) |
| 101 | T1 | A | P-3/20.40 | B | 1(10.0) | 2.3 | 0.24 | +0.08 | 100 | 150 |
| (Comp.) | | | | | | | | | | |
| 102 | T2 | B | P-3/20.40 | B | 1(10.0) | 2.4 | 0.25 | +0.10 | 105 | 165 |
| (Comp.) | | | | | | | | | | |
| 103 | T3 | C | P-3/20.40 | B | 1(10.0) | 2.4 | 0.26 | +0.11 | 105 | 155 |
| (Comp.) | | | | | | | | | | |
| 104 | T4 | D | P-3/20.40 | B | 1(10.0) | 2.4 | 0.26 | +0.12 | 107 | 160 |
| (Comp.) | | | | | | | | | | |
| 105 | T4 | D | P-3/20.40 | B | 4(0.0) | 2.3 | 0.22 | +0.12 | 110 | 145 |
| (Comp.) | | | | | | | | | | |
| 106 | T5 | C | P-1/16.03 | A | 4(0.0) | 2.1 | 0.19 | +0.01 | 115 | 110 |
| (Inv.) | | | | | | | | | | |
| 107 | T6 | C | P-1/14.57 | A | 4(0.0) | 1.8 | 0.18 | +0.01 | 118 | 104 |
| (Inv.) | | | | | | | | | | |
| 108 | T7 | C | P-1/13.11 | A | 4(0.0) | 1.6 | 0.19 | +0.01 | 120 | 110 |
| (Inv.) | | | | | | | | | | |
| 109 | T8 | C | P-1/9.00 | A | 4(0.0) | 1.5 | 0.30 | +0.07 | 90 | 150 |
| (Comp.) | | | | | | | | | | |
| 110 | T6 | C | P-1/14.57 | A | 2(5.0) | 1.9 | 0.19 | 0 | 115 | 108 |
| (Inv.) | | | | | | | | | | |
| 111 | T6 | C | P-1/14.57 | A | 3(1.1) | 1.9 | 0.19 | 0 | 115 | 105 |
| (Inv.) | | | | | | | | | | |

*1: Light-sensitive Layer Coating Solution
(*2) Water-vapor permeability (g/m² · 24 hr 40° C. 90% RH)
*³Fog density after retained in interior of an imager
*⁴Density change after retained in an imager

As apparent from Table 3, it was proved that photothermographic materials of the invention exhibited enhanced sensitivity as well as reduced fog density (minimum density), and little increase in fog density and little change in sensitivity even after being retained in the imager, compared to comparative photothermographic materials.

### Example 2

Similarly to Example 1, silver halide emulsions were prepared as follows.

Preparation of Silver Halide Emulsion 2

Light-sensitive silver halide emulsion 2 was prepared similarly to light-sensitive silver halide emulsion 1 in Example 1, except that 5 ml of an aqueous 0.4% lead bromide solution was added to solution D1. The prepared emulsion was comprised of monodisperse cubic silver iodobromide grains having an average grain size of 0.042 μm, a grain size variation coefficient of 13 percent and a (100) crystal face ratio of 94 percent.

Preparation of Silver Halide Emulsion 3

Light-sensitive silver halide emulsion 3 was prepared similarly to light-sensitive silver halide emulsion 1 in Example 1, except that after the total amount of solution F1 was added after nucleation, 40 ml of an aqueous 5% solution of 4-hydroxy-6-methyl-1,3,3a,7-tetrazaindene was added. The prepared emulsion was comprised of monodisperse cubic silver iodobromide grains having an average grain size of 0.041 μm, a grain size variation coefficient of 14 percent and a (100) crystal face ratio of 93 percent.

Preparation of Silver Halide Emulsion 4

Light-sensitive silver halide emulsion 4 was prepared similarly to light-sensitive silver halide emulsion 1 in Example 1, except that 4 ml of a 0.1% ethanol solution of compound (ETTU). The prepared emulsion was comprised of monodisperse cubic silver iodobromide grains having an average grain size of 0.042 μm, a grain size variation coefficient of 10 percent and a (100) crystal face ratio of 94 percent. 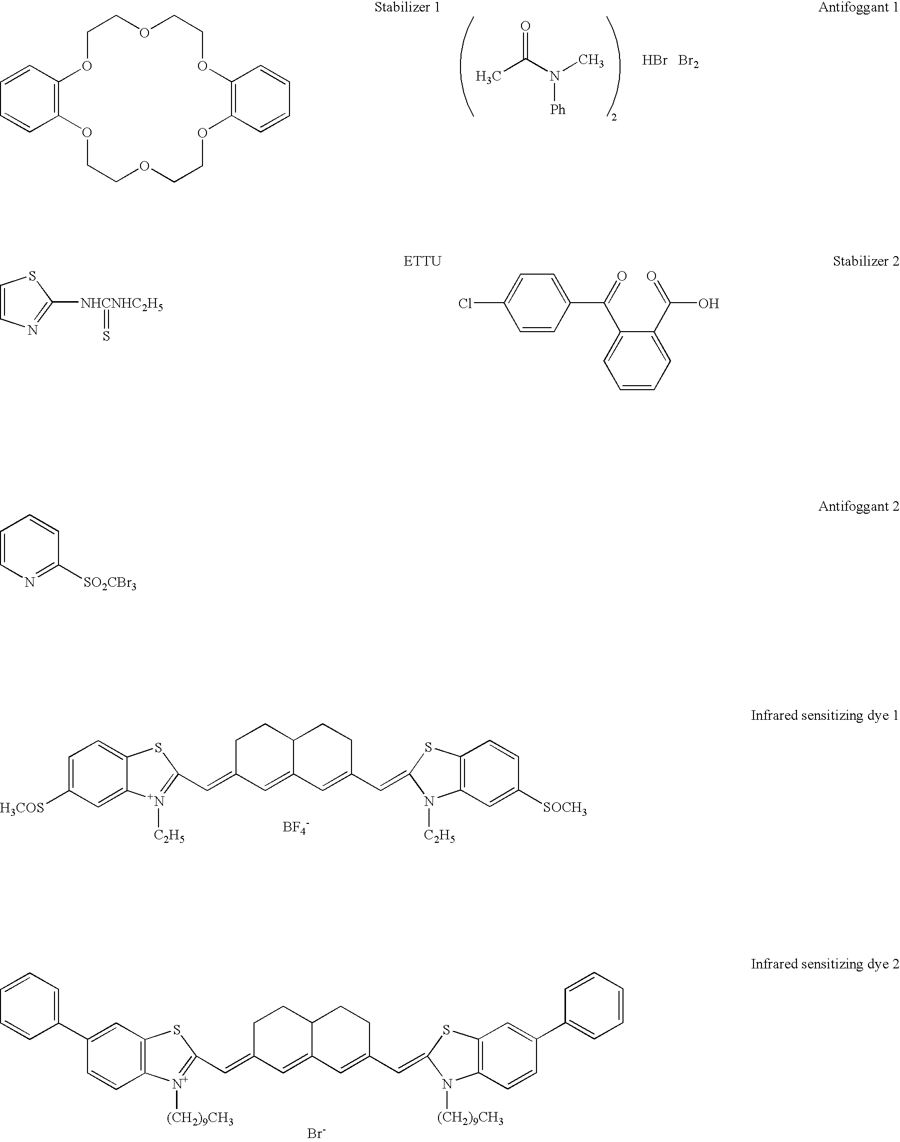
Preparation of Silver Halide Emulsion 5

Light-sensitive silver halide emulsion 5 was prepared similarly to light-sensitive silver halide emulsion 1 in Example 1, except that after the total amount of solution F1 was added after nucleation, 4 ml of a 0.1% ethanol solution of 1,2-benzothiazoline-3-one was added. The prepared emulsion was comprised of monodisperse cubic silver iodobromide grains having an average grain size of 0.041 μm, a grain size variation coefficient of 11 percent and a (100) crystal face ratio of 93 percent.

In the preparation of samples, compounds of the foregoing formula (RED) were used in place of developer A at an equimolar amount, as shown in Table 3.

Light-Sensitive Layer Coating Solution T1

Light-sensitive layer coating solution T1 for use in Example 2 was prepared similarly to light-sensitive layer coating solution T1 used in Example 1.

Light-Sensitive Layer Coating Solution T9-T16

Light-sensitive layer coating solutions T9 to T15 were prepared similarly to the foregoing light-sensitive layer coating solution T1, provided that the kind of light-sensitive silver halide emulsion, the kind of light-sensitive emulsion, the kind of a binder and the content thereof and the kind of a reducing agent were varied as shown in Table 4. Light-sensitive layer coating solution 16 was prepared similarly to the light-sensitive layer coating solution 12, except that 0.159 g of a yellow dye forming leuco dye (YL-1) and 0.159 g of a cyan dye forming leuco dye (CL-8) were added to the additive solution “a”.

Preparation of Sample

Sample 1 was prepared, provided that light-sensitive layer coating solution T1 and a coating solution of surface protective layer B were coated on the support used in Example 1.

Samples 2 to 13 were prepared similarly to the foregoing sample 1, provided that light-sensitive layer coating solutions T9 to T16 and a coating solution of surface protective layer A or B were used as shown In Table 4.

The thus prepared samples were each packaged in packaging material 1 or 4 exhibiting a water-vapor permeability described in Example 1, under a deaeration pressure of 2.0 kPa. After aged at 23° C. and 80% RH for 7 days, samples were subjected to evaluation of characteristics, as below.

### Evaluation

Surface Sensitivity and Internal Sensitivity

Samples were subjected to exposure to white light (4874K, 30 sec.) through an optical wedge and thermal development (123° C., 15 sec.) to obtain sensitivity S1. Separately, prior to exposure to white light, samples were subjected to a thermal treatment at 123° C. for 15 sec., then, the thermally treated samples were further subjected to exposure to white light (4874K, 30 sec.) through an optical wedge and thermal development (123° C., 15 sec.) to obtain S2. From comparison of sensitivities S1 and S2 for each sample, it was apparently shown that the sensitivity (S2) obtained when subjected to the thermal treatment prior to exposure and thermal development, was lowered, compared to the sensitivity (S1) obtained when subjected to exposure and thermal development. From observation/measurement of the spectral sensitivity spectrum, lowering of the sensitivity (S2) relative to the sensitivity (S1) is contemplated to be mainly due to change in the surface sensitivity of silver halide grains relative to the internal sensitivity, caused by disappearance or reduction of spectral sensitization effects and chemical sensitization effects.

Similarly to Example 1, samples were measured with respect to moisture content change, fog density, sensitivity (S), fogging after being retained in an imager, and density change after being retained in an image. Results thereof are shown in Table 4.

Raw Stock Stability

Samples were each packaged using packaging material 1 or 2 and kept for 10 days under the following condition A or B. Thereafter, samples were subjected to exposure and thermal development similarly to sensitometry to determine the minimum density for each sample. The ratio of the minimum density (Dₘᵢₙ) of condition B to that of condition A was determined as a measure of raw stock stability, according to the equation as below:

Condition A: 25° C., 55% RH

Condition B: 55° C., 80% RH
Ratio=[(Dₘᵢₙ of condition B)/(Dₘᵢₙ of condition B)]×100
Image Fastness

Samples were each exposed and thermally developed similarly to Example 1. These samples were adhered to a viewing box and allowed to stand for 10 days. Then, the samples were visually evaluated with respect to change of images, based on the following criteria:
5: almost no change was observed,
4: slight change in image color was observed,
3: partial change in image color and increased fogging were observed,
2: appreciable change in image color and increased fogging were observed in parts.

1: Marked change in image color and increased fogging were observed overall.

TABLE 4

| | Light- | Silver | | | | | |
|---|---|---|---|---|---|---|---|
| Sample | sensitive | Halide | Silver | Binder/ | Protective | Packaging | Reducing |
| No. | Layer | Emulsion | Carboxylate | Content (g) | Layer | Material (*1) | Agent |
| 1 | T1 | 1 | A | P-3/20.40 | B | 1 | A |
| (Comp.) | | | | | | | |
| 2 | T9 | 1 | D | P-1/13.31 | A | 1 | RED-17 |
| (Comp.) | | | | | | | |
| 3 | T10 | 1 | D | P-3/1082 | B | 4 | RED-17 |
| (Comp.) | | | | | | | |
| 4 | T9 | 1 | D | P-1/13.31 | A | 4 | RED-17 |
| (Inv.) | | | | | | | |
| 5 | T11 | 2 | D | P-1/13.31 | A | 4 | RED-17 |
| (Inv.) | | | | | | | |
| 6 | T12 | 3 | D | P-1/13.31 | A | 4 | RED-17 |
| (Inv.) | | | | | | | |
| 8 | T13 | 4 | D | P-1/13.31 | A | 4 | RED-17 |
| (Inv.) | | | | | | | |
| 9 | T14 | 5 | D | P-1/13.31 | A | 4 | RED-17 |
| (Inv.) | | | | | | | |
| 10 | T13 | 4 | D | P-1/13.31 | A | 4 | RED-1 |
| (Inv.) | | | | | | | |
| 11 | T13 | 4 | D | P-1/13.31 | A | 4 | RED-13 |
| (Inv.) | | | | | | | |
| 12 | T15 | 4 | A | P-1/9.00 | A | 4 | RED-17 |
| (Comp.) | | | | | | | |
| 13 | T16 | 3 | D | p-1/13.31 | A | 4 | RED-17 |
| (Inv.) | | | | | | | |

| | Moisture | | | | Density | | | |
|---|---|---|---|---|---|---|---|---|
| Sample | Content Change | | | | Change*³ | Raw Stock | Image | Sensitivity |
| No. | (%) | Fog | Fogging*² | S | (%) | Stability | Fastness | (S2/S1) |
| 1 | 2.3 | 0.24 | +0.08 | 100 | 150 | 130 | 2 | 1/2 |
| (Comp.) | | | | | | | | |
| 2 | 1.9 | 0.24 | +0.09 | 101 | 135 | 125 | 3 | 1/2 |
| (Comp.) | | | | | | | | |
| 3 | 2.3 | 0.26 | +0.09 | 100 | 145 | 112 | 2 | 1/2 |
| (Comp.) | | | | | | | | |
| 4 | 1.9 | 0.20 | +0.01 | 113 | 104 | 105 | 4 | 1/2 |
| (Inv.) | | | | | | | | |
| 5 | 1.9 | 0.19 | 0 | 115 | 105 | 103 | 4 | 1/12 |
| (Inv.) | | | | | | | | |
| 6 | 1.9 | 0.19 | 0 | 115 | 104 | 103 | 4 | 1/14 |
| (Inv.) | | | | | | | | |
| 8 | 1.9 | 0.19 | 0 | 115 | 105 | 102 | 5 | 1/18 |
| (Inv.) | | | | | | | | |
| 9 | 1.9 | 0.19 | 0 | 116 | 105 | 102 | 5 | 1/16 |
| (Inv.) | | | | | | | | |
| 10 | 1.9 | 0.20 | 0 | 117 | 104 | 104 | 4 | 1/18 |
| (Inv.) | | | | | | | | |
| 11 | 1.9 | 0.20 | 0 | 118 | 105 | 104 | 4 | 1/18 |
| (Inv.) | | | | | | | | |
| 12 | 1.5 | 0.30 | +0.07 | 90 | 130 | 115 | 2 | 1/18 |
| (Comp.) | | | | | | | | |
| 13 | 1.9 | 0.19 | 0 | 115 | 104 | 103 | 5 | 1/14 |
| (Inv.) | | | | | | | | |

(*1) Water-vapor permeability (g/m² · 24 hr 40° C. 90% RH),
*²Fogging after retained in an imager,
*³Density change after retained in an imager

As apparent from Table 4, it was proved that photothermographic materials of the invention exhibited enhanced sensitivity as well as reduced fog density (minimum density), little increase in fog density and little change in sensitivity even after retained in the imager, and superior raw stock stability and image fastness, compared to photothermographic materials of comparison.

1. A photothermographic material comprising a light-insensitive aliphatic carboxylic acid silver salt grains, light-sensitive silver halide grains, a reducing agent for silver ions and a binder, wherein the photothermographic material is packaged in a package of a packaging material exhibiting a water-vapor permeability of not more than 5.0 g/m²·24 hr·40° C.·90% RH and the photothermographic material exhibits a moisture content change of 1.6 to 2.2, in which the moisture content change is a ratio of a moisture content after allowed to stand at 23° C. and 80% RH for 6 hr. after opening the package to that immediately after opening the package; the aliphatic carboxylic acid silver salt has a silver behenate content of 65% to 100%.

2. The photothermographic material of claim 1, wherein the reducing agent is a compound represented by the following formula (RED): 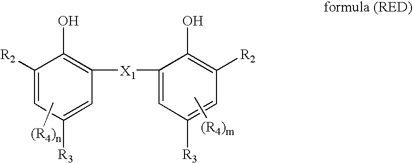
wherein X₁ is a chalcogen atom or CHR₁ in which R₁ is a hydrogen atom, a halogen atom, an alkyl group, alkenyl group, an aryl group or a heterocyclic group; R₂ is an alkyl group; R₃ is a hydrogen atom or a group capable of being substituted on a benzene ring; R₄ is a group capable of being substituted on a benzene ring; m and n are each an integer of 0 to 2.

3. The photothermographic material of claim 1, wherein the photothermographic material meets the following requirement:
S2/S1≦1/10
wherein S1 represents a sensitivity obtained when subjected to exposure to white light and thermal development and S2 represents a sensitivity obtained when heated under the same condition as the thermal development and then subject to the exposure to white light and the thermal development.

4. The photothermographic material of claim 1, wherein the photothermographic material contains an yellow dye forming leuco dye or a cyan dye forming leuco dye.

5. The photothermographic material of claim 1, wherein the silver halide grains are sensitized with a sensitizing dye to perform spectral sensitization and the spectral sensitization disappears after subjected to thermal development.

6. An image forming method of a photothermographic material comprising a light-insensitive aliphatic carboxylic acid silver salt grains, light-sensitive silver halide grains, a reducing agent for silver ions and a binder, the method comprising:
(a) subjecting the photothermographic material to imagewise exposure, and
(b) subjecting the exposed photothermographic material to thermal development to form an image,
wherein in (a), image wise exposure is performed using a laser scanning exposure apparatus generating a scanning laser beam in a longitudinal multiple mode, and wherein the photothermographic material is packaged in a package of a packaging material exhibiting a water-vapor permeability of not more than 5.0 g/m²·24 hr·40° C.·90% RH and the photothermographic material exhibits a moisture content change of 1.6 to 2.2, in which the moisture content change is a ratio of a moisture content after allowed to stand at 23° C. and 80% RH for 6 hr. after opening the package to that immediately after opening the package; the aliphatic carboxylic acid silver salt has a silver behenate content of 65% to 100%.
